(19) United States
(12) Patent Application Publication
(10) Pub. No.: US 2026/0267202 A1
(43) Pub. Date: Sep. 10, 2026

(54) LENS DRIVING DEVICE, CAMERA DEVICE AND OPTICAL DEVICE

(71) Applicant: LG INNOTEK CO., LTD., Seoul (KR)

(72) Inventors: Yun Ho NOH, Seoul (KR); Tae Bong PARK, Seoul (KR); Jun Taek LEE, Seoul (KR)

(21) Appl. No.: 18/994,959

(22) PCT Filed: Jun. 7, 2023
(86) PCT No.: PCT/KR2023/007780

§ 371 Date: Jan. 15, 2025

(30) Foreign Application Priority Data
Jul. 15, 2022 (KR) 10-2022-0087509
Sep. 20, 2022 (KR) 10-2022-0118228
Sep. 29, 2022 (KR) 10-2022-0124541

(51) Int. Cl. G03B 13/36; G03B 5/04

(52) U.S. Cl. CPC G03B 13/36; G03B 5/04; G03B 2205/0015; G03B 2205/0069

(57) ABSTRACT

A first embodiment of the present invention relates to a lens driving device comprising: a base; a first holder arranged in the base; a second holder arranged in the first holder; first to third magnets arranged in the base; a first coil which is arranged in the first holder and which interacts with the first magnet; a second coil which is arranged in the second holder and which interacts with the second magnet; and a third coil which is arranged in the second holder and which interacts with the third magnet.

### TECHNICAL FIELD

The present embodiment relates to a lens driving device, a camera device, and an optical device.

### BACKGROUND ART

A camera device is a device that photographs a picture or video of a subject, and is installed in optical devices such as smartphones, drones, and vehicles.

An auto-focus function that automatically adjusts the focus according to the distance of the subject is applied to the camera device. In addition, a handshake correction function is applied to prevent a phenomenon in which the focus is shaken by the user's handshake.

The autofocus function and the shake correction function may be performed through electromagnetic interaction between the magnet and the coil.

However, in the conventional lens driving device, a magnet that does not require electrical connection is disposed in the moving unit and the coil is disposed in the fixed unit. In this case, there is a problem in that a magnet having a greater weight than a coil is disposed in the moving unit, thereby increasing current consumption.

In particular, recently, as image sensors become more pixelated, the lens diameter has increased, and the weight of the lens has also increased, which has exacerbated the problem.

In addition, in conventional lens driving devices, there is a problem in that the height of the camera device in an optical axis direction increases because the guide structure for OIS-x-axis driving and the guide structure for OIS-y-axis driving are disposed in separate layers.

(Patent Literature 1) KR 10-2015-0118005 A

### DETAILED DESCRIPTION OF THE INVENTION

### Technical Subject

The present embodiment is intended to provide a lens driving device in which power consumption for performing an autofocus function and an image stabilization function is reduced by arranging a coil that is lightweight compared to a magnet in a moving unit.

In addition, the present invention is intended to provide a lens driving device having a minimized height in an optical axis direction by forming a guide structure for OIS-x-axis driving and a guide structure for OIS-y-axis driving as one body.

### Technical Solution

A lens driving device according to a first embodiment of the present invention may comprises: a base; a first holder being disposed inside the base; a second holder being disposed in the first holder; first to third magnets being disposed in the base; a first coil being disposed in the first holder and interacting with the first magnet; a second coil being disposed in the second holder and interacting with the second magnet; and a third coil being disposed in the second holder and interacting with the third magnet.

By the interaction between the first coil and the first magnet, the first holder moves in the optical axis direction, by the interaction between the second coil and the second magnet, the second holder moves in a first direction perpendicular to the optical axis direction, and by the interaction between the third coil and the third magnet, the second holder can move in a second direction perpendicular to both the optical axis direction and the first direction.

The second holder can move in the optical axis direction together with the first holder by the interaction between the first coil and the first magnet.

The base may comprise a first side portion and a second side portion being disposed opposite to each other, and a third side portion and a fourth side portion being disposed opposite to each other, and the first magnet may be disposed in the first side portion of the base, the second magnet may be disposed in the second side portion of the base, and the third magnet may be disposed in the third side portion of the base.

The second holder may comprise a first side surface and a second side surface being disposed opposite to each other, and a third side surface and a fourth side surface being disposed opposite to each other, the first coil may be disposed between the first side surface of the second holder and the first magnet, the second coil may be disposed between the second side surface of the second holder and the second magnet, and the third coil may be disposed between the third side surface of the second holder and the third magnet.

It comprises a first substrate comprising a first portion being disposed in the first holder, a second portion being disposed on the second side surface of the second holder, and a third portion being disposed on the third side surface of the second holder, wherein the first coil is disposed in the first portion of the first substrate, wherein the second coil is disposed in the second portion of the first substrate, and wherein the third coil may be disposed in the third portion of the first substrate.

The first substrate comprises a fourth portion being disposed between the fourth side surface of the second holder and the first holder, and the fourth portion of the first substrate may comprise a terminal.

The lens driving device comprises a second substrate being disposed on the base, the second substrate comprising a body portion being disposed on the base and an extended portion being extended from the body portion, wherein the extended portion comprises a first terminal being coupled to the terminal of the first substrate, wherein the body portion comprises a second terminal being electrically connected to the first terminal, and wherein at least a portion of the extended portion can move together with the first holder.

The lens driving device may comprise a first ball being disposed between the base and the first holder.

The lens driving device comprises a yoke being disposed in the first portion of the first substrate and generating an attractive force with the first magnet.

The lens driving device may comprise a second ball being disposed between the first holder and the second holder.

The lens driving device comprises a first elastic member being disposed on an upper surface of the second holder; a second elastic member being disposed on a lower surface of the first holder; and a third elastic member connecting the first elastic member and the second elastic member, wherein the first holder comprises a body portion and a pressing portion being coupled to the upper surface of the body portion, wherein the second elastic member is disposed on the lower surface of the body portion, and wherein the second ball can be disposed between the pressing portion of the first holder and the second holder.

The second ball can guide the second holder to move in a first direction and a second direction perpendicular to the optical axis direction with respect to the first holder.

The lens driving device may comprise: a first sensor being disposed in the first portion of the first substrate and detecting the first magnet; a second sensor being disposed in the second portion of the first substrate and detecting the second magnet; and a third sensor being disposed in the third portion of the first substrate and detecting the third magnet.

A camera device according to a first embodiment of the present invention may comprise a printed circuit board; an image sensor being disposed on the printed circuit board; a lens driving device being disposed on the printed circuit board; and a lens being coupled to the lens driving device.

An optical device according to a first embodiment of the present invention may comprise: a main body; a camera device being disposed in the main body; and a display being disposed in the main body and outputting at least one of an image and a video photographed by the camera device.

A lens driving device according to a second embodiment of the present invention may comprise: a fixed unit; a first moving unit being disposed inside the fixed unit; a second moving unit being disposed inside the first moving unit; a first driving unit that moves the first moving unit in an optical axis direction; a second driving unit that moves the second moving unit in a first direction perpendicular to the optical axis direction; a third driving unit that moves the second moving unit in a second direction perpendicular to the optical axis direction and the first direction; a first ball being disposed between the first moving unit and the second moving unit so as to be overlapped with the first moving unit and the second moving unit in the optical axis direction; a wire being disposed parallel to the optical axis direction; a first elastic member connecting a first region of the wire and the first moving unit; and a second elastic member connecting a second region of the wire and the second moving unit.

The second region of the above wire can be disposed higher than the first region.

The first moving unit comprises a top plate disposed higher than the second moving unit, and the first ball may be disposed between the upper plate of the first moving unit and the second moving unit.

The first elastic member comprises an outer portion being coupled with the first moving unit, the second elastic member comprises an inner portion being coupled with the second moving unit, and in the optical axis direction, the distance between the first region and the second region of the wire may be longer than a distance between the outer portion of the first elastic member and the inner portion of the second elastic member.

The first elastic member comprises: an outer portion being coupled with the first moving unit; a coupling portion being coupled with the wire; and a connecting portion connecting the outer portion and the coupling portion, wherein the coupling portion of the first elastic member can be disposed lower than the outer portion of the first elastic member.

The second elastic member comprises: an inner portion being coupled with the second moving unit; a coupling portion being coupled with the wire; and a connecting portion connecting the inner portion and the coupling portion, wherein the coupling portion of the second elastic member can be disposed higher than the inner portion of the second elastic member.

When viewed from above, the first ball can be disposed inside a space being formed by the inner portion, the coupling portion, and the connecting portion of the second elastic member.

The second moving unit comprises a first protrusion and a second protrusion being formed on an upper surface of the second moving unit; the inner portion of the second elastic member comprises a first region being coupled with the first protrusion and a second region being coupled with the second protrusion; the wire comprises a first wire being disposed at a first corner region of the fixed unit; the coupling portion of the second elastic member comprises a first coupling portion being coupled with the first wire; and the connecting portion of the second elastic member may comprise a first connecting portion connecting the first region of the inner portion and the first coupling portion, and a second connecting portion connecting the second region of the inner portion and the first coupling portion.

The coupling portion of the first elastic member comprises a first coupling portion coupled with the first wire; and the connecting portion of the first elastic member comprises a first connecting portion and a second connecting portion connecting the outer portion of the first elastic member and the first coupling portion of the first elastic member; and when viewed from below, the first and second connecting portions of the first elastic member may be symmetrical with respect to an imaginary straight line connecting an optical axis and the first corner region of the fixed unit.

The wires comprises first to fourth wires respectively disposed in first to fourth corner regions of the fixed unit; the first elastic member comprises first to fourth elastic units corresponding to the first to fourth wires; the first to fourth elastic units are spaced apart from one another; and the second elastic member can be formed integrally.

The first driving unit comprises a first coil disposed in the first moving unit and a first magnet disposed in the fixed unit, and the second driving unit may comprise a second coil disposed in the second moving unit and a second magnet disposed in the fixed unit.

The third driving unit may comprise a third coil being disposed in the second moving unit and a third magnet being disposed the fixed unit.

It comprises: a first substrate comprising a first portion being disposed in the first moving unit; a second portion being disposed on the first side surface of the second moving unit; and a third portion being disposed on the second side surface of the second moving unit, wherein the first coil is disposed in the first portion of the first substrate, the second coil is disposed in the second portion of the first substrate, and the third coil may be disposed in the third portion of the first substrate.

It comprises a body portion being disposed on the fixed unit and a second substrate comprising an extended portion being extended from the body portion, wherein the extended portion comprises a terminal being coupled to a terminal of the first substrate, and wherein at least a portion of the extended portion can move together with the first moving unit.

A camera device according to a second embodiment of the present invention may comprise: a printed circuit board; an image sensor being disposed on the printed circuit board; the lens driving device being disposed on the printed circuit board; and a lens being coupled to the lens driving device.

An optical device according to a second embodiment of the present invention may comprise: a main body; the camera device being disposed in the main body; and a display being disposed in the main body and outputting at least one of an image and a video photographed by the camera device.

A lens driving device according to a third embodiment of the present invention comprises: a fixed unit; a first moving unit being disposed inside the fixed unit; a second moving unit being disposed inside the first moving unit; a first driving unit that moves the first moving unit in an optical axis direction; a second driving unit that moves the second moving unit in a first direction perpendicular to the optical axis direction; a third driving unit that moves the second moving unit in a second direction perpendicular to the optical axis direction and the first direction; a ball being disposed between the fixed unit and the first moving unit; and an elastic member that connects the first moving unit and the second moving unit, wherein the first driving unit may comprise a first coil being disposed in the first moving unit and a first magnet being disposed in the fixed unit.

The above ball may not be overlapped with the second moving unit in the optical axis direction.

The elastic member may comprise a first elastic member being coupled with the first moving unit, a second elastic member being coupled with the second moving unit, and a wire connecting the first elastic member and the second elastic member.

The first elastic member may comprise an outer portion being coupled with the first moving unit, a coupling portion being coupled with the wire, and a connecting portion connecting the outer portion and the coupling portion.

The outer portion of the first elastic member and the coupling portion of the first elastic member can be disposed at the same height.

The second elastic member may comprise an inner portion being coupled with the second moving unit, a coupling portion being coupled with the wire, and a connecting portion connecting the inner portion and the coupling portion of the second elastic member.

The inner portion of the second elastic member and the coupling portion of the first elastic member can be disposed at the same height.

The second driving unit may comprise a second coil being disposed in the second moving unit and a second magnet being disposed in the fixed unit.

The third driving unit may comprise a third coil being disposed in the second moving unit and a third magnet being disposed in the fixed unit.

It comprises: a first substrate comprising a first portion being disposed on the first moving unit; a second portion being disposed on a first side surface of the second moving unit; and a third portion being disposed on a second side surface of the second moving unit, wherein the first coil is disposed on the first portion of the first substrate, the second coil is disposed on the second portion of the first substrate, and the third coil may be disposed on the third portion of the first substrate.

It comprises a second substrate comprising a body portion being disposed on the fixed unit and an extended portion being extended from the body portion, wherein the extended portion comprises a terminal being coupled to a terminal of the first substrate, and wherein at least a portion of the extended portion may move together with the first moving unit.

The ball guides the first moving unit to move in the optical axis direction against the fixed unit, and the elastic member can guide the second moving unit to move in the first direction and the second direction against the first moving unit.

It may comprise a yoke being disposed between the first coil and the first moving unit and having an attractive force with the first magnet.

A camera device according to a third embodiment of the present invention may comprise: a printed circuit board; an image sensor being disposed on the printed circuit board; the lens driving device being disposed on the printed circuit board; and a lens being coupled to the lens driving device.

An optical device according to a third embodiment of the present invention may comprise: a main body; a camera device being disposed in the main body; and a display being disposed in the main body and outputting at least one of an image and a video photographed by the camera device.

### Advantageous Effects

Through the present embodiment, since a coil that is lighter in weight than the magnet is disposed in the moving unit, the current consumption for performing the auto focus function and the shake correction function can be reduced.

In addition, since the guide structure for OIS-x-axis driving and the guide structure for OIS-y-axis driving are formed integrally, the height of the lens driving device in an optical axis direction can be minimized.

Accordingly, the height at which the camera device is protruded from the smartphone can be minimized.

In addition, the OIS guide structure of a second embodiment of the present invention can maintain the OIS guide ball in a close state without a separate preload member.

### BRIEF DESCRIPTION OF DRAWINGS

FIG. 1 is a conceptual diagram of a lens driving device according to a first embodiment of the present invention.

FIG. 2 is a perspective view of a lens driving device according to a first embodiment of the present invention.

FIG. 3 is a cross-sectional view taken along line A-A of FIG. 2.

FIG. 4 is a cross-sectional view taken along line B-B of FIG. 2.

FIG. 5 is an exploded perspective view of a lens driving device according to a first embodiment of the present invention.

FIG. 6 is a perspective view of a lens driving device according to a first embodiment of the present invention with a cover removed.

FIG. 7 is an enlarged view illustrating an enlarged portion of FIG. 6.

FIG. 8 is a perspective view of a lens driving device in a state of FIG. 6 viewed from a different direction from FIG. 6.

FIG. 9 is a perspective view of a lens driving device according to a first embodiment of the present invention with a fixed unit and some components omitted.

FIG. 10 is a bottom perspective view of a moving unit of a lens driving device according to a first embodiment of the present invention.

FIG. 11 is a bottom perspective view of a moving unit and related components of a lens driving device according to a first embodiment of the present invention with a cover removed.

FIG. 12 is a perspective view illustrating a base and a second substrate of a lens driving device according to a first embodiment of the present invention.

FIG. 13 is a perspective view illustrating a moving unit and a second substrate of a lens driving device according to a first embodiment of the present invention.

FIG. 14 is a bottom perspective view of a lens driving device of FIG. 13 from a different direction than FIG. 13.

FIG. 15 is a bottom perspective view of a lens driving device of FIG. 14 with a cover and a second substrate removed.

FIG. 16 is a bottom perspective view of a lens driving device of FIG. 15 with a first holder removed.

FIG. 17 is a bottom perspective view of a lens driving device of FIG. 16.

FIG. 18 is a plan view of a lens driving device according to a first embodiment of the present invention with a cover and a pressing portion of a first holder removed.

FIG. 19 is a perspective view illustrating a second moving unit and a substrate and related configuration of a lens driving device according to a first embodiment of the present invention.

FIG. 20 is a bottom view and a partially enlarged view of a lens driving device in a state of FIG. 19.

FIG. 21 is a perspective view of a first holder and a second substrate and related component of a lens driving device according to a first embodiment of the present invention.

FIG. 22 is a bottom perspective view illustrating a driving unit, substrate, elastic member, and the like of a lens driving device according to a first embodiment of the present invention.

FIG. 23 is a plan view illustrating a driving unit, substrate, and elastic member of a lens driving device according to a first embodiment of the present invention.

FIG. 24 is a perspective view illustrating a first substrate and a coil of a lens driving device according to a first embodiment of the present invention.

FIG. 25 is a perspective view illustrating a second substrate of a lens driving device according to a first embodiment of the present invention.

FIG. 26 is a cross-sectional perspective view of a lens driving device according to a first embodiment of the present invention with a pressing portion of a first holder removed.

FIG. 27 is a cross-sectional perspective view of FIG. 26 with a pressing portion of a first holder, and the like added.

FIGS. 28 to 30 are diagrams for explaining an auto focus driving of a lens driving device according to a first embodiment of the present invention. FIG. 28 is a cross-sectional view illustrating an appearance of a moving unit in an initial state where no current is applied to a first coil. FIG. 29 is a cross-sectional view illustrating an appearance where a moving unit moves upward in an optical axis direction when a forward current is applied to a first coil. FIG. 30 is a cross-sectional view illustrating an appearance where a moving unit moves downward in an optical axis direction when a reverse current is applied to a first coil.

FIGS. 31 to 33 are drawings for explaining a shake correction driving of a lens driving device according to a first embodiment of the present invention. FIG. 31 is a cross-sectional view illustrating an appearance of a moving unit in an initial state where no current is applied to a second coil and a third coil. FIG. 32 is a cross-sectional view illustrating an appearance where a second moving unit moves in an x-axis direction perpendicular to an optical axis when current is applied to a second coil. FIG. 33 is a cross-sectional view illustrating an appearance where a second moving unit moves in a y-axis direction perpendicular to both an optical axis and a x-axis when current is applied to a third coil.

FIG. 34 is an exploded perspective view of a camera device according to a first embodiment of the present invention.

FIG. 35 is a perspective view of an optical device according to a first embodiment of the present invention.

FIG. 36 is a perspective view of an optical device according to a modified embodiment.

FIG. 37 is a conceptual diagram of a lens driving device according to a second embodiment of the present invention.

FIG. 38 is a perspective view of a lens driving device according to a second embodiment of the present invention.

FIG. 39 is a cross-sectional view taken along line A-A of FIG. 38.

FIG. 40 is a cross-sectional view taken along line B-B of FIG. 38.

FIG. 41 is a cross-sectional view taken along line C-C of FIG. 38.

FIG. 42 is a cross-sectional view taken from above, cut perpendicular to the optical axis, of a lens driving device according to a second embodiment of the present invention.

FIG. 43 is an exploded perspective view of a lens driving device according to a second embodiment of the present invention.

FIG. 44 is a perspective view of a lens driving device according to a second embodiment of the present invention with the cover removed.

FIG. 45 is an enlarged view illustrating a portion of FIG. 44.

FIG. 46a is a perspective view of FIG. 44 viewed from another direction.

FIG. 46b is a perspective view illustrating a state in which the metal member of the AF moving unit is omitted in FIG. 46.

FIG. 47 is a perspective view illustrating a fixed unit and related components of a lens driving device according to a second embodiment of the present invention.

FIG. 48 is a perspective view illustrating a moving unit and related components of a lens driving device according to a second embodiment of the present invention.

FIG. 49 is a front view of FIG. 48 as seen from the front.

FIG. 50 is a cross-sectional perspective view illustrating an AF guide ball and related component of a lens driving device according to a second embodiment of the present invention.

FIG. 51 is a perspective view of FIG. 48 from a different direction.

FIG. 52 is a perspective view of FIG. 51 with a cover removed.

FIG. 53 is a bottom view of an AF moving unit and related components of a lens driving device according to a second embodiment of the present invention as viewed from below.

FIG. 54 is a bottom perspective view of FIG. 53 as viewed from a different direction.

FIG. 55 is an enlarged view illustrating a portion of FIG. 54 in an enlarged manner.

FIG. 56 is a perspective view illustrating an OIS moving unit and related components of a lens driving device according to a second embodiment of the present invention.

FIG. 57a is an enlarged view illustrating a portion of FIG. 56 in an enlarged manner.

FIG. 57b is a cross-sectional view as viewed from A-A of FIG. 57a.

FIG. 58a is a cross-sectional view illustrating a pressurizing structure of an OIS guide ball of a lens driving device according to a second embodiment of the present invention.

FIG. 58b is a cross-sectional view illustrating a coupling structure of an elastic member and a wire of a lens driving device according to a second embodiment of the present invention.

FIG. 59 is a bottom perspective view of FIG. 56 viewed from a different direction.

FIG. 60 is a perspective view illustrating an inner substrate and an outer substrate of a lens driving device according to a second embodiment of the present invention.

FIG. 61 is a perspective view illustrating an elastic member and a wire of a lens driving device according to a second embodiment of the present invention.

FIGS. 62 to 64 are diagrams for explaining an auto focus driving of a lens driving device according to a second embodiment of the present invention. FIG. 62 is a cross-sectional view illustrating an appearance of a moving unit in an initial state in which no current is applied to an AF coil. FIG. 63 is a cross-sectional view illustrating an appearance in which a moving unit moves upward in an optical axis direction when a forward current is applied to an AF coil. FIG. 64 is a cross-sectional view illustrating an appearance in which a moving unit moves downward in an optical axis direction when a reverse current is applied to an AF coil.

FIGS. 65 to 67 are drawings for explaining a hand shake correction driving of a lens driving device according to a second embodiment of the present invention. FIG. 65 is a cross-sectional view illustrating an appearance of a moving unit in an initial state in which no current is applied to an OIS-x coil and an OIS-y coil. FIG. 66 is a cross-sectional view illustrating an OIS moving unit moving in an x-axis direction perpendicular to an optical axis when a current is applied to an OIS-x coil. FIG. 67 is a cross-sectional view illustrating an OIS moving unit moving in a y-axis direction perpendicular to both an optical axis and an x-axis when a current is applied to an OIS-y coil.

FIG. 68 is an exploded perspective view of a camera device according to a second embodiment of the present invention.

FIG. 69 is a perspective view of an optical device according to a second embodiment of the present invention.

FIG. 70 is a perspective view of an optical device according to a modified embodiment.

FIG. 71 is a conceptual diagram of a lens driving device according to a third embodiment of the present invention.

FIG. 72 is a perspective view of a lens driving device according to a third embodiment of the present invention.

FIG. 73 is a cross-sectional view taken along line A-A of FIG. 72.

FIG. 74 is a cross-sectional view taken along line B-B of FIG. 72.

FIG. 75 is a cross-sectional view taken along line C-C of FIG. 72.

FIG. 76 is an enlarged view of a portion of FIG. 75.

FIG. 77 is a cross-sectional view taken along line perpendicular to an optical axis of a lens driving device according to a third embodiment of the present invention as viewed from above.

FIG. 78 is an exploded perspective view of a lens driving device according to a third embodiment of the present invention.

FIG. 79 is a perspective view of a lens driving device according to a third embodiment of the present invention with a cover removed.

FIG. 80 is an enlarged view of a portion of FIG. 79.

FIG. 81 is a perspective view of FIG. 80 viewed from a different direction.

FIG. 82 is a perspective view illustrating a fixed unit and related configuration of a lens driving device according to a third embodiment of the present invention.

FIG. 83 is a perspective view illustrating a moving unit and related component of a lens driving device according to a third embodiment of the present invention.

FIG. 84 is a front view of FIG. 83 viewed from front.

FIG. 85 is a cross-sectional perspective view illustrating an AF guide ball and related component of a lens driving device according to a third embodiment of the present invention.

FIG. 86 is a perspective view of FIG. 83 viewed from a different direction.

FIG. 87 is a perspective view of FIG. 86 with the cover removed.

FIG. 88 is a bottom view of an AF moving unit and related component of a lens driving device according to a third embodiment of the present invention viewed from below.

FIG. 89 is a bottom perspective view of FIG. 88 viewed from a different direction.

FIG. 90 is a perspective view illustrating an OIS moving unit and related component of a lens driving device according to a third embodiment of the present invention.

FIG. 91 is a cross-sectional view illustrating an arrangement structure of an elastic member of a lens driving device according to a third embodiment of a present invention.

FIG. 92 is a bottom perspective view of FIG. 90 seen from a different direction.

FIG. 93 is a perspective view illustrating an inner substrate and an outer substrate of a lens driving device according to a third embodiment of the present invention.

FIG. 94 is a perspective view illustrating an elastic member and a wire of a lens driving device according to a third embodiment of the present invention.

FIGS. 95 to 97 are drawings for explaining an auto focus driving of a lens driving device according to a third embodiment of the present invention. FIG. 95 is a cross-sectional view illustrating an appearance of a moving unit in an initial state where no current is applied to an AF coil. FIG. 96 is a cross-sectional view illustrating an appearance where a moving unit moves upward in an optical axis direction when a positive current is applied to an AF coil. FIG. 97 is a cross-sectional view illustrating a moving unit moving downward in an optical axis direction when reverse current is applied to an AF coil.

FIGS. 98 to 100 are drawings for explaining a shake correction drive of a lens driving device according to a third embodiment of the present invention. FIG. 98 is a cross-sectional view illustrating a moving unit in an initial state when no current is applied to an OIS-x coil and an OIS-y coil. FIG. 99 is a cross-sectional view illustrating an OIS moving unit moving in an x-axis direction perpendicular to an optical axis when current is applied to an OIS-x coil. FIG. 100 is a cross-sectional view illustrating an OIS moving unit moving in a y-axis direction perpendicular to both an optical axis and an x-axis when current is applied to an OIS-y coil.

FIG. 101 is an exploded perspective view of a camera device according to a third embodiment of the present invention.

FIG. 102 is a perspective view of an optical device according to a third embodiment of the present invention.

FIG. 103 is a perspective view of an optical device according to a modified embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (comprising technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’ due that another component between that other components.

In addition, when described as being formed or disposed in “on (above)” or “under (below)” of each component, “on (above)” or “under (below)” means that it comprises not only the case where the two components are directly in contact with, but also the case where one or more other components are formed or disposed between the two components. In addition, when expressed as “on (above)” or “under (below)”, the meaning of not only an upward direction but also a downward direction with respect to one component may be comprised.

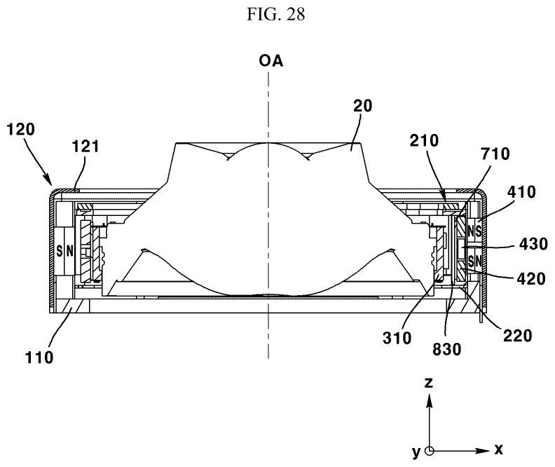

The ‘optical axis (refer to OA in FIG. 28) direction’ used hereinafter is defined as the optical axis direction of the lens and/or image sensor being coupled to the lens driving device.

The ‘vertical direction’ used hereinafter may be a direction parallel to or the same direction as the optical axis. The vertical direction may correspond to a ‘z-axis direction’. The ‘horizontal direction’ used hereinafter may be a direction perpendicular to the vertical direction. That is, the horizontal direction may be a direction perpendicular to the optical axis. Therefore, the horizontal direction may comprise an ‘x-axis direction’and a ‘y-axis direction’.

The ‘auto focus (AF) function’ used hereinafter is defined as a function that automatically focuses on a subject by adjusting the distance from the image sensor by moving the lens in the optical axis direction according to the distance of the subject so that a clear image of the subject can be obtained on the image sensor. In addition, ‘closed-loop auto focus (CLAF) control’ is defined as detecting the distance between the image sensor and the lens and controlling the position of the lens through feedback in real time in order to improve the accuracy of focus adjustment.

The ‘optical image stabilization (OIS) function’ used hereinafter is defined as a function that moves or tilts the lens in a direction perpendicular to the optical axis to offset hand shake in order to prevent an image or video from shaking due to the user's hand shake. In addition, ‘closed-loop auto focus (CLAF) control’ is defined as detecting the position of the lens with respect to the image sensor and controlling the feedback of the lens position in real time in order to improve the accuracy of hand shake correction.

Hereinafter, one of the “AF moving unit 1200” and the “OIS moving unit 1300” is referred to as a “first moving unit” and the other may be referred to as a “second moving unit”.

Hereinafter, one among the “AF driving unit 1400”, the “OIS-x driving unit 1500”, and the “OIS-y driving unit 1600” is referred to as a “first driving unit”, the other is referred to as a “second driving unit”, and yet the other may be referred to as a “third driving unit”.

Hereinafter, one among the “AF magnet 1410”, the “OIS-x magnet 1510”, and the “OIS-y magnet 1610” may be referred to as a “first magnet”, the other is referred to as a “second magnet”, and yet the other may be referred to as a “third magnet”.

Hereinafter, one among the “AF coil 1420”, the “OIS-x coil 1520”, and the “OIS-y coil 1620” is referred to as a “first coil”, the other is referred to as a “second coil”, and yet the other may be referred to as a “third coil”.

Hereinafter, one among the “AF sensor 1430”, the “OIS-x sensor 1530”, and the “OIS-y sensor 1630” is referred to as a “first sensor”, the other is referred to as a “second sensor”, and yet the other may be referred to as a “third sensor”.

Hereinafter, one of the “inner substrate 1710” and the “outer substrate 1720” is referred to as a “first substrate” and the other may be referred to as a “second substrate”.

Hereinafter, one of the “AF guide ball 1810” and the “OIS guide ball 1820” is referred to as a “first ball” and the other may be referred to as a “second ball”.

Hereinafter, either the “lower elastic member 1910” or the “upper elastic member 1920” is referred to as a “first elastic member” and the other may be referred to as a “second elastic member”.

Hereinafter, one of the “AF moving unit 2200” and the “OIS moving unit 2300” is referred to as a “first moving unit” and the other may be referred to as a “second moving unit”.

Hereinafter, one among the “AF driving unit 2400”, “OIS-x driving unit 2500” and “OIS-y driving unit 2600” is referred to as a “first driving unit”, the other is referred to as a “second driving unit” and yet the other may be referred to as a “third driving unit”.

Hereinafter, one among the “AF magnet 2410”, the “OIS-x magnet 2510”, and the “OIS-y magnet 2610” is referred to as a “first magnet”, the other is referred to as a “second magnet”, and yet the other may be referred to as a “third magnet”.

Hereinafter, one among the “AF coil 2420”, the “OIS-x coil 2520”, and the “OIS-y coil 2620” is referred to as a “first coil”, the other is referred to as a “second coil”, and yet the other may be referred to as a “third coil”.

Hereinafter, one among the “AF sensor 2430”, the “OIS-x sensor 2530”, and the “OIS-y sensor 2630” is referred to as a “first sensor”, the other is referred to as a “second sensor”, and yet the other may be referred to as a “third sensor”.

Hereinafter, one of the “inner substrate 2710” and the “outer substrate 2720” is referred to as a “first substrate” and the other may be referred to as a “second substrate”.

Hereinafter, either the “lower elastic member 2910” or the “upper elastic member 2920” is referred to as a “first elastic member” and the other may be referred to as a “second elastic member”.

Hereinafter, the component of a lens driving device according to a first embodiment of the present invention will be described with reference to the drawings.

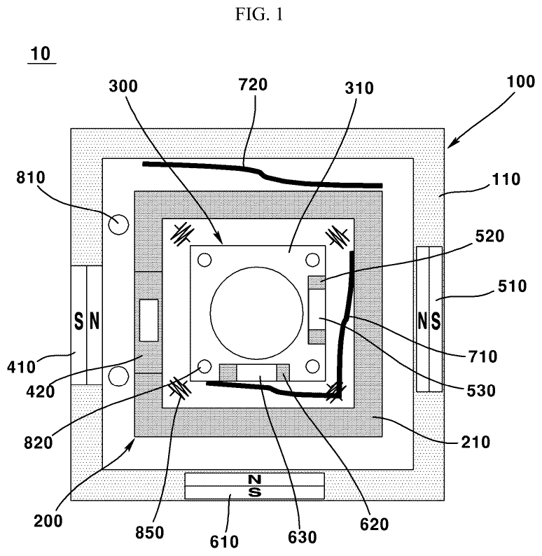

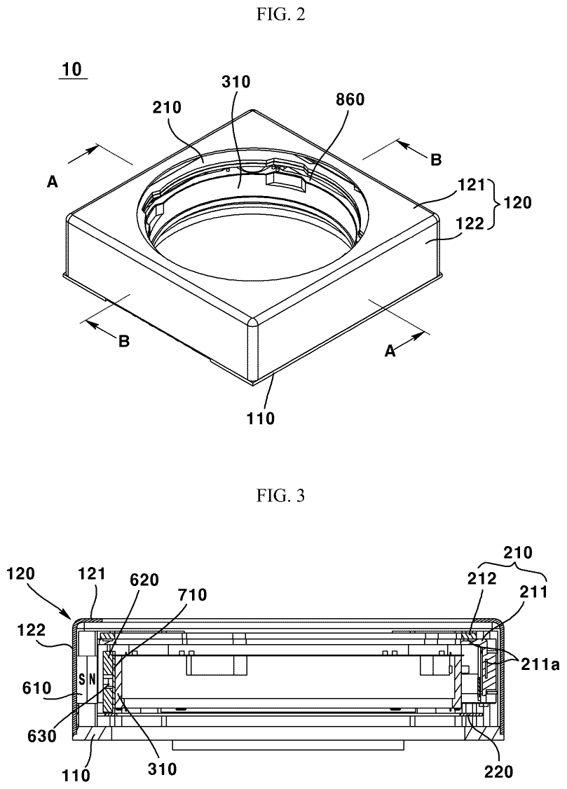

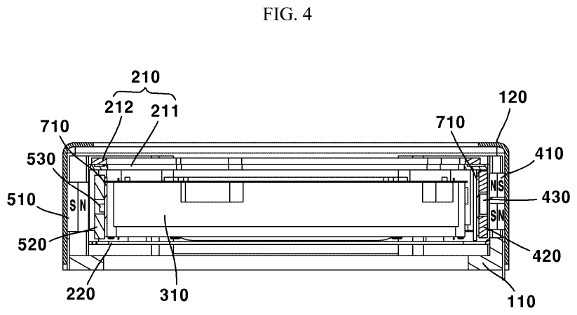

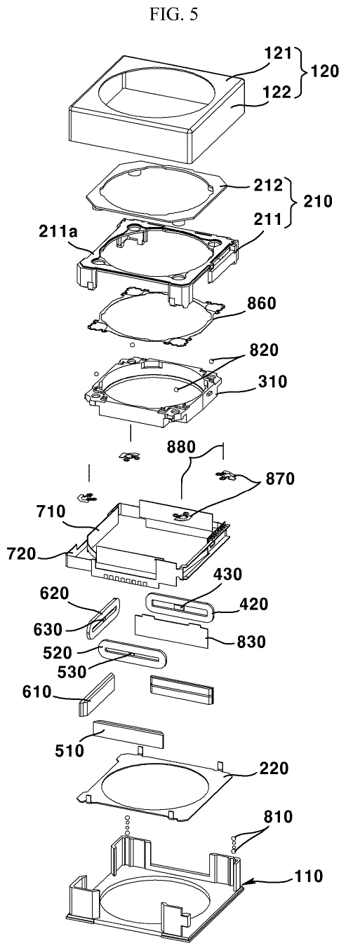

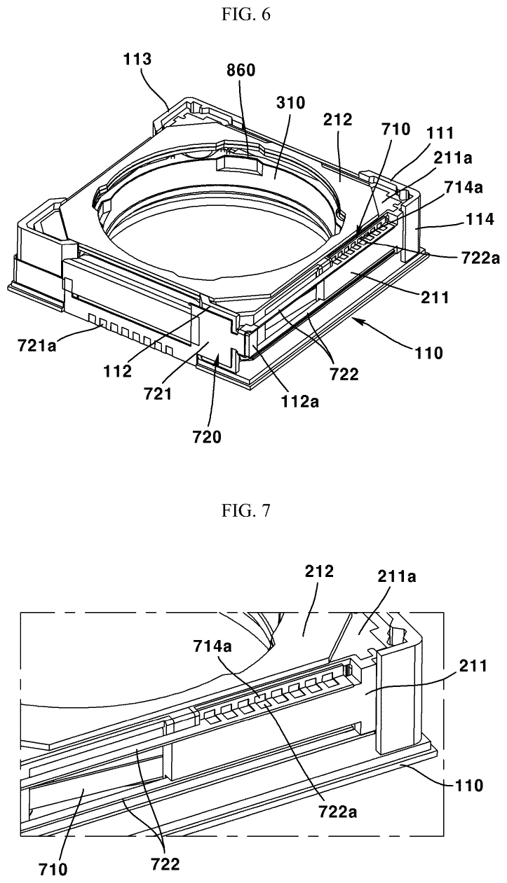

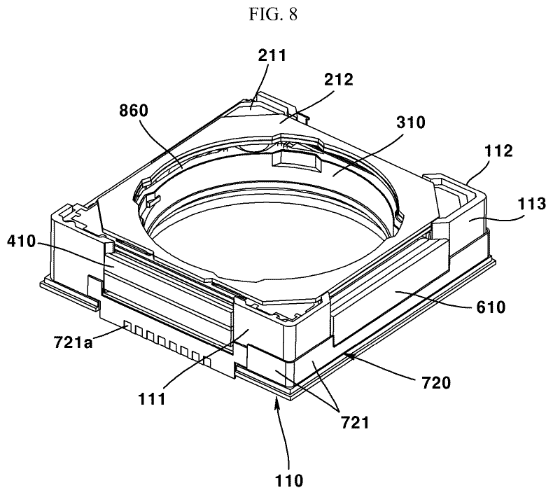

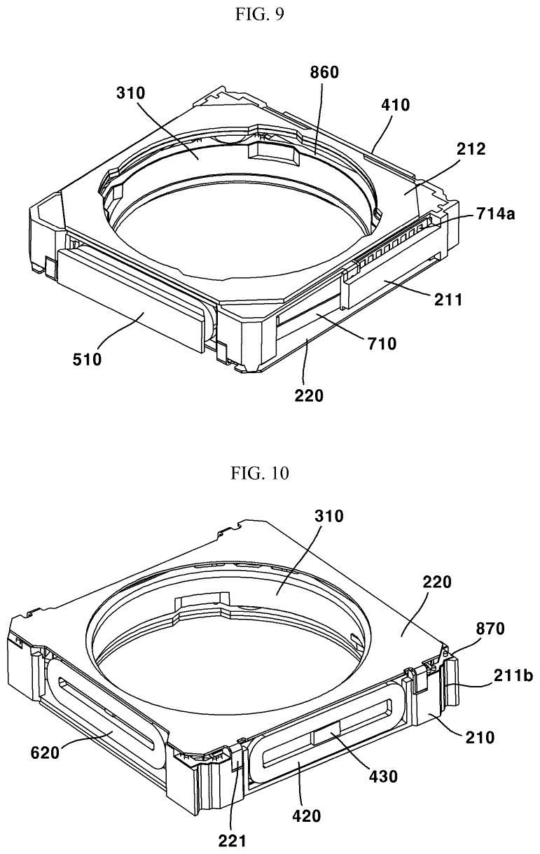

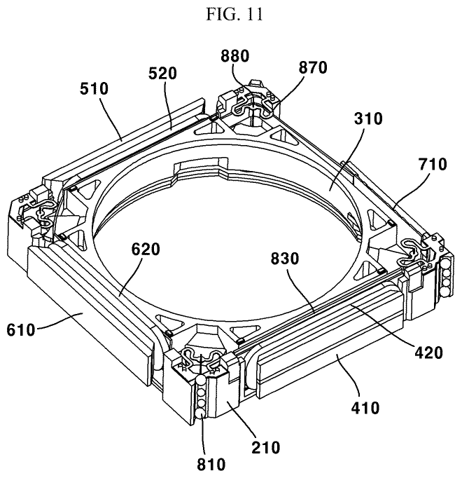

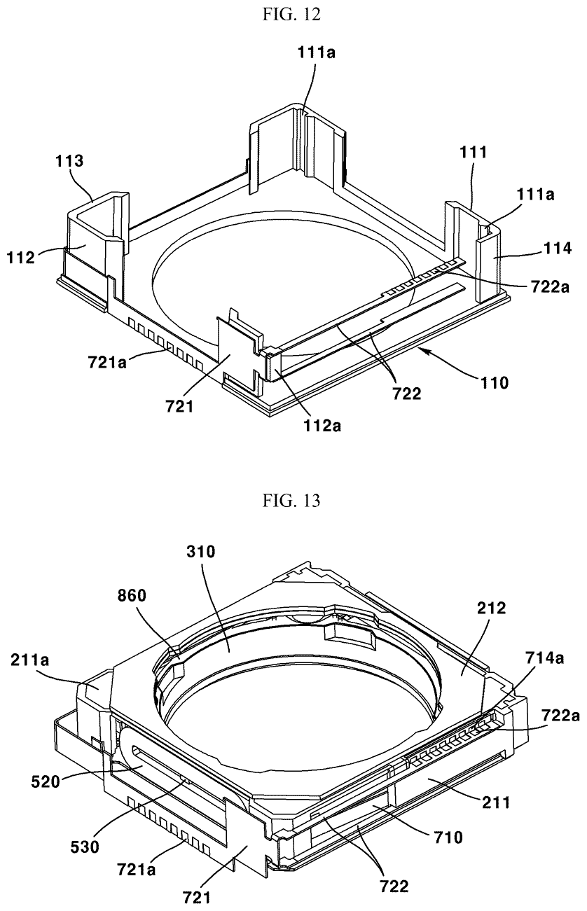

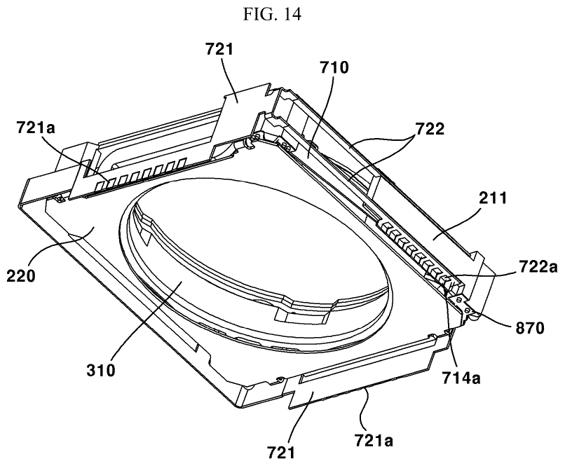

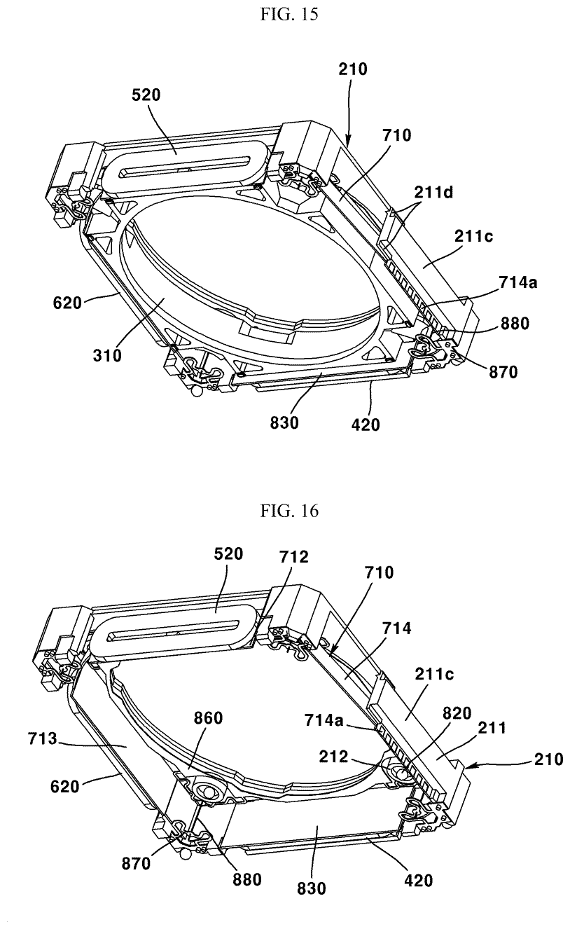

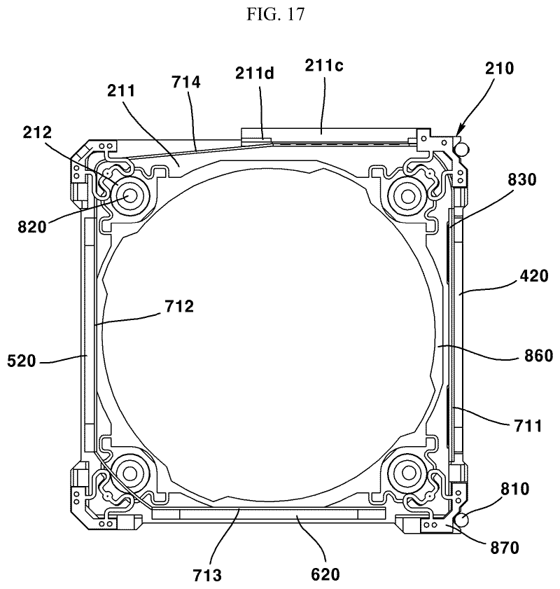

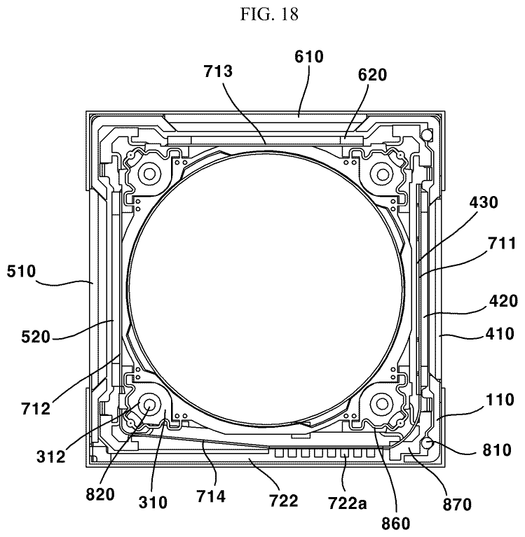

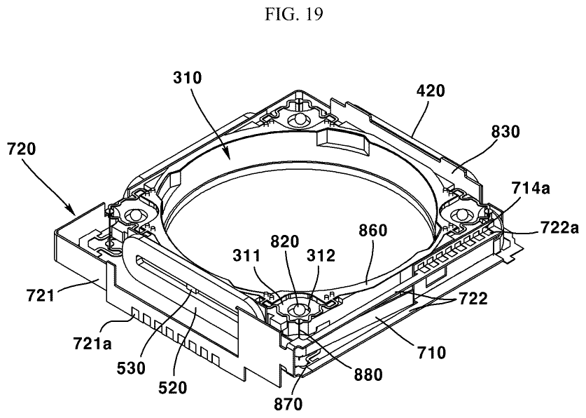

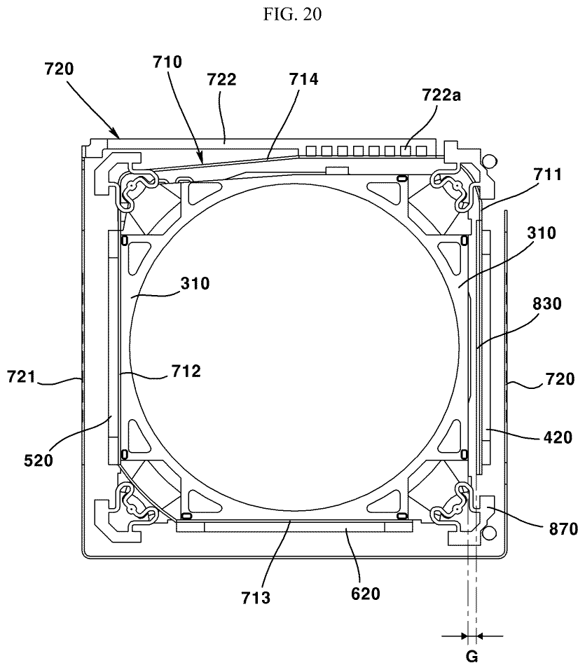

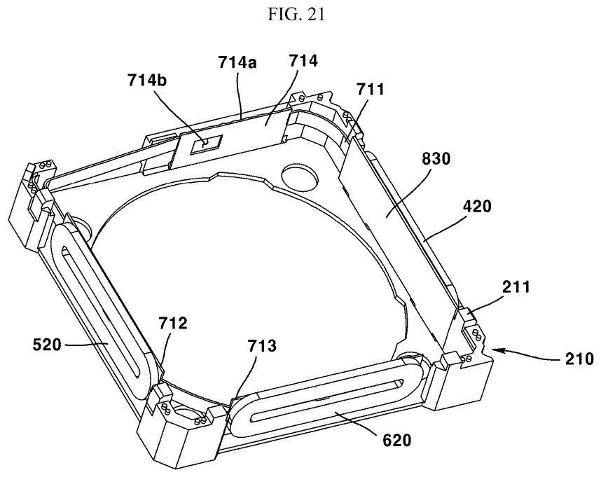

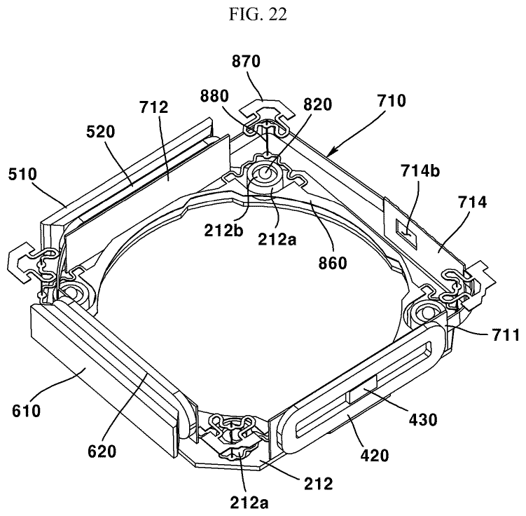

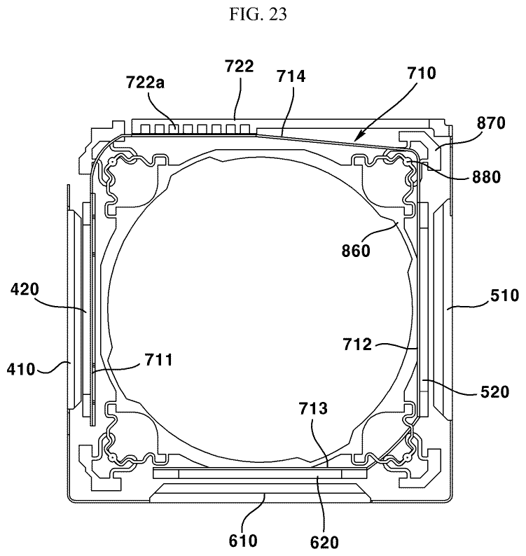

FIG. 1 is a conceptual diagram of a lens driving device according to a first embodiment of the present invention; FIG. 2 is a perspective view of a lens driving device according to a first embodiment of the present invention; FIG. 3 is a cross-sectional view taken along line A-A of FIG. 2; FIG. 4 is a cross-sectional view taken along line B-B of FIG. 2; FIG. 5 is an exploded perspective view of a lens driving device according to a first embodiment of the present invention; FIG. 6 is a perspective view of a lens driving device according to a first embodiment of the present invention with a cover removed; FIG. 7 is an enlarged view illustrating an enlarged portion of FIG. 6; FIG. 8 is a perspective view of a lens driving device in a state of FIG. 6 viewed from a different direction from FIG. 6; FIG. 9 is a perspective view of a lens driving device according to a first embodiment of the present invention with a fixed unit and some components omitted; FIG. 11 is a bottom perspective view of a moving unit and related components of a lens driving device according to a first embodiment of the present invention with a cover removed; FIG. 12 is a perspective view illustrating a base and a second substrate of a lens driving device according to a first embodiment of the present invention; FIG. 13 is a perspective view illustrating a moving unit and a second substrate of a lens driving device according to a first embodiment of the present invention; FIG. 14 is a bottom perspective view of a lens driving device of FIG. 13 from a different direction than FIG. 13; FIG. 15 is a bottom perspective view of a lens driving device of FIG. 14 with a cover and a second substrate removed; FIG. 16 is a bottom perspective view of a lens driving device of FIG. 15 with a first holder removed; FIG. 17 is a bottom perspective view of a lens driving device of FIG. 16; FIG. 18 is a plan view of a lens driving device according to a first embodiment of the present invention with a cover and a pressing portion of a first holder removed; FIG. 19 is a perspective view illustrating a second moving unit and a substrate and related configuration of a lens driving device according to a first embodiment of the present invention; FIG. 20 is a bottom view and a partially enlarged view of a lens driving device in a state of FIG. 19; FIG. 21 is a perspective view of a first holder and a second substrate and related component of a lens driving device according to a first embodiment of the present invention; FIG. 22 is a bottom perspective view illustrating a driving unit, substrate, elastic member, and the like of a lens driving device according to a first embodiment of the present invention; FIG. 23 is a plan view illustrating a driving unit, substrate, and elastic member of a lens driving device according to a first embodiment of the present invention; FIG. 24 is a perspective view illustrating a first substrate and a coil of a lens driving device according to a first embodiment of the present invention;

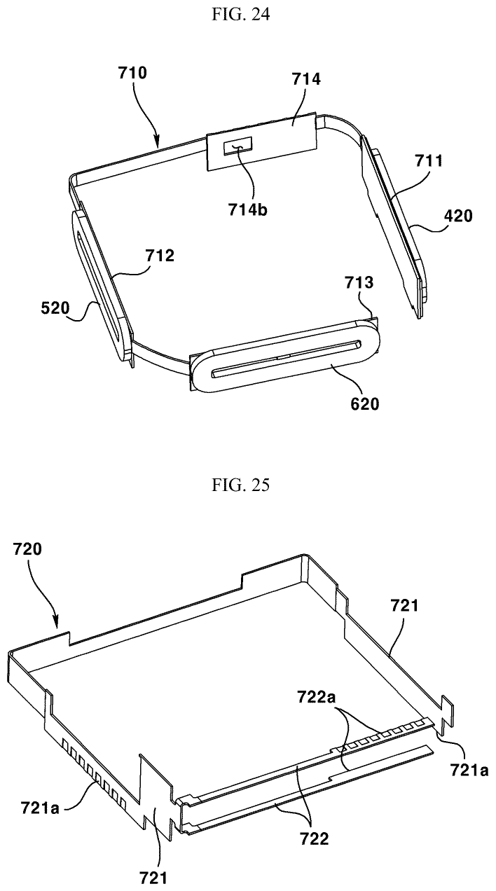

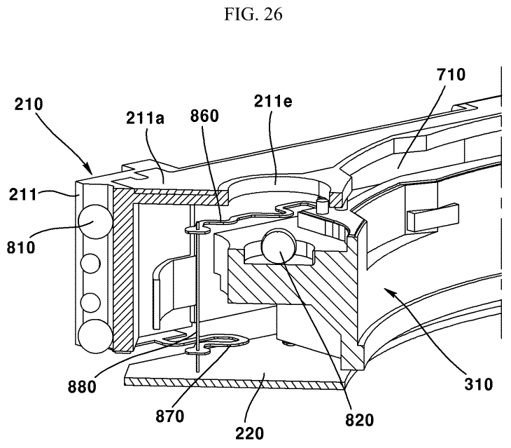

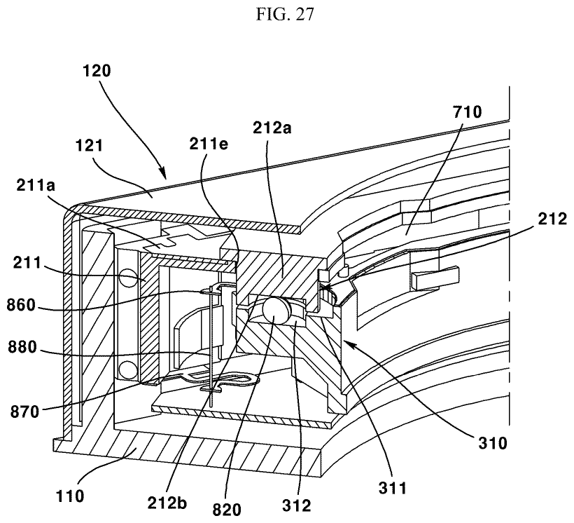

FIG. 25 is a perspective view illustrating a second substrate of a lens driving device according to a first embodiment of the present invention; FIG. 26 is a cross-sectional perspective view of a lens driving device according to a first embodiment of the present invention with a pressing portion of a first holder removed; and FIG. 27 is a cross-sectional perspective view of FIG. 26 with a pressing portion of a first holder, and the like added.

The lens driving device 10 may be a voice coil motor (VCM). The lens driving device 10 may be a lens driving motor. The lens driving device 10 may be a lens driving actuator. The lens driving device 10 may comprise an AF module. The lens driving device 10 may comprise an OIS module.

The lens driving device 10 may comprise a fixed unit 100. The fixed unit 100 may be a portion that is relatively fixed when the moving unit moves. The moving unit may move against the fixed unit 100.

The lens driving device 10 may comprise a base 110. The fixed unit 100 may comprise a base 110. The base 110 may be disposed below the first holder 210. The base 110 may be disposed below the second holder 310. The base 110 may be coupled with the cover 120. The first holder 210 and the second holder 310 may be disposed on the base 110. The first holder 210 and the second holder 310 may be disposed on a lower plate of the base 110. The first holder 210 and the second holder 310 may be disposed inside the base 110. The first holder 210 and the second holder 310 may be disposed inside a side plate of the base 110.

In a first embodiment of the present invention, all of the first to third magnets 410, 510, and 610 can be disposed on the base 110. All of the first to third magnets 410, 510, and 610 can be disposed on the fixed unit 100. That is, all of the first to third magnets 410, 510, and 610 can be maintained in a fixed state during the auto focus operation. In addition, all of the first to third magnets 410, 510, and 610 can be maintained in a fixed state during the shake correction operation. During the auto focus operation, the first magnet 410 is fixed and the first coil 420 can move. During the shake correction operation, the second and third magnets 510 and 610 are fixed and the second and third coils 520 and 620 can move.

The base 110 may comprise a lower plate. The base 110 may comprise a side plate. The side plate may be a ‘side portion’. The side plate of the base 110 may be extended from an upper surface of the lower plate.

The side plate of the base 110 may comprise a plurality of side plates. The side plate of the base 110 may comprise four side plates. However, one or more of the four side plates of the base 110 may be omitted. The side plate of the base 110 may comprise first to fourth side plates 111, 112, 113 and 114. The base 110 may comprise a first side plate 111 and a second side plate 112 which are disposed opposite each other, and a third side plate 113 and a fourth side plate 114 which are disposed opposite each other.

The side portion of the base 110 may comprise a plurality of side portions. The side portion of the base 110 may comprise four side portions. However, at least one among the four side portions of the base 110 may be omitted. The side portion of the base 110 may comprise first to fourth side portions. The base 110 may comprise a first side portion and a second side portion being disposed opposite to each other, and a third side portion and a fourth side portion being disposed opposite to each other.

The first magnet 410 may be disposed on a first side plate of the base 110. The second magnet 510 may be disposed on a second side plate of the base 110. The third magnet 610 may be disposed on a third side plate of the base 110.

The first side plate 111 of the base 110 may comprise a groove 111a. The groove 111a may be a ‘first ball accommodating groove’. The first ball 810 may be disposed in the groove 111a. The groove 111a may be in direct contact with the first ball 810. The groove 111a may be disposed in the optical axis direction. The groove 111a may comprise a plurality of grooves. The groove 111a may comprise two grooves. The two grooves may be disposed parallel to each other. The groove 111a may comprise a first groove being in contact with the first ball 810 at two points, and a second groove being in contact with the first ball 810 at one point. In a modified embodiment, both the first groove and the second groove may be in contact with the first ball 810 at two points.

The second side plate 112 of the base 110 may comprise a protruded portion 112a. The protruded portion 112a may be protruded outward. The leg portion 722 of the second substrate 720 may be disposed above and below the protruded portion 112a. A groove may be formed in the protruded portion 112a so as not to interfere with the leg portion 722 of the second substrate 720 when it moves.

The base 110 may comprise a step 115. The step 115 may be formed at a lower portion of an outer surface of the base 110. The step 115 may be protruded from an outer surface of the base 110. A side plate 122 of the cover 120 may be disposed on the step 115 of the base 110.

The lens driving device 10 may comprise a cover 120. The fixed unit 100 may comprise a cover 120. The cover 120 may be disposed on a base 110. The cover 120 may be coupled to the base 110. The cover 120 may be fixed to the base 110. The cover 120 may accommodate a first holder 210 therein. The cover 120 may accommodate a second holder 310 therein. The cover 120 may be a shield member. The cover 120 may be a shield can.

The cover 120 may comprise an upper plate 141. The upper plate 141 may be disposed on a moving unit. The upward movement of the moving unit may be limited by the moving unit by being in contact with the upper plate 141. The upper plate 141 may comprise a hole through which light passes

The cover 120 may comprise a side plate 142. The side plate 142 may be extended from the upper plate 141. The side plate 142 may be disposed on the base 110. The side plate 142 may be disposed in a step portion being protruded from a lower portion of an outer surface of the base 110. The side plate 142 may comprise a plurality of side plates. The side plate 142 may comprise four side plates. The side plate 142 may comprise a first side plate and a second side plate being disposed opposite to each other, and a third side plate and a fourth side plate being disposed opposite to each other.

The lens driving device 10 may comprise a moving unit. The moving unit may be disposed in the fixed unit 100. The moving unit may be disposed inside the fixed unit 100. The moving unit may be disposed on the fixed unit 100. The moving unit may be movably disposed in the fixed unit 100. The moving unit may be moved with respect to the fixed unit 100 by the driving unit. The moving unit may be moved during AF driving. The moving unit may be moved during OIS driving. A lens may be coupled to the moving unit.

The lens driving device 10 may comprise a first moving unit 200. The first moving unit 200 may be an ‘AF moving unit’. The first moving unit 200 may be disposed in the fixed unit 100. The first moving unit 200 may be disposed inside the fixed unit 100. The first moving unit 200 may be disposed on the fixed unit 100. The first moving unit 200 may be disposed between the fixed unit 100 and the second moving unit 300. The first moving unit 200 may be movably disposed in the fixed unit 100. The first moving unit 200 may be moved in an optical axis direction against the fixed unit 100 by the first driving unit. The first moving unit 200 may be moved during AF driving.

The lens driving device 10 may comprise a first holder 210. The first moving unit 200 may comprise a first holder 210. The first holder 210 may be an ‘AF holder’. The first holder 210 may be an ‘AF carrier’. The first holder 210 may be disposed inside the base 110. The first holder 210 may be disposed on the base 110. The first holder 210 may be disposed inside the cover 120. The first holder 210 may be disposed between the base 110 and the second holder 310. The first holder 210 may be disposed so as to be movable in an optical axis direction.

The lens driving device 10 may comprise a body portion 211. The first holder 210 may comprise a body portion 211. The body portion 211 may be formed separately from the pressing portion 212. A second elastic member 870 may be coupled to the body portion 211.

The first holder 210 may comprise a metal member 211a. The body portion 211 may comprise a metal member 211a. The metal member 211a may be insert-molded into the body portion 211. At least a portion of the metal member 211a may be disposed on an upper surface of the body portion 211. The metal member 211a may be disposed to reinforce the strength of the body portion 211.

The first holder 210 may comprise a groove 211b. The body portion 211 may comprise a groove 211b. The groove 211b may be a ‘first ball accommodating groove’. A first ball 810 may be disposed in the groove 211b. The groove 211b may be in direct contact with the first ball 810. The groove 211b may be disposed in an optical axis direction. The groove 211b may comprise a plurality of grooves. The groove 211b may comprise two grooves. The two grooves may be disposed parallel to each other. The groove 211b may comprise a first groove being in contact with the first ball 810 at two points, and a second groove being in contact with the first ball 810 at one point. In a modified embodiment, both the first groove and the second groove can be in contact with the first ball 810 at two points.

The first holder 210 may comprise a protruded portion 211c. The body portion 211 may comprise a protruded portion 211c. The protruded portion 211c may be formed on an outer surface of the first holder 210. The protruded portion 211c may be protruded outwardly from the first holder 210. Leg portions 722 may be disposed on an upper surface and a lower surface of the protruded portion 211c.

The first holder 210 may comprise a protrusion 211d. The body portion 211 may comprise the protrusion 211d. The protrusion 211d may be formed in the protruded portion 211c. The protrusion 211d may be formed to be protruded on the protruded portion 211c. The protrusion 211c may be formed on at least one of an upper surface and a lower surface of the protruded portion 211c. The protrusion 211c may be formed to catch the leg portion 722. Through this, the protrusion 211c may prevent the leg portion 722 from being separated from the original position.

The first holder 210 may comprise a hole 211e. The body portion 211 may comprise a hole 211e. The hole 211e may be formed in an upper plate of the body portion 211. A pressing portion 212 may be inserted into the hole 211e. A protrusion 212a of the pressing portion 212 may be inserted into the hole 211e.

The lens driving device 10 may comprise a pressing portion 212. The first holder 210 may comprise a pressing portion 212. The pressing portion 212 may be coupled to an upper surface of the body portion 211. The pressing portion 212 may be coupled to the body portion 211. The pressing portion 212 may be inserted into and coupled to the body portion 211 from the upper side. The pressing portion 212 may press the second ball 820. The pressing portion 212 may be in direct contact with the second ball 820.

The first holder 210 may comprise a protrusion 212a. The pressing portion 212 may comprise a protrusion 212a. The protrusion 212a may be coupled to a hole 211e of the body portion 211. The protrusion 212a may comprise a plurality of protrusions. The protrusion 212a may comprise four protrusions.

The first holder 210 may comprise a groove 212b. The pressing portion 212 may comprise a groove 212b. The groove 212b may be a ‘second ball accommodating groove’. The groove 212b may be formed in the protrusion 212a. The groove 212b may be formed on a lower surface of the protrusion 212a. The groove 212b may be concavely formed on a lower surface of the protrusion 212a. A second ball 820 may be disposed in the groove 212b. The groove 212b may be in direct contact with the second ball 820.

The lens driving device 10 may comprise a cover 220. The first moving unit 200 may comprise a cover 220. The cover 220 may be coupled with the first holder 210. The cover 220 may be coupled to a lower surface of the first holder 210. The cover 220 may be coupled to the first holder 210 from the lower side. The cover 220 may comprise a hook 221. The hook 221 of the cover 220 may be coupled to the first holder 210. The hook 211 of the cover 220 is protruded upward and may be coupled to a side surface of the first holder 210.

The lens driving device 10 may comprise a second moving unit 300. The second moving unit 300 may be an ‘OIS moving unit’. The second moving unit 300 may be disposed in the fixed unit 100. The second moving unit 300 may be disposed in the fixed unit 100. The second moving unit 300 may be disposed on the fixed unit 100. The second moving unit 300 may be disposed inside the first moving unit 200. The second moving unit 300 may be movably disposed. The second moving unit 300 may move in a direction perpendicular to the optical axis against the fixed unit 100 and the first moving unit 200 by the second driving unit. The second moving unit 300 may move during OIS driving.

The lens driving device 10 may comprise a second holder 310. The second moving unit 300 may comprise a second holder 310. The second holder 310 may be an ‘OIS holder’. The second holder 310 may be an ‘OIS carrier’. The second holder 310 may be disposed inside the first holder 210. The second holder 310 may be disposed inside the base 110. The second holder 310 may be disposed on the base 110. The second holder 310 may be disposed inside the cover 120. The second holder 310 may be disposed so as to be movable in a direction perpendicular to the optical axis.

The second holder 310 may comprise an outer surface. The second holder 310 may comprise a plurality of side surfaces. The second holder 310 may comprise a first side surface and a second side surface being disposed opposite to each other, and a third side surface and a fourth side surface being disposed opposite to each other. The first coil 420 may be disposed between a first side surface of the second holder 310 and the first magnet 410. The second coil 520 may be disposed between a second side surface of the second holder 310 and the second magnet 510. The third coil 620 may be disposed between a third side surface of the second holder 310 and the third magnet 610.

The second holder 310 may comprise a first groove 311. The first groove 311 may be a ‘first elastic member interference prevention groove’. The first groove 311 may be formed on an upper surface of the second holder 310. The first groove 311 may be formed concavely on an upper surface of the second holder 310. The first groove 311 may be disposed at a position corresponding to the first elastic member 860 to prevent interference between the second holder 310 and the first elastic member 860.

The second holder 310 may comprise a second groove 312. The second groove 312 may be a ‘second ball accommodating groove’. A second ball 820 may be disposed in the second groove 312. The second groove 312 may be in direct contact with the second ball 820. The second groove 312 may be disposed in a direction perpendicular to the optical axis. The second groove 312 may be recessed in a direction of the optical axis. The second groove 312 may comprise a plurality of grooves. The second groove 312 may comprise four grooves. The second groove 312 may be in contact with the second ball 820 at one point. Or, the second groove 312 may be in contact with the second ball 820 at two points. The number of points where the second holder 310 and the second ball 820 come into contact may vary due to movement of the second ball 820. The second groove 312 may be formed in the first groove 311. The second groove 312 may be additionally recessed from the first groove 311.

The second holder 310 may comprise a lateral stopper 313. The lateral stopper 313 may limit a lateral stroke of the second holder 310. That is, when the second holder 310 moves to the maximum, the lateral stopper 313 of the second holder 310 may be in contact with at least one of the first holder 210 and the base 110. The lateral stopper 313 may be formed on an outer surface of the second holder 310. The lateral stopper 313 may be protruded outwardly from a side surface of the second holder 310.

The lens driving device 10 may comprise a driving unit. The driving unit may move a moving unit against the fixed unit 100. The driving unit may comprise an AF driving unit. The driving unit may comprise an OIS driving unit. The driving unit may comprise a coil and a magnet.

The lens driving device 10 may comprise a first driving unit. The first driving unit may be an ‘AF driving unit’. The first driving unit may move the first holder 210 in an optical axis direction. The first driving unit may move the first holder 210 in an optical axis direction through electromagnetic force. The first driving unit may comprise a coil and a magnet.

In a first embodiment of the present invention, the first holder 210 and the second holder 310 can move in an optical axis direction by the interaction between the first coil 420 and the first magnet 410. The first coil 420, the first holder 210, and the second holder 310 can move in the optical axis direction as one unit.

The lens driving device 10 may comprise a first magnet 410. The first driving unit may comprise a first magnet 410. The first magnet 410 may be an ‘AF magnet’. The first magnet 410 may be disposed in the base 110. The first magnet 410 may be disposed in the cover 120. The first magnet 410 may be disposed in the side plate 122 of the cover 120. The first magnet 410 may be disposed on an outer surface of the base 110. The first magnet 410 may be disposed on an inner side surface of the base 110. The first magnet 410 may be fixed to the base 110. The first magnet 410 may be coupled to the base 110. The first magnet 410 can be attached to the base 110 by an adhesive. The first magnet 410 can be disposed inside the cover 120. The first magnet 410 can interact with the first coil 420. The first magnet 410 can electromagnetically interact with the first coil 420. The first magnet 410 can be disposed at a position corresponding to the first coil 420. The first magnet 410 can face the first coil 420. The first magnet 410 and the first coil 420 may face each other. The first magnet 410 can be overlapped with the first coil 420 in a direction perpendicular to the optical axis.

The first magnet 410 may be a four-pole magnet. The first magnet 410 may comprise a four-pole magnetizing magnet. The first magnet 410 may comprise a first magnet portion comprising an N pole and an S pole, and a second magnet portion comprising an N pole and an S pole. The first magnet portion and the second magnet portion may be disposed in a vertical direction. The first magnet portion and the second magnet portion may be disposed spaced apart from each other in a vertical direction, and a neutral portion may be disposed between the first magnet portion and the second magnet portion.

The lens driving device 10 may comprise a first coil 420. The first driving unit may comprise a first coil 420. The first coil 420 may be an ‘AF coil’. The first coil 420 may interact with the first magnet 410. The first coil 420 may move in an optical axis direction. The first coil 420 may move in an optical axis direction through interaction with the first magnet 410. The first coil 420 may face the first magnet 410. The first coil 420 and the first magnet 410 may face each other. The first coil 420 may be disposed at a position corresponding to the first magnet 410. The first coil 420 may be overlapped with the first magnet 410 in a direction perpendicular to the optical axis. The first coil 420 may be disposed in the first substrate 710. The first coil 420 may be disposed in the first portion 711 of the first substrate 740. The first coil 420 may be disposed in the first holder 210. The first coil 420 may be disposed in the first moving unit 200.

The lens driving device 10 may comprise a first sensor 430. The first driving unit may comprise a first sensor 430. The first sensor 430 may be an ‘AF sensor’. The first sensor 430 may be a Hall sensor. The first sensor 430 may be disposed in a substrate 740. The first sensor 430 may be disposed in a first portion 711 of the substrate 740. The first sensor 430 may detect a first magnet 410. The first sensor 430 may detect movement of the first magnet 410. The movement amount or position of the first magnet 410 detected by the first sensor 430 may be used for feedback of auto focus driving.

The first sensor 430 may be a driver IC. The driver IC may comprise a sensing unit. The sensing unit may comprise a Hall element (Hall IC). The driver IC may be electrically connected to the first coil 420. The driver IC may supply current to the first coil 420.

The first sensor 430 may be disposed inside the first coil 420. The first sensor 430 may be overlapped with a neutral portion of the first magnet 410 in a direction perpendicular to the optical axis. In a modified embodiment, the first sensor 430 may be disposed at an outside of the first coil 420.

The lens driving device 10 may comprise a second driving unit. The second driving unit may be an ‘OIS-x driving unit’. The second driving unit may move the second holder 310 in a first direction perpendicular to the optical axis. The second driving unit may move the second holder 310 in a first direction perpendicular to the optical axis through electromagnetic force. At this time, the first direction may be an x-axis direction. The second driving unit may comprise a coil and a magnet.

In a first embodiment of the present invention, the second holder 310 can move in a first direction perpendicular to the optical axis direction by the interaction between the second coil 520 and the second magnet 510. At this time, the first direction may be an x-axis direction. The second coil 520 and the second holder 310 can move in an x-axis direction as one unit.

The lens driving device 10 may comprise a second magnet 510. The second driving unit may comprise a second magnet 510. The second magnet 510 may be an ‘OIS-x magnet’. The second magnet 510 may be disposed in the base 110. The second magnet 510 may be disposed on an outer surface of the base 110. The second magnet 510 may be disposed on an inner surface of the base 110. The second magnet 510 may be fixed to the base 110. The second magnet 510 may be coupled to the base 110. The second magnet 510 may be attached to the base 110 with an adhesive. The second magnet 510 may be disposed inside the cover 120. The second magnet 510 can interact with the second coil 520. The second magnet 510 can electromagnetically interact with the second coil 520. The second magnet 510 can be disposed at a position corresponding to the second coil 520. The second magnet 510 can face the second coil 520. The second magnet 510 and the second coil 520 can be faced each other. The second magnet 510 can be overlapped with the second coil 520 in a direction perpendicular to the optical axis.

The second magnet 610 may be a two-pole magnet. The second magnet 510 may comprise a two-pole magnetizing magnet. The second magnet 510 may comprise an N pole and an S pole.

The lens driving device 10 may comprise a second coil 520. The second driving unit may comprise a second coil 520. The second coil 520 may be an ‘OIS-x coil’. The second coil 520 may interact with a second magnet 510. The second coil 520 may move in an x-axis direction perpendicular to the optical axis. The second coil 520 may move in an x-axis direction through interaction with the second magnet 510. The second coil 520 may face the second magnet 510. The second coil 520 and the second magnet 510 may be faced to each other. The second coil 520 may be disposed at a position corresponding to the second magnet 510. The second coil 520 may be overlapped with the second magnet 510 in a direction perpendicular to the optical axis. The second coil 520 may be disposed in the first substrate 710. The second coil 520 may be disposed in the second portion 712 of the first substrate 710. The second coil 520 may be disposed in the second holder 310. The second coil 520 may be disposed in the second moving unit 300.

The lens driving device 10 may comprise a second sensor 530. The second driving unit may comprise a second sensor 530. The second sensor 530 may be an ‘OIS-x sensor’. The second sensor 530 may be disposed in the first substrate 710. The second sensor 530 may be disposed in the second portion 712 of the first substrate 710. The second sensor 530 may comprise a Hall sensor. The second sensor 530 may detect a second magnet 510. The second sensor 530 may detect a magnetic force of the second magnet 510. The second sensor 530 may be disposed inside a second coil 520. The second sensor 530 may be overlapped with the second coil 520 in an optical axis direction. The second sensor 530 may face the second magnet 510. The second sensor 530 may be disposed at a position corresponding to the second magnet 510. The second sensor 530 may detect movement of the second magnet 510. The amount of movement or position of the second magnet 510 detected by the second sensor 530 may be used for feedback of the shake compensation driving in an x-axis direction.

The lens driving device 10 may comprise a third driving unit. The third driving unit may be an ‘OIS-y driving unit’. The third driving unit may move the second holder 310 in a second direction perpendicular to both the optical axis and the first direction. The third driving unit may move the second holder 310 in a second direction perpendicular to both the optical axis and the first direction through electromagnetic force. At this time, the second direction may be a y-axis direction. The third driving unit may comprise a coil and a magnet.

In a first embodiment of the present invention, the second holder 310 can move in a second direction perpendicular to both the optical axis direction and the first direction by the interaction between the third coil 620 and the third magnet 610. At this time, the second direction can be a y-axis direction. The third coil 620 and the second holder 310 can move in a y-axis direction as one.

The lens driving device 10 may comprise a third magnet 610. The third driving unit may comprise a third magnet 610. The third magnet 610 may be an ‘OIS-y magnet’. The third magnet 610 may be disposed in the base 110. The third magnet 610 may be disposed on an outer surface of the base 110. The third magnet 610 may be disposed on an inner surface of the base 110. The third magnet 610 may be fixed to the base 110. The third magnet 610 may be coupled to the base 110. The third magnet 610 may be attached to the base 110 with an adhesive. The third magnet 610 may be disposed inside the cover 120. The third magnet 610 can interact with the third coil 620. The third magnet 610 can electromagnetically interact with the third coil 620. The third magnet 610 can be disposed at a position corresponding to the third coil 620. The third magnet 610 can face the third coil 620. The third magnet 610 and the third coil 620 can face each other. The third magnet 610 can be overlapped with the third coil 620 in a direction perpendicular to the optical axis.

The third magnet 610 may be a two-pole magnet. The third magnet 610 may comprise a two-pole magnetizing magnet. The third magnet 610 may comprise an N pole and an S pole.

The lens driving device 10 may comprise a third coil 620. The third driving unit may comprise a third coil 620. The third coil 620 may be an ‘OIS-y coil’. The third coil 620 may interact with the third magnet 610. The third coil 620 may be disposed at an opposite side to the first coil 420 with respect to the optical axis. The third coil 620 may move in a y-axis direction perpendicular to both the optical axis and the x-axis. The third coil 620 may move in a y-axis direction through interaction with the third magnet 610. The third coil 620 may face the third magnet 610. The third coil 620 and the third magnet 610 may face each other. The third coil 620 may be disposed at a position corresponding to the third magnet 610. The third coil 620 may be overlapped with the third magnet 610 in a direction perpendicular to the optical axis. The third coil 620 may be disposed in the first substrate 710. The third coil 620 may be disposed in the third portion 713 of the first substrate 710. The third coil 620 may be disposed in the second holder 310. The third coil 620 may be disposed in the second moving unit 300.

The lens driving device 10 may comprise a third sensor 630. The third driving unit may comprise a third sensor 630. The third sensor 630 may be an ‘OIS-y sensor’. The third sensor 630 may be disposed in the first substrate 710. The third sensor 630 may be disposed in a third portion 713 of the first substrate 710. The third sensor 630 may comprise a Hall sensor. The third sensor 630 may detect the third magnet 610. The third sensor 630 may detect a magnetic force of the third magnet 610. The third sensor 630 may be disposed in the third coil 620. The third sensor 630 may be overlapped with the third coil 620 in an optical axis direction. The third sensor 630 may face the third magnet 610. The third sensor 630 may be disposed at a position corresponding to the third magnet 610. The third sensor 630 may detect the movement of the third magnet 610. The amount of movement or position of the third magnet 610 detected by the third sensor 630 may be used for feedback of the shake compensation driving in a y-axis direction.

The lens driving device 10 may comprise a substrate. The substrate may comprise a flexible substrate. The substrate may be electrically connected to a coil. The substrate may be electrically connected to a sensor.

The lens driving device 10 may comprise a first substrate 710. The first substrate 710 may be electrically connected to coils 420, 520, and 620. The first substrate 710 may be electrically connected to sensors 430, 530, and 630. The first substrate 710 may connect the first holder 210 and the second holder 310. The first substrate 710 may elastically connect the first holder 210 and the second holder 310. The first substrate 710 may support the second holder 310 to be movable against the first holder 210. The first substrate 710 may guide the second holder 310 to move in a direction perpendicular to the optical axis against the first holder 210. The first substrate 710 may comprise a flexible substrate. The first substrate 710 may comprise a flexible printed circuit board (FPCB). The first substrate 710 may comprise an elastic portion. The first substrate 710 may comprise an elastic member.

The first substrate 710 may comprise a first portion 711. The first portion 711 may be disposed in the first holder 210. The first coil 420 may be disposed in the first portion 711 of the first substrate 710. The first sensor 430 may be disposed in the first portion 711 of the first substrate 710. The yoke 830 may be disposed in the first portion 711 of the first substrate 710.

The first substrate 710 may comprise a second portion 712. The second portion 712 may be disposed in the second holder 310. The second portion 712 may be disposed on a second side surface of the second holder 310. The second coil 520 may be disposed in the second portion 712 of the first substrate 710. The second sensor 530 may be disposed in the second portion 712 of the first substrate 710.

The first substrate 710 may comprise a third portion 713. The third portion 713 may be disposed in the second holder 310. The third portion 713 may be disposed on a third side surface of the third holder 310. The third coil 620 may be disposed in the third portion 713 of the first substrate 710. The third sensor 630 may be disposed in the third portion 713 of the first substrate 710.

The first substrate 710 may comprise a fourth portion 714. The fourth portion 714 may be disposed between the second holder 310 and the first holder 210. The fourth portion 714 may be disposed between the fourth side surface of the second holder 310 and the first holder 210.

The first substrate 710 may comprise a terminal 714a. The fourth portion 714 of the first substrate 710 may comprise a terminal 714a. The terminal 714a may be electrically connected to coils 420, 520, and 620. The terminal 714a may be electrically connected to sensors 430, 530, and 630.

The first substrate 710 may comprise a hole 714b. The fourth portion 714 of the first substrate 710 may comprise a hole 714b. The hole 714b may be formed to penetrate the fourth portion 714 of the first substrate 710. The hole 714b may be disposed at a position corresponding to the lateral stopper 313 of the second holder 310. Due to the hole 714b, the first substrate 710 may not interfere with the lateral stopper 313 of the second holder 310.

The lens driving device 10 may comprise a second substrate 720. The second substrate 720 may be disposed in the base 110. The second substrate 720 may be electrically connected to coils 420, 520, and 620. The second substrate 720 may be electrically connected to sensors 430, 530, and 630. The second substrate 720 may connect the first holder 210 and the base 110. The second substrate 720 may elastically connect the first holder 210 and the base 110. The second substrate 720 may support the first holder 210 to be movable against the base 110. The second substrate 720 can guide the first holder 210 to move in an optical axis direction against the base 110. The second substrate 720 can comprise a flexible substrate. The second substrate 720 can comprise a flexible printed circuit board (FPCB). The second substrate 720 can comprise an elastic portion. The second substrate 720 can comprise an elastic member.

The second substrate 720 may comprise a body portion 721. The body portion 721 may be disposed in the base 110. The body portion 721 may be formed to surround a side surface of the base 110. The body portion 721 may be disposed on three side surfaces of the base 110. The body portion 721 may comprise two terminal portions. The two terminal portions may be disposed on opposite sides with respect to the optical axis. The terminal portion may comprise a first terminal 721a.

The second substrate 720 may comprise a first terminal 721a. The body portion 720 of the second substrate 720 may comprise a first terminal 721a. The first terminal 721a may be coupled to the terminal 714a of the first substrate 710. The first terminal 721a may be coupled to the terminal 714a of the first substrate 710 through a solder. The first terminal 721a may be coupled to the terminal 714a of the first substrate 710 through a conductive member. The first terminal 721a may be connected to the terminal 714a of the first substrate 710. The first terminal 721a may be electrically connected to the terminal 714a of the first substrate 710.

The second substrate 720 may comprise a leg portion 722. The leg portion 722 may be an ‘extended portion’. The leg portion 722 may be extended from the body portion 721. At least a portion of the leg portion 722 may move together with the first holder 210. The extended portion may be extended from the body portion 721. At least a portion of the extended portion may move together with the first holder 210. The leg portion 722 may comprise a plurality of leg portions. The leg portion 722 may comprise a first leg portion and a second leg portion. The second leg portion may be disposed below the first leg portion.

The second substrate 720 may comprise a second terminal 722a. The leg portion 722 of the second substrate 720 may comprise a second terminal 722a. The second terminal 722a may be electrically connected to the first terminal 721a. The second terminal 722a may be disposed at a lower end of the base 110. The second terminal 722a can be coupled to a printed circuit board 50. The second terminal 722a can be coupled to a terminal of the printed circuit board 50 through a solder. The second terminal 722a can be coupled to a terminal of the printed circuit board 50 through a conductive member. The second terminal 722a can be connected to a terminal of the printed circuit board 50. The second terminal 722a can be electrically connected to a terminal of the printed circuit board 50.

The lens driving device 10 may comprise a guide member. The guide member may comprise a ball. The guide member may comprise a pin. The guide member may comprise a cylindrical member. The guide member may guide movement of the moving unit against the fixed unit 100 in a specific direction.

The lens driving device 10 may comprise a first ball 810. The first ball 810 may be an ‘AF guide ball’. The first ball 810 may guide movement of the first holder 210 against the base 110 in an optical axis direction. The first ball 810 may be disposed between the base 110 and the first holder 210. The first ball 810 may be disposed between the base 110 and the first holder 210 in a first direction. The first ball 810 may be disposed in a groove 111a of the base 110. The first ball 810 may be disposed in a first groove 211b of the first holder 210. The first ball 810 may comprise a first-first ball that contacts the base 110 and the first holder 210 at four points, and a first-second ball that contacts the base 110 and the first holder 210 at three points. The first ball 810 may have a spherical shape. The first ball 810 may be formed of metal. Grease may be applied to the surface of the first ball 810.

The first ball 810 may comprise a plurality of balls. The first ball 810 may comprise eight balls. Four first balls 810 may be disposed on one side of the first magnet 410 and the remaining four first balls 810 may be disposed on the other side of the first magnet 410.

The lens driving device 10 may comprise a second ball 820. The second ball 820 may be an ‘OIS guide ball’. The second ball 820 may guide movement of the second holder 310 against the first holder 210 in a direction perpendicular to the optical axis. The second ball 820 may be disposed between the first holder 210 and the second holder 310. The second ball 820 may be disposed between the first holder 210 and the second holder 310 in an optical axis direction.

The second ball 820 can be disposed between the pressing portion 212 of the first holder 210 and the second holder 310. The second ball 820 can be pressed between the first holder 210 and the second holder 310 by the pressing force of the elastic member 850. The pressing portion 212 can press the second ball 820 downward during the process of being coupled to the body portion 211. The pressing portion 212 can press the second ball 820 toward the second holder 310 during the process of being coupled to the body portion 211. At this time, the second holder 310 can press the second ball 820 toward the pressing portion 212 by the restoring force of the elastic member 850. Accordingly, the second ball 820 can be pressed between the pressing portion 212 and the second holder 310.

The second ball 820 can guide the second holder 310 to move in a first direction and a second direction perpendicular to the optical axis direction with respect to the first holder 210. That is, the second ball 820 can guide the second holder 310 to move in an x-axis direction and a y-axis direction. In other words, the second ball 820 can guide movement in both the x-axis direction and the y-axis direction. For reference, in a first embodiment of the present invention in which the ball guiding the x-axis direction and the ball guiding the y-axis direction are provided integrally, the size of the lens driving device 10 can be minimized when compared to a comparative example in which a ball guiding the x-axis direction and a ball guiding the y-axis direction are provided separately. In particular, the height of the lens driving device 10 in an optical axis direction can be reduced. Through this, the height protruding from the smartphone, that is, the shoulder height can be minimized. The second ball 820 can comprise a plurality of balls. The second ball 820 may comprise four balls.

The lens driving device 10 may comprise a yoke 830. The yoke 830 may be disposed in the first portion 711 of the first substrate 710. An attractive force may be generated between the yoke 830 and the first magnet 410. The yoke 830 may be disposed at a position corresponding to the first magnet 410. The yoke 830 may be formed of metal. The first ball 810 may be pressed between the base 110 and the first holder 210 by the attractive force between the yoke 830 and the first magnet 410. That is, the contact state of the first ball 810 with the base 110 and the first holder 210 may be maintained by the attractive force between the yoke 830 and the first magnet 410.

The lens driving device 10 may comprise an elastic member 850. The elastic member 850 may be formed to pressurize the second ball 820. The elastic member 850 may be formed to guide both the OIS-x-axis driving and the OIS-y-axis driving only with the second ball 820. The elastic member 850 may comprise a leaf spring. The elastic member 850 may comprise a wire. The elastic member 850 may have elasticity. The elastic member 850 may be formed of metal.

The lens driving device 10 may comprise a first elastic member 860. The first elastic member 860 may be an ‘upper elastic member’. The first elastic member 860 may be a leaf spring. The first elastic member 860 may have elasticity. The first elastic member 860 may be disposed on an upper surface of the second holder 310. The first elastic member 860 may be disposed in the second holder 310. The first elastic member 860 may be disposed on an upper portion of the second holder 310. The first elastic member 860 may be disposed above the second holder 310. The first elastic member 860 may be disposed perpendicular to the optical axis.

The lens driving device 10 may comprise a second elastic member 870. The second elastic member 870 may be a ‘lower elastic member’. The second elastic member 870 may be a leaf spring. The second elastic member 870 may have elasticity. The second elastic member 870 may be disposed on a lower surface of the first holder 210. The second elastic member 870 may be disposed in the first holder 210. The second elastic member 870 may be disposed on a lower portion of the first holder 210. The second elastic member 870 may be disposed below the first holder 210. The second elastic member 870 may be disposed on a lower surface of the body portion 721. The second elastic member 870 can be coupled to a lower surface of the body portion 721. The second elastic member 870 can be disposed perpendicular to the optical axis.

The lens driving device 10 may comprise a third elastic member 880. The third elastic member 880 may be a ‘side portion elastic member’. The third elastic member 880 may be a wire. The third elastic member 880 may be a wire spring. The third elastic member 880 may be a suspension wire. The third elastic member 880 may have elasticity. The third elastic member 880 may connect the first elastic member 860 and the second elastic member 870. The third elastic member 880 may elastically connect the first elastic member 860 and the second elastic member 870. The third elastic member 880 may be disposed parallel to an optical axis.

Hereinafter, the auto focus (AF) driving of a lens driving device according to a first embodiment of the present invention will be described with reference to the drawings.

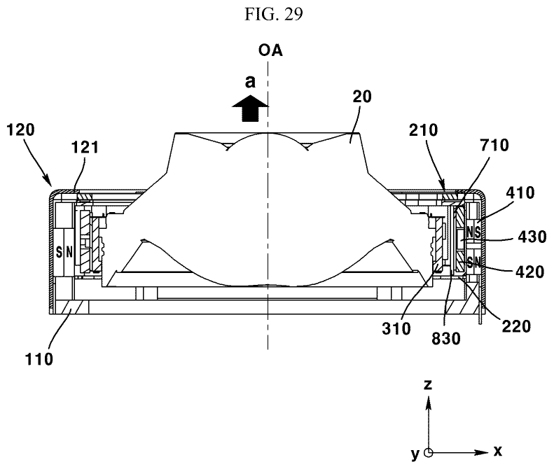

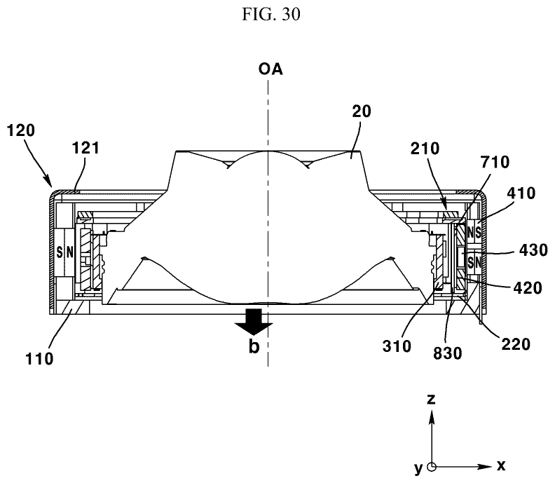

FIGS. 28 to 30 are diagrams for explaining an auto focus driving of a lens driving device according to a first embodiment of the present invention. FIG. 28 is a cross-sectional view illustrating an appearance of a moving unit in an initial state where no current is applied to a first coil. FIG. 29 is a cross-sectional view illustrating an appearance where a moving unit moves upward in an optical axis direction when a forward current is applied to a first coil. FIG. 30 is a cross-sectional view illustrating an appearance where a moving unit moves downward in an optical axis direction when a reverse current is applied to a first coil.

The moving unit may be disposed at a position spaced apart from both the upper plate 121 and the base 110 of the cover 120 in an initial position where no current is applied to the first coil 420. At this time, the moving unit may be the first moving unit 200. In addition, the moving unit may comprise the first and second moving units 200 and 300.

When a forward current is applied to the first coil 420, the first coil 420 can move upward in an optical axis direction due to the electromagnetic interaction between the first coil 420 and the first magnet 410 (see a of FIG. 29). At this time, the first holder 210 can move upward in an optical axis direction together with the first coil 420. Furthermore, the second holder 310 and the lens can move upward in an optical axis direction together with the first holder 210. Accordingly, the distance between the lens and the image sensor can be changed, and the focus of the image being formed on an image sensor through the lens can be adjusted.

When a reverse current is applied to the first coil 420, the first coil 420 can move downward in an optical axis direction due to the electromagnetic interaction between the first coil 420 and the first magnet 410 (see b of FIG. 30). At this time, the first holder 210 can move downward in an optical axis direction together with the first coil 420. Furthermore, the second holder 310 and the lens can move downward in an optical axis direction together with the first holder 210. Accordingly, the distance between the lens and the image sensor can be changed, and the focus of the image being formed on the image sensor through the lens can be adjusted.

Meanwhile, during the movement process of the first coil 420, the first sensor 430 moves together with the first coil 420 and detects the strength of the magnetic field of the first magnet 410 to detect the amount of movement or position of the lens in an optical axis direction. The amount of movement or position of the lens in an optical axis direction detected by the first sensor 430 can be used for auto focus feedback control.

Hereinafter, the optical image stabilization (OIS) operation of a lens driving device according to a first embodiment of the present invention will be described with reference to the drawings.

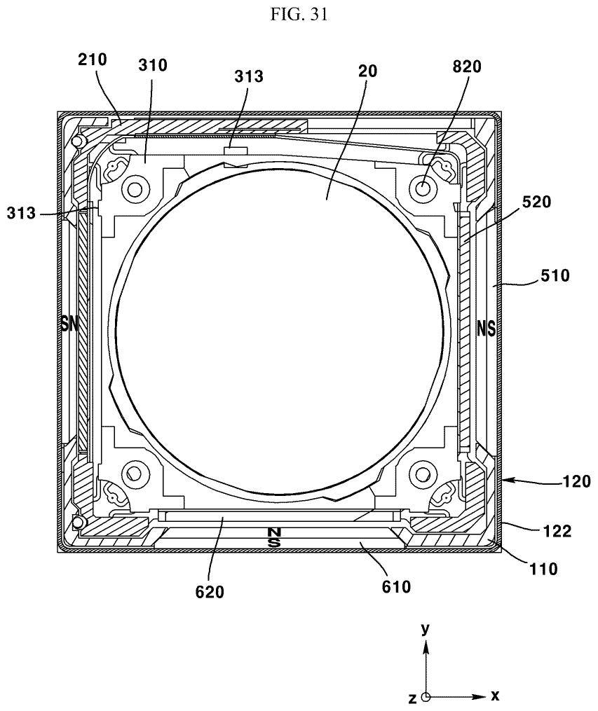

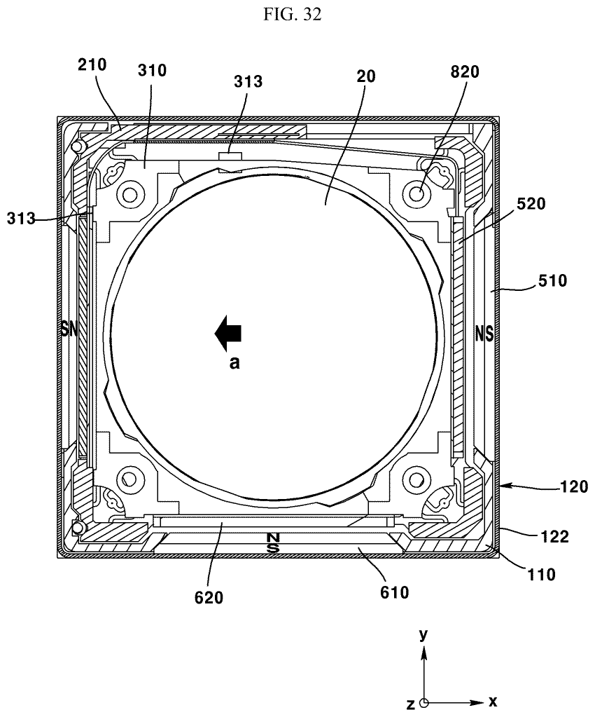

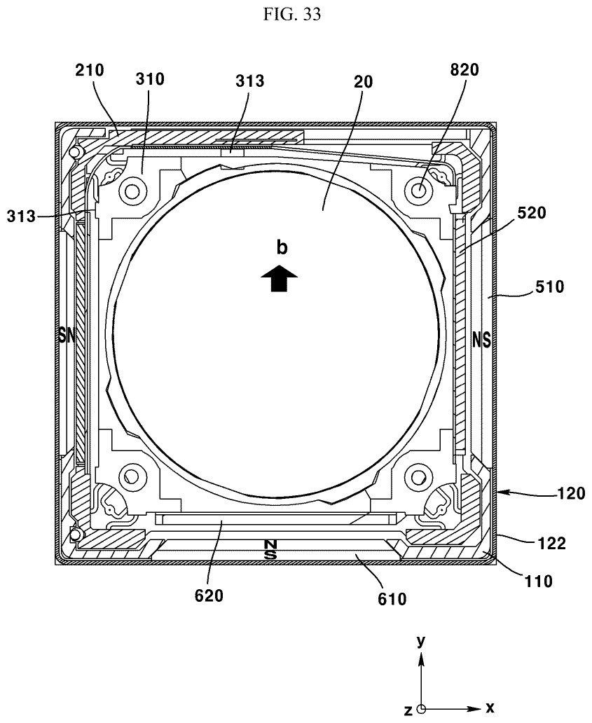

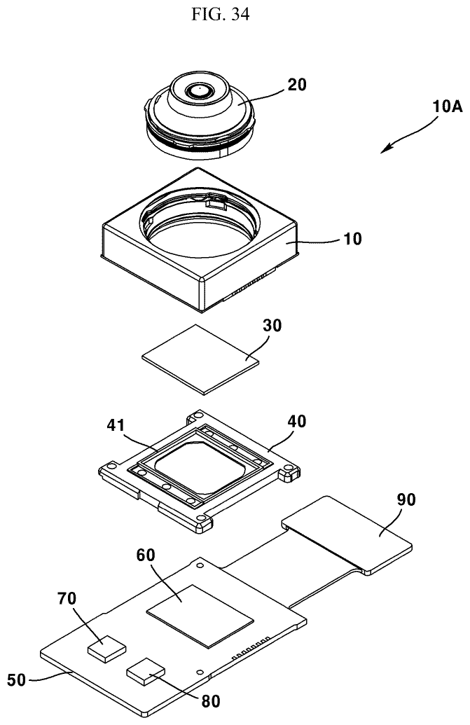

FIGS. 31 to 33 are drawings for explaining a shake correction driving of a lens driving device according to a first embodiment of the present invention. FIG. 31 is a cross-sectional view illustrating an appearance of a moving unit in an initial state where no current is applied to a second coil and a third coil. FIG. 32 is a cross-sectional view illustrating an appearance where a second moving unit moves in an x-axis direction perpendicular to an optical axis when current is applied to a second coil. FIG. 33 is a cross-sectional view illustrating an appearance where a second moving unit moves in a y-axis direction perpendicular to both an optical axis and a x-axis when current is applied to a third coil.

As illustrated in FIG. 31, the moving unit may be disposed in an initial position where no current is applied to the second coil 520 and the third coil 620. At this time, the moving unit may be the second moving unit 300.

When a current is applied to the second coil 520, the second coil 520 can move in an x-axis direction perpendicular to the optical axis due to the electromagnetic interaction between the second coil 520 and the second magnet 510 (see a in FIG. 32a). At this time, the second holder 310 can move in an x-axis direction together with the second coil 520. Furthermore, the lens can move in an x-axis direction together with the second holder 310. In more detail, when a forward current is applied to the second coil 520, the second coil 520, the second holder 310, and the lens can move in one direction along an x-axis. In addition, when a reverse current is applied to the second coil 520, the second coil 520, the second holder 310, and the lens can move in the other direction along an x-axis.

When a current is applied to the third coil 620, the third coil 620 can move in a y-axis direction perpendicular to the optical axis due to the electromagnetic interaction between the third coil 620 and the third magnet 610 (see b in FIG. 33b). At this time, the second holder 310 can move in a y-axis direction together with the third coil 620. Furthermore, the lens can move in a y-axis direction together with the second holder 310. In more detail, when a forward current is applied to the third coil 620, the third coil 620, the second holder 310, and the lens can move in one direction in a y-axis. In addition, when a reverse current is applied to the third coil 620, the third coil 620, the second holder 310, and the lens can move in the other direction in a y-axis.

Meanwhile, the second sensor 530 can detect the amount of movement or position of the second coil 520 by detecting the strength of the magnetic field of the second magnet 510. The amount of movement or position detected by the second sensor 530 can be used for shake correction feedback control in an x-axis direction. The third sensor 630 can detect the amount of movement or position of the third coil 620 by detecting the strength of the magnetic field of the third magnet 610. The amount of movement or position detected by the third sensor 630 can be used for shake correction feedback control in a y-axis direction.

Hereinafter, a camera device according to a first embodiment of the present invention will be described with reference to the drawings.

FIG. 34 is an exploded perspective view of a camera device according to a first embodiment of the present invention.

The camera device 10A may comprise a camera module.

The camera device 10A may comprise a lens module 20. The lens module 20 may comprise at least one lens. The lens may be disposed at a position corresponding to the image sensor 60. The lens module 20 may comprise a lens and a barrel. The lens module 20 may be coupled to the holder 210 of the lens driving device 10. The lens module 20 may be coupled to the holder 210 by screw coupling and/or an adhesive. The lens module 20 may be moved integrally with the holder 210.

The camera device 10A may comprise a filter 30. The filter 30 may serve to block the light of a specific frequency band passing through the lens module 20 from being incident on the image sensor 60. The filter 30 may be disposed parallel to an x-y plane. The filter 30 may be disposed between the lens module 20 and the image sensor 60. The filter 30 may be disposed in the sensor base 40. In a modified embodiment, the filter 30 may be disposed in the base 110. The filter 30 may comprise an infrared filter. The infrared filter may block light of an infrared region from being incident on the image sensor 60.

The camera device 10A may comprise a sensor base 40. The sensor base 40 may be disposed between the lens driving device 10 and the printed circuit board 50. The sensor base 40 may comprise a protruded portion 41 in which a filter 30 is disposed. An opening may be formed in a portion of the sensor base 40 in which the filter 30 is disposed so that light passing through the filter 30 may be incident on the image sensor 60. The adhesive member may couple or attach the base 310 of the lens driving device 10 to the sensor base 40. The adhesive member may additionally serve to prevent foreign substances from entering the interior of the lens driving device 10. The adhesive member may comprise at least one among an epoxy, a thermosetting adhesive, and an ultraviolet-curable adhesive.

The camera device 10A may comprise a printed circuit board (PCB) 50. The printed circuit board 50 may be a substrate or a circuit board. A lens driving device 10 may be disposed on the printed circuit board 50. A sensor base 40 may be disposed between the printed circuit board 50 and the lens driving device 10. The printed circuit board 50 may be electrically connected to the lens driving device 10. An image sensor 60 may be disposed on the printed circuit board 50. Various circuits, elements, control units, and the like may be provided on the printed circuit board 50 to convert an image being formed on the image sensor 60 into an electrical signal and transmit it to an external device.

The camera device 10A may comprise an image sensor 60. The image sensor 60 may be a configuration in which a light passing through a lens and a filter 30 is incident thereon to form an image. The image sensor 60 may be mounted on a printed circuit board 50. The image sensor 60 may be electrically connected to the printed circuit board 50. For example, the image sensor 60 may be coupled to the printed circuit board 50 by surface mounting technology (SMT). As another example, the image sensor 60 may be coupled to the printed circuit board 50 by flip chip technology. The image sensor 60 may be disposed such that its optical axis is aligned with that of the lens. That is, the optical axis of the image sensor 60 and the optical axis of the lens may be aligned. The image sensor 60 can convert light irradiated to the effective image area of the image sensor 60 into an electrical signal. The image sensor 60 can be any one among a charge coupled device (CCD), a metal oxide semi-conductor (MOS), a CPD, and a CID.

The camera device 10A may comprise a motion sensor 70. The motion sensor 70 may be mounted on a printed circuit board 50. The motion sensor 70 may be electrically connected to the control unit 80 through a circuit pattern being provided on the printed circuit board 50. The motion sensor 70 may output rotational velocity information due to the movement of the camera device 10A. The motion sensor 70 may comprise a two-axis or three-axis gyro sensor or an angular velocity sensor.

The camera device 10A may comprise a control unit 80. The control unit 80 may be disposed on a printed circuit board 50. The control unit 80 may be electrically connected to a coil 330 of a lens driving device 10. The control unit 80 may individually control the direction, intensity, amplitude, and the like of the current supplied to the coil 330. The control unit 80 may control the lens driving device 10 to perform an auto focus function and/or a shake correction function. Furthermore, the control unit 80 may perform auto focus feedback control and/or shake correction feedback control for the lens driving device 10.

The camera device 10A may comprise a connector 90. The connector 90 may be electrically connected to the printed circuit board 50. The connector 90 may comprise a port for electrically connecting to an external device.

Hereinafter, an optical device according to a first embodiment of the present invention will be described with reference to the drawings.

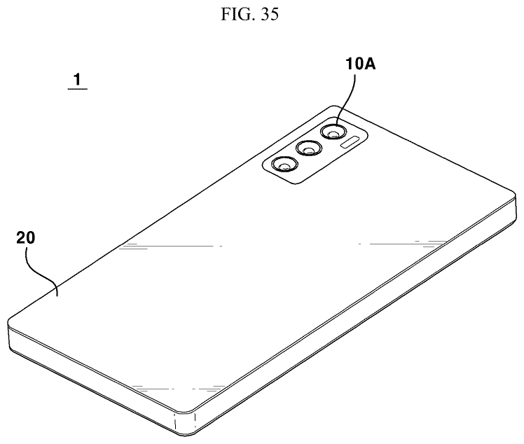

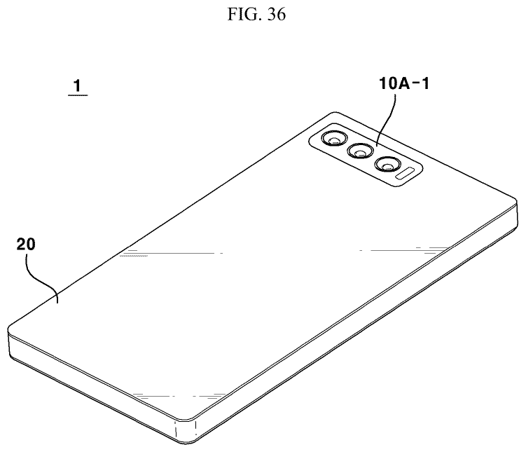

FIG. 35 is a perspective view of an optical device according to a first embodiment of the present invention; and FIG. 36 is a perspective view of an optical device according to a modified embodiment.

The optical device 1 may comprise at least one among a mobile phone, a cellular phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation device. The optical device 1 may comprise any device for photographing videos or pictures.

The optical device 1 may comprise a main body 20. The optical device 1 may comprise a camera device 10A. The camera device 10A may be disposed in the main body 20. The camera device 10A may capture a subject. The optical device 1 may comprise a display. The display may be disposed in the main body 20. The display may output one or more of an image and a video captured by the camera device 10A. The display may be disposed on a first surface of the main body 20. The camera device 10A may be disposed on one or more of the first surface of the main body 20 and the second surface opposite to the first surface. As illustrated in FIG. 22, in the camera device 10A, a triple camera may be disposed in a vertical direction. As illustrated in FIG. 23, in the camera device 10A-1, a triple camera may be disposed in a horizontal direction.

Hereinafter, the configuration of a lens driving device according to a second embodiment of the present invention is described with reference to the drawings.

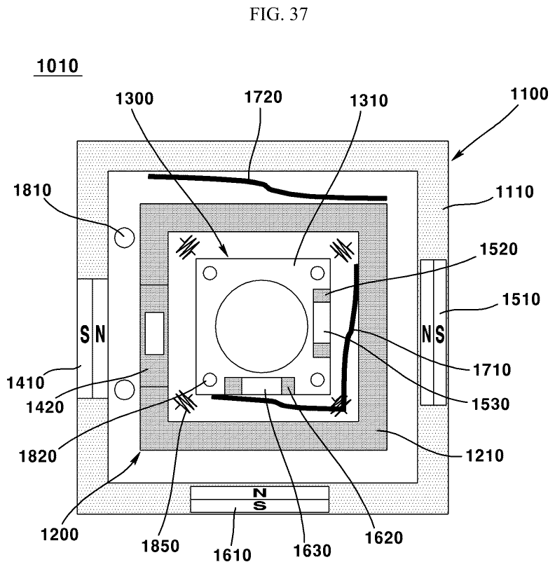

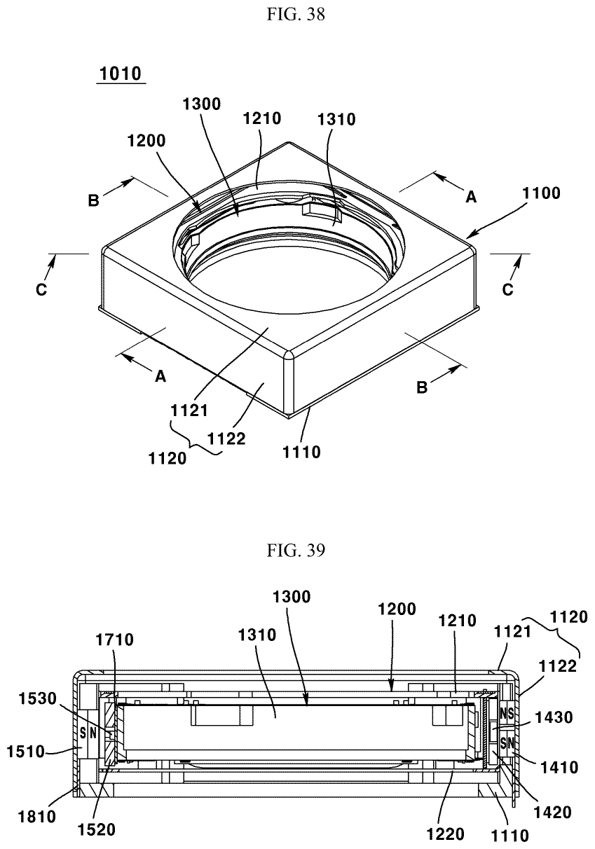

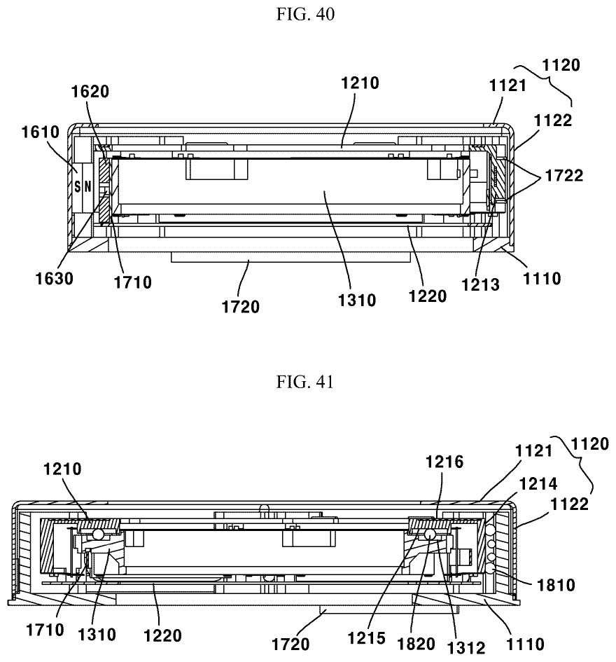

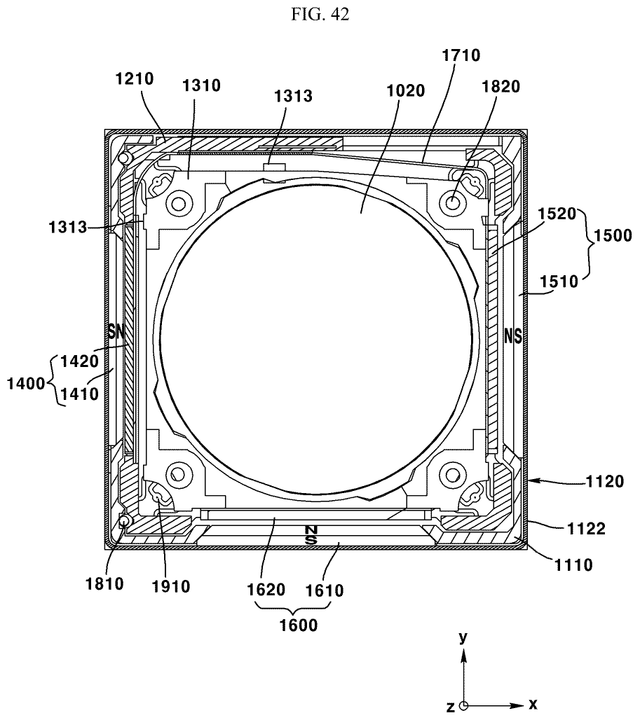

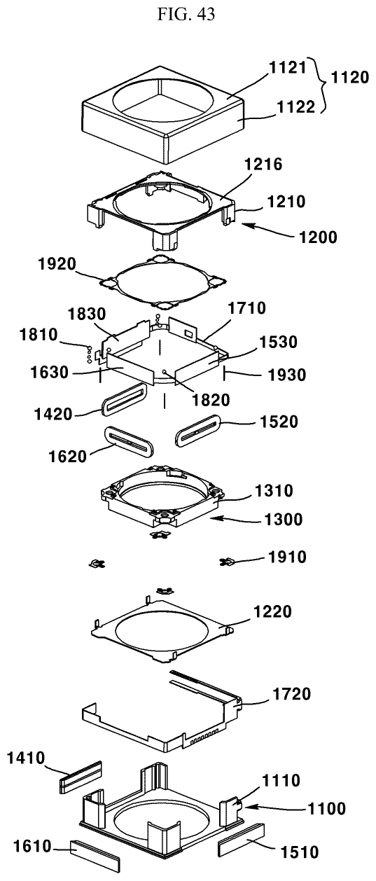

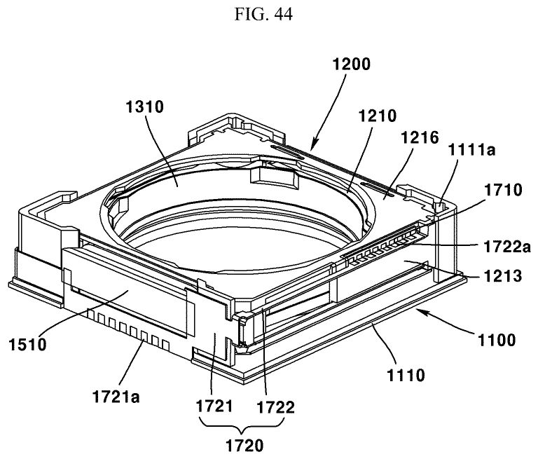

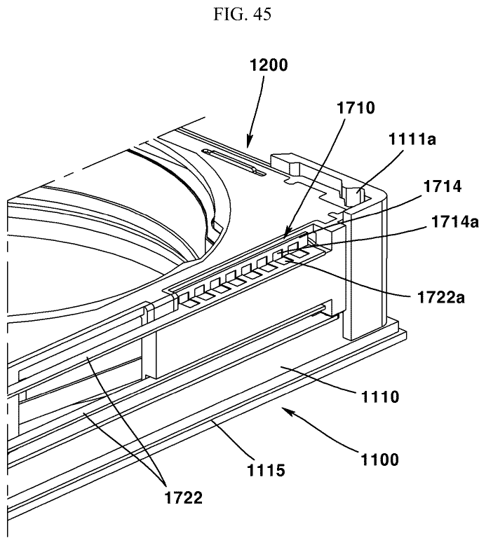

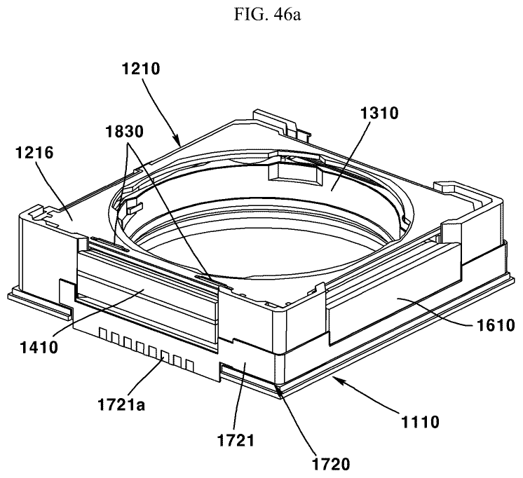

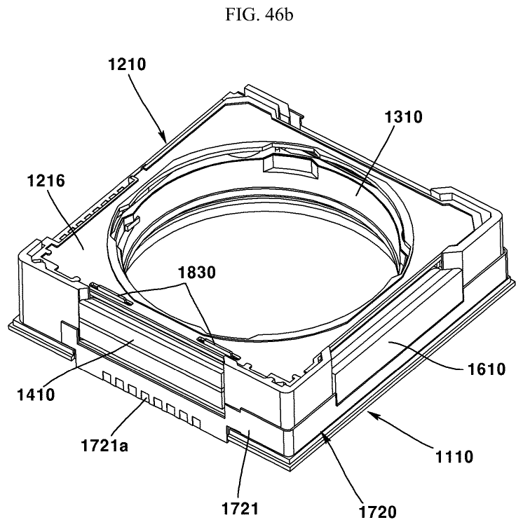

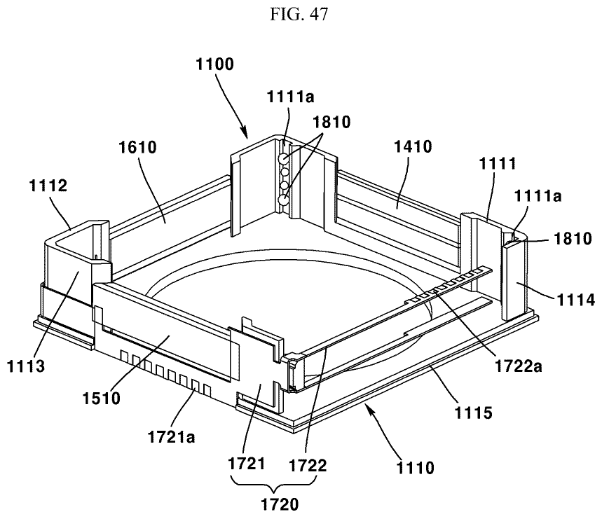

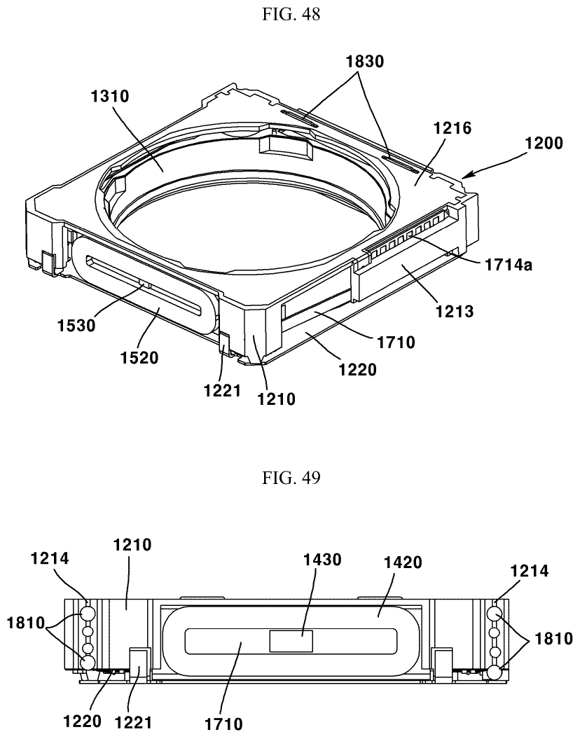

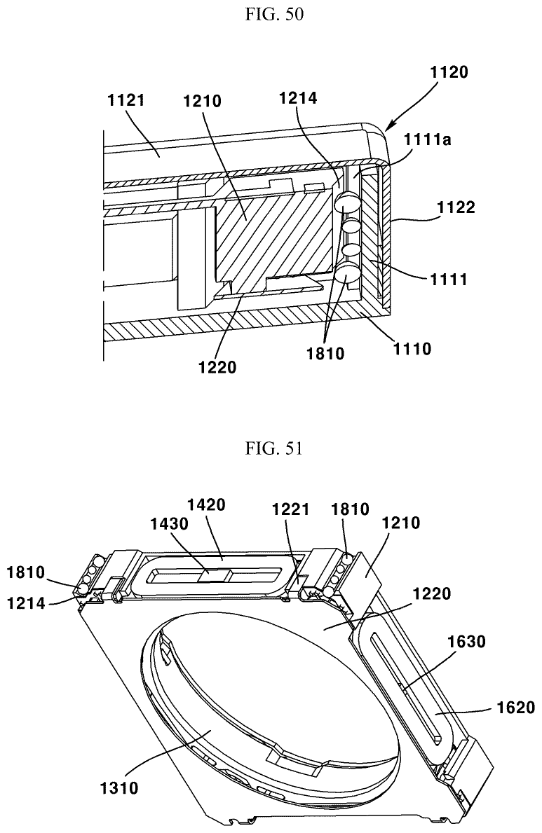

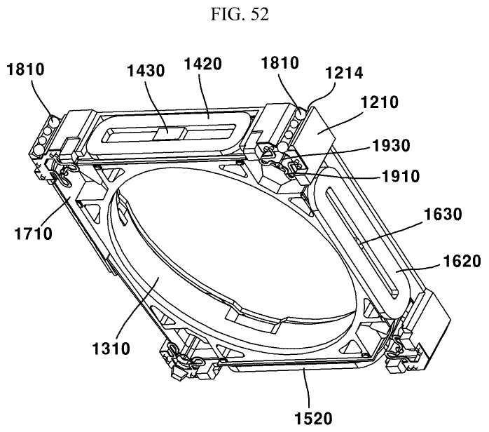

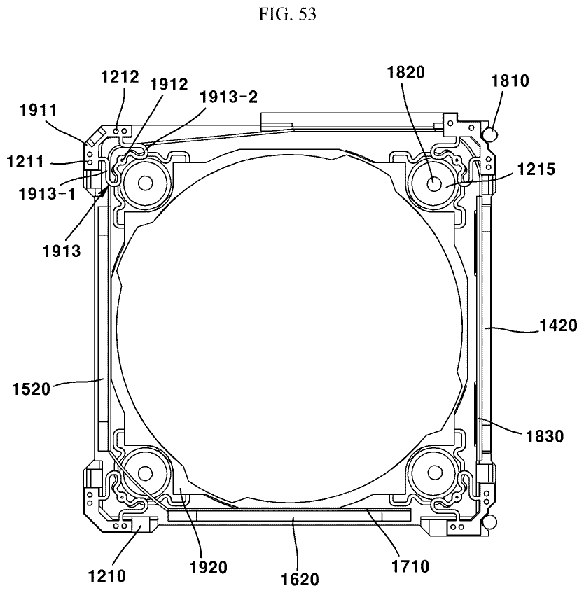

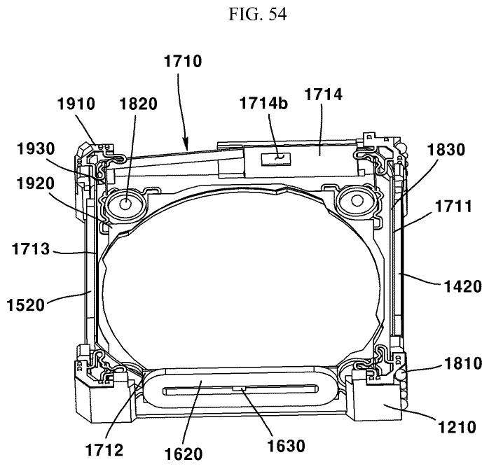

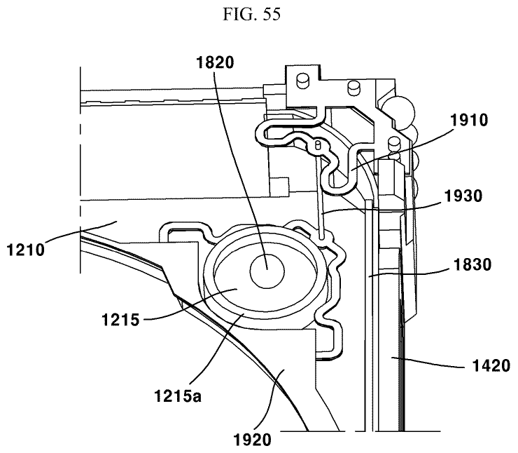

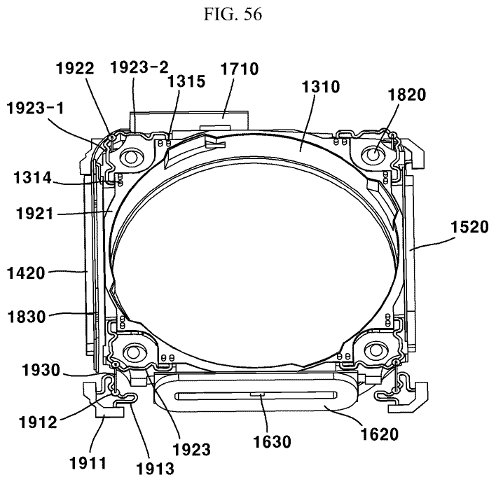

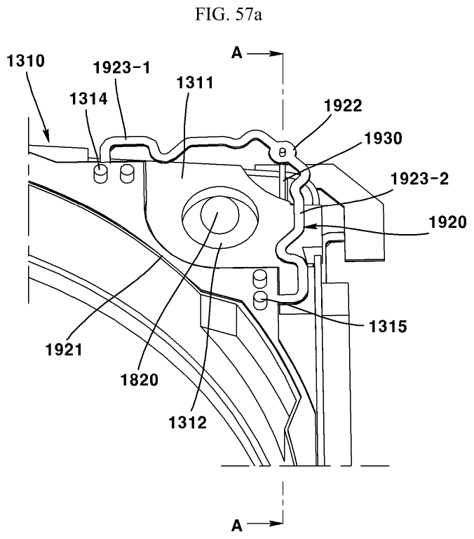

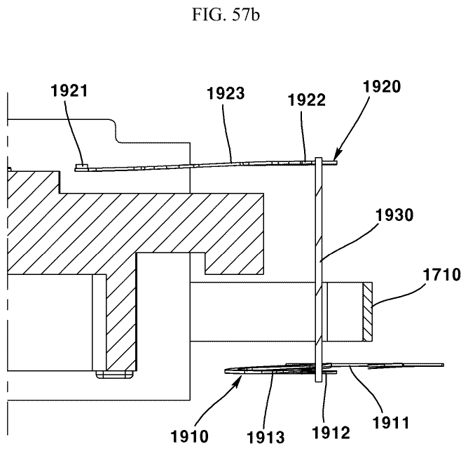

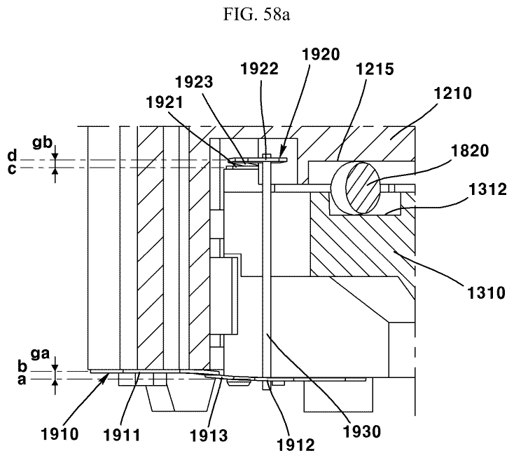

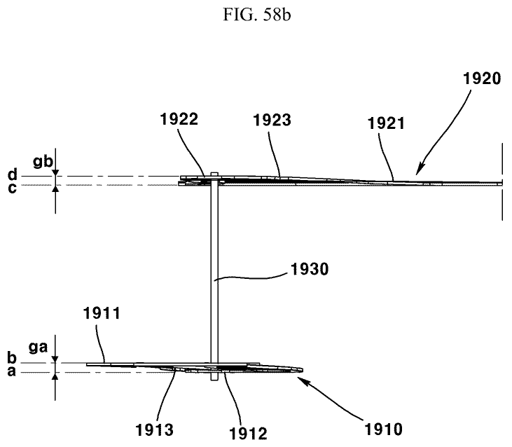

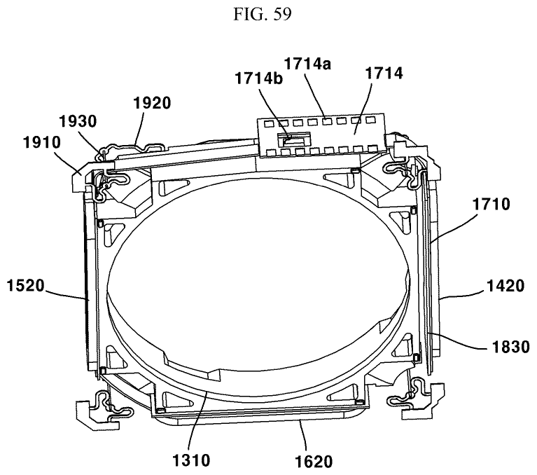

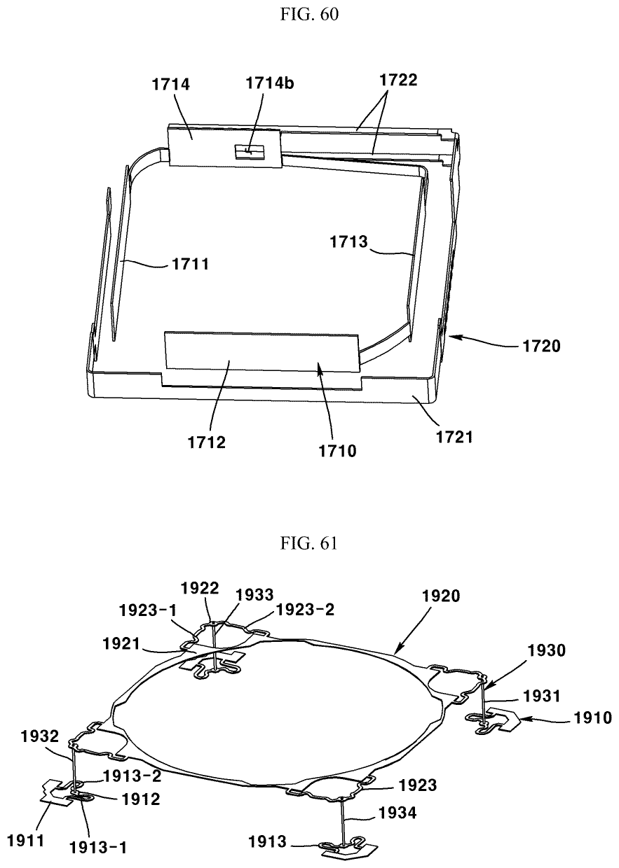

FIG. 37 is a conceptual diagram of a lens driving device according to a second embodiment of the present invention; FIG. 38 is a perspective view of a lens driving device according to a second embodiment of the present invention; FIG. 39 is a cross-sectional view taken along line A-A of FIG. 38; FIG. 40 is a cross-sectional view taken along line B-B of FIG. 38; FIG. 41 is a cross-sectional view taken along line C-C of FIG. 38; FIG. 42 is a cross-sectional view taken from above, cut perpendicular to the optical axis, of a lens driving device according to a second embodiment of the present invention; FIG. 43 is an exploded perspective view of a lens driving device according to a second embodiment of the present invention; FIG. 44 is a perspective view of a lens driving device according to a second embodiment of the present invention with the cover removed; FIG. 45 is an enlarged view illustrating a portion of FIG. 44; FIG. 46a is a perspective view of FIG. 44 viewed from another direction; FIG. 46b is a perspective view illustrating a state in which the metal member of the AF moving unit is omitted in FIG. 46; FIG. 47 is a perspective view illustrating a fixed unit and related components of a lens driving device according to a second embodiment of the present invention; FIG. 48 is a perspective view illustrating a moving unit and related components of a lens driving device according to a second embodiment of the present invention; FIG. 49 is a front view of FIG. 48 as seen from the front; FIG. 50 is a cross-sectional perspective view illustrating an AF guide ball and related component of a lens driving device according to a second embodiment of the present invention; FIG. 51 is a perspective view of FIG. 48 from a different direction; FIG. 52 is a perspective view of FIG. 51 with a cover removed; FIG. 53 is a bottom view of an AF moving unit and related components of a lens driving device according to a second embodiment of the present invention as viewed from below; FIG. 54 is a bottom perspective view of FIG. 53 as viewed from a different direction; FIG. 55 is an enlarged view illustrating a portion of FIG. 54 in an enlarged manner; FIG. 56 is a perspective view illustrating an OIS moving unit and related components of a lens driving device according to a second embodiment of the present invention; FIG. 57a is an enlarged view illustrating a portion of FIG. 56 in an enlarged manner; FIG. 57b is a cross-sectional view as viewed from A-A of FIG. 57a; FIG. 58a is a cross-sectional view illustrating a pressurizing structure of an OIS guide ball of a lens driving device according to a second embodiment of the present invention; FIG. 58b is a cross-sectional view illustrating a coupling structure of an elastic member and a wire of a lens driving device according to a second embodiment of the present invention; FIG. 59 is a bottom perspective view of FIG. 56 viewed from a different direction; FIG. 60 is a perspective view illustrating an inner substrate and an outer substrate of a lens driving device according to a second embodiment of the present invention; and FIG. 61 is a perspective view illustrating an elastic member and a wire of a lens driving device according to a second embodiment of the present invention.

The lens driving device 1010 may be a voice coil motor (VCM). The lens driving device 1010 may be a lens driving motor. The lens driving device 1010 may be a lens driving actuator. The lens driving device 1010 may comprise an AF module. The lens driving device 1010 may comprise an OIS module.

The lens driving device 1010 may comprise a fixed unit 1100. The fixed unit 1100 may be a portion that is relatively fixed portion when the moving unit moves. The moving unit may move with respect to the fixed unit 1100.

The lens driving device 1010 may comprise a base 1110. The fixed unit 1100 may comprise a base 1110. The base 1110 may be disposed below the AF holder 1210. The base 1110 may be disposed below the OIS holder 1310. The base 1110 may be coupled with the cover 1120. The AF holder 1210 and the OIS holder 1310 may be disposed on the base 1110. The AF holder 1210 and the OIS holder 1310 may be disposed on a lower plate of the base 1110. The AF holder 1210 and the OIS holder 1310 may be disposed inside the base 1110. The AF holder 1210 and the OIS holder 1310 can be disposed inside the side plate of the base 1110.

In a second embodiment of the present invention, all of the AF magnet 1410, the OIS-x magnet 1510, and the OIS-y magnet 1610 can be disposed in the base 1110. All of the AF magnet 1410, the OIS-x magnet 1510, and the OIS-y magnet 1610 can be disposed in the fixed unit 1100. That is, in the auto focus operation, all of the AF magnet 1410, the OIS-x magnet 1510, and the OIS-y magnet 1610 can be maintained in a fixed state. In addition, in the shake correction operation, all of the AF magnet 1410, the OIS-x magnet 1510, and the OIS-y magnet 1610 can be maintained in a fixed state. In the auto focus operation, the AF magnet 1410 is fixed and the AF coil 1420 can move. In the image stabilization operation, the OIS-x and OIS-y magnets 1510 and 1610 are fixed and the OIS-x and OIS-y coils 1520 and 1620 can move.

The base 1110 may comprise a lower plate. The base 1110 may comprise a side plate. The side plate may be a ‘side portion’. The side plate of the base 1110 may be extended from an upper surface of the lower plate.

The side plate of the base 1110 may comprise a plurality of side plates. The side plate of the base 1110 may comprise four side plates. However, one or more of the four side plates of the base 1110 may be omitted. The side plate of the base 1110 may comprise first to fourth side plates 1111, 1112, 1113, and 1114. The base 1110 may comprise a first side plate 1111 and a second side plate 1113 being disposed opposite to each other, and a third side plate 1112 and a fourth side plate 1114 being disposed opposite to each other.

The side portion of the base 1110 may comprise a plurality of side portions. The side portion of the base 1110 may comprise four side portions. However, one or more of the four side portions of the base 1110 may be omitted. The side portion of the base 1110 may comprise first to fourth side portions. The base 1110 may comprise a first side portion and a second side portion being disposed opposite to each other, and a third side portion and a fourth side portion being disposed opposite to each other.

The AF magnet 1410 may be disposed on the first side plate 1111 of the base 1110. The OIS-x magnet 1510 may be disposed in the second side plate 1113 of the base 1110. The OIS-y magnet 1610 may be disposed in the third side plate 1112 of the base 1110.

The first side plate 1111 of the base 1110 may comprise a groove 1111a. The groove 1111a may be an ‘AF guide ball accommodating groove’. An AF guide ball 1810 may be disposed in the groove 1111a. The groove 1111a may be in direct contact with the AF guide ball 1810. The groove 1111a may be disposed in an optical axis direction. The groove 1111a may comprise a plurality of grooves. The groove 1111a may comprise two grooves. The two grooves may be disposed parallel to each other. The groove 1111a may comprise a first groove that comes into contact with the AF guide ball 1810 at two points, and a second groove that comes into contact with the AF guide ball 1810 at one point. In a modified embodiment, both the first groove and the second groove can come into contact with the AF guide ball 1810 at two points.

The second side plate 1113 of the base 1110 may comprise a protruded portion. The protruded portion may be protruded outwardly. An extended portion 1722 of an outer substrate 1720 may be disposed above and below the protruded portion. A groove may be formed in the protruded portion so as not to interfere even when the extended portion 1722 of the outer substrate 1720 moves.

The base 1110 may comprise a step 1115. The step 1115 may be formed at a lower portion of the outer surface of the base 1110. The step 1115 may be protruded from an outer surface of the base 1110. A side plate 1122 of the cover 1120 may be disposed on the step 1115 of the base 1110.

The lens driving device 1010 may comprise a cover 1120. The fixed unit 1100 may comprise a cover 1120. The cover 1120 may be disposed in the base 1110. The cover 1120 may be coupled to the base 1110. The cover 1120 may be fixed to the base 1110. The cover 1120 may accommodate an AF holder 1210 therein. The cover 1120 may accommodate an OIS holder 1310 therein. The cover 1120 may be a shield member. The cover 1120 may be a shield can.

The cover 1120 may comprise an upper plate 1141. The upper plate 1141 may be disposed on a moving unit. The upward movement of the moving unit may be limited as the moving unit is in contact with the upper plate 1141. The upper plate 1141 may comprise a hole through which light passes.

The cover 1120 may comprise a side plate 1142. The side plate 1142 may be extended from the upper plate 1141. The side plate 1142 may be disposed in the base 1110. The side plate 1142 may be disposed in a step portion being protruded from a lower portion of the outer surface of the base 1110. The side plate 1142 may comprise a plurality of side plates. The side plate 1142 may comprise four side plates. The side plate 1142 may comprise a first side plate and a second side plate being disposed opposite to each other, and a third side plate and a fourth side plate disposed opposite to each other.

The lens driving device 1010 may comprise a moving unit. The moving unit may be disposed in the fixed unit 1100. The moving unit may be disposed inside the fixed unit 1100. The moving unit may be disposed on the fixed unit 1100. The moving unit may be movably disposed in the fixed unit 1100. The moving unit may be moved with respect to the fixed unit 1100 by the driving unit. The moving unit may be moved during AF driving. The moving unit may be moved during OIS driving. A lens may be coupled to the moving unit.

The lens driving device 1010 may comprise an AF moving unit 1200. The AF moving unit 1200 may be disposed in the fixed unit 1100. The AF moving unit 1200 may be disposed inside the fixed unit 1100. The AF moving unit 1200 may be disposed on the fixed unit 1100. The AF moving unit 1200 may be disposed between the fixed unit 1100 and the OIS moving unit 1300. The AF moving unit 1200 may be movably disposed in the fixed unit 1100. The AF moving unit 1200 may be moved in an optical axis direction against the fixed unit 1100 by the AF driving unit 1400. The AF moving unit 1200 may be moved during AF driving.

The lens driving device 1010 may comprise an AF holder 1210. The AF moving unit 1200 may comprise an AF holder 1210. The AF holder 1210 may be an ‘AF carrier’. The AF holder 1210 may be disposed in the base 1110. The AF holder 1210 may be disposed on the base 1110. The AF holder 1210 may be disposed inside the cover 1120. The AF holder 1210 may be disposed between the base 1110 and the OIS holder 1310. The AF holder 1210 may be movably disposed in an optical axis direction.

The AF holder 1210 may comprise a protrusion. The protrusion may be coupled with the lower elastic member 1910. The lower elastic member 1910 may comprise a hole being coupled with the protrusion of the AF holder 1210. In a modified embodiment, the AF holder 1210 may comprise a groove for accommodating an adhesive instead of the protrusion. In this case, the lower elastic member 1910 may comprise a hole disposed in the groove of the AF holder 1210. The protrusion of the AF holder 1210 may be formed on a lower surface of the AF holder 1210. The protrusion of the AF holder 1210 may be protruded from a lower surface of the AF holder 1210.

The protrusion of the AF holder 1210 may comprise a plurality of protrusions. The protrusion of the AF holder 1210 may comprise a first protrusion 1211 and a second protrusion 1212. The outer portion 1911 of the lower elastic member 1910 may comprise a first region being coupled with the first protrusion 1211 and a second region 1212 being coupled with the first protrusion 1212. The wire 1930 may comprise a first wire 1931 disposed at a first corner region of the fixed unit 1100. The coupling portion 1912 of the lower elastic member 1910 may comprise a first coupling portion being coupled with the first wire 1931. The connecting portion 1913 of the lower elastic member 1910 may comprise a first connecting portion 1913-1 and a second connecting portion 1913-2 connecting the outer portion 1911 of the lower elastic member 1910 and the first coupling portion of the lower elastic member 1910. The connecting portion 1913 of the lower elastic member 1910 may comprise a first connecting portion 1913-1 connecting the first region of the outer portion 1911 and the first coupling portion, and a second connecting portion 1913-2 connecting the second region of the outer portion 1911 and the first coupling portion. That is, the connecting portion 1913 of the lower elastic member 1910 may be provided with two strands of connecting portions to connect one outer portion 1911 and one coupling portion 1912.

When viewed from below, the first and second connecting portions 1913-1 and 1913-2 of the lower elastic member 1910 may be symmetrical with respect to an imaginary straight line connecting the optical axis and the first corner region of the fixed unit 1100.

The wire 1930 may comprise a second wire 1933 disposed in a second corner region of the fixed unit 1100. The coupling portion 1912 of the lower elastic member 1910 may comprise a second coupling portion being coupled with the second wire 1933. The wire 1930 may comprise a third wire 1932 being disposed in a third corner region of the fixed unit 1100. The coupling portion 1912 of the lower elastic member 1910 may comprise a third coupling portion being coupled with the third wire 1932. The wire 1930 may comprise a fourth wire 1934 being disposed in a fourth corner region of the fixed unit 1100. The coupling portion 1912 of the lower elastic member 1910 may comprise a fourth coupling portion being coupled to the fourth wire 1934. The first corner region of the fixed unit 1100 may be disposed to be diagonally opposite to the second corner region, and the third corner region may be disposed to be diagonally opposite to the fourth corner region.

The AF holder 1210 may comprise a protruded portion 1213. The protruded portion 1213 may be formed on an outer surface of the AF holder 1210. The protruded portion 1213 may be protruded outwardly from the AF holder 1210. An extended portion 1722 of an outer substrate 1720 may be disposed on an upper surface and a lower surface of the protruded portion 1213.

The AF holder 1210 may comprise a groove 1214. The groove 1214 may be an ‘AF guide ball accommodating groove’. An AF guide ball 1810 may be disposed in the groove 1214. The groove 1214 may be in direct contact with the AF guide ball 1810. The groove 1214 may be disposed in an optical axis direction. The groove 1214 may comprise a plurality of grooves. The groove 1214 may comprise two grooves. The two grooves may be disposed parallel to each other. The groove 1214 may comprise a first groove that comes into contact with the AF guide ball 1810 at two points, and a second groove that comes into contact with the AF guide ball 1810 at one point. In a modified embodiment, both the first groove and the second groove may come into contact with the AF guide ball 1810 at two points.

The AF holder 1210 may comprise a protrusion 1215a. The protrusion 1215a may be protruded from a lower surface of an upper plate of the AF holder 1210. An OIS guide ball 1820 may be disposed on a lower surface of the protrusion 1215a. The protrusion 1215a may comprise a plurality of protrusions. The protrusion 1215a may comprise four protrusions.

The AF holder 1210 may comprise a groove 1215. The groove 1215 may be an ‘OIS guide ball accommodating groove’. The groove 1215 may be formed in the protrusion 1215a. The groove 1215 may be formed on a lower surface of the protrusion 1215a. The groove 1215 may be concavely formed on a lower surface of the protrusion 1215a. An OIS guide ball 1820 may be disposed in the groove 1215. The groove 1215 may be in direct contact with the OIS guide ball 1820.

The AF holder 1210 may comprise a metal member 1216. The metal member 1216 may be insert-molded into the AF holder 1210. At least a portion of the metal member 1216 may be disposed on an upper surface of the AF holder 1210. The metal member 1216 may be disposed to reinforce the strength of the AF holder 1210.

The AF holder 1210 may comprise a groove 1217. The groove 1217 may be a “metal member accommodating groove.” The groove 1217 may be formed on an upper surface of the AF holder 1210. The groove 1217 may be formed concavely on an upper surface of the AF holder 1210. A metal member 1216 may be disposed in the groove 1217. The groove 1217 may be formed in a shape corresponding to the metal member 1216.

The lens driving device 1010 may comprise a cover 1220. The AF moving unit 1200 may comprise a cover 1220. The cover 1220 may be coupled with the AF holder 1210. The cover 1220 may be coupled to a lower surface of the AF holder 1210. The cover 1220 may be coupled to the AF holder 1210 from the lower side. The cover 1220 may comprise a hook 1221. The hook 1221 of the cover 1220 may be coupled to the AF holder 1210. The hook 1221 of the cover 1220 may be protruded upward and coupled to a side surface of the AF holder 1210.

The lens driving device 1010 may comprise an OIS moving unit 1300. The OIS moving unit 1300 may be disposed in the fixed unit 1100. The OIS moving unit 1300 may be disposed inside the fixed unit 1100. The OIS moving unit 1300 may be disposed in the fixed unit 1100. The OIS moving unit 1300 may be disposed inside the AF moving unit 1200. The OIS moving unit 1300 may be movably disposed. The OIS moving unit 1300 may move in an x-axis direction perpendicular to the optical axis against the fixed unit 1100 and the AF moving unit 1200 by the OIS-x driving unit 1500. The OIS moving unit 1300 can move in a y-axis direction perpendicular to the optical axis against the fixed unit 1100 and the AF moving unit 1200 by the OIS-y driving unit 1600. The OIS moving unit 1300 can move during OIS driving.

The lens driving device 1010 may comprise an OIS holder 1310. The OIS moving unit 1300 may comprise an OIS holder 1310. The OIS holder 1310 may be an ‘OIS carrier’. The OIS holder 1310 may be disposed inside the AF holder 1210. The OIS holder 1310 may be disposed inside the base 1110. The OIS holder 1310 may be disposed on the base 1110. The OIS holder 1310 may be disposed inside the cover 1120. The OIS holder 1310 may be movably disposed in a direction perpendicular to the optical axis.

The OIS holder 1310 may comprise an outer surface. The OIS holder 1310 may comprise a plurality of side surfaces. The OIS holder 1310 may comprise a first side surface and a second side surface being disposed opposite to each other, and a third side surface and a fourth side surface being disposed opposite to each other. The AF coil 1420 may be disposed between the first side surface of the OIS holder 1310 and the AF magnet 1410. The OIS-x coil 1520 may be disposed between the second side surface of the OIS holder 1310 and the OIS-x magnet 1510. The OIS-y coil 1620 may be disposed between the third side surface of the OIS holder 1310 and the OIS-y magnet 1610. The AF coil 1420 may be disposed on a first side surface of the OIS holder 1310. The OIS-x coil 1520 can be disposed on a second side surface of the OIS holder 1310. The OIS-y coil 1620 can be disposed on a third side surface of the OIS holder 1310.

The OIS holder 1310 may comprise a groove 1311. The groove 1311 may be an ‘upper elastic member interference prevention groove’. The groove 1311 may be formed on an upper surface of the OIS holder 1310. The groove 1311 may be formed concavely on an upper surface of the OIS holder 1310. The groove 1311 may be disposed at a position corresponding to the upper elastic member 1920 to prevent interference between the OIS holder 1310 and the upper elastic member 1920.

The OIS holder 1310 may comprise a groove 1312. The groove 1312 may be an ‘OIS guide ball accommodating groove’. An OIS guide ball 1820 may be disposed in the groove 1312. The groove 1312 may be in direct contact with the OIS guide ball 1820. The groove 1312 may be disposed in a direction perpendicular to an optical axis. The groove 1312 may be recessed in an optical axis direction. The groove 1312 may comprise a plurality of grooves. The groove 1312 may comprise four grooves. The groove 1312 may be in contact with the OIS guide ball 1820 at one point. Or, the groove 1312 may be in contact with the OIS guide ball 1820 at two points. The number of contact points between the OIS holder 1310 and the OIS guide ball 1820 may vary depending on the movement of the OIS guide ball 1820. The groove 1312 may be formed in the groove 1311. The groove 1312 may be additionally recessed from the groove 1311.

One of the grooves 1311 and 1312 of the OIS holder 1310 is referred to as a ‘first groove’ and the other may be referred to as a ‘second groove’.

The OIS holder 1310 may comprise a lateral stopper. The lateral stopper may limit a lateral stroke of the OIS holder 1310. That is, when the OIS holder 1310 moves to the maximum, the lateral stopper of the lower surface OIS holder 1310 may be in contact with at least one of the AF holder 1210 and the base 1110. The lateral stopper may be formed on an outer surface of the OIS holder 1310. The lateral stopper may be protruded outwardly from a side surface of the OIS holder 1310.

The OIS holder 1310 may comprise a protrusion. The protrusion may be coupled with the upper elastic member 1920. The upper elastic member 1920 may comprise a hole being coupled with the protrusion of the OIS holder 1310. In a modified embodiment, the OIS holder 1310 may comprise a groove for accommodating an adhesive instead of the protrusion. In this case, the upper elastic member 1920 may comprise a hole being disposed in the groove of the OIS holder 1310. The protrusion of the OIS holder 1310 may be formed on an upper surface of the OIS holder 1310. The protrusion of the OIS holder 1310 may be protruded from an upper surface of the OIS holder 1310.

The protrusion of the OIS holder 1310 may comprise a plurality of protrusions. The protrusion of the OIS holder 1310 may comprise a first protrusion 1314 and a second protrusion 1315. The inner portion 1921 of the upper elastic member 1920 may comprise a first region being coupled with the first protrusion 1314 and a second region 1212 being coupled with the second protrusion 1315. The wire 1930 may comprise a first wire 1931 being disposed at a first corner region of the fixed unit 1100. The coupling portion 1922 of the upper elastic member 1920 may comprise a first coupling portion being coupled with the first wire 1931. The connecting portion 1923 of the upper elastic member 1920 may comprise a first connecting portion 1923-1 and a second connecting portion 1923-2 connecting the inner portion 1921 of the upper elastic member 1920 and the first coupling portion of the upper elastic member 1920. The connecting portion 1923 of the upper elastic member 1920 may comprise a first connecting portion 1923-1 connecting the first region of the inner portion 1921 and the first coupling portion, and a second connecting portion 1923-2 connecting the second region of the inner portion 1921 and the first coupling portion. That is, the connecting portion 1923 of the upper elastic member 1920 may be provided with two strands of connecting portions to connect one inner portion 1921 and one coupling portion 1922.

When viewed from below, the first and second connecting portions 1923-1 and 1923-2 of the upper elastic member 1920 may be symmetrical with respect to an imaginary straight line connecting the optical axis and the first corner region of the fixed unit 1100.

The coupling portion 1922 of the upper elastic member 1920 may comprise a second coupling portion being coupled with a second wire 1933. The coupling portion 1922 of the upper elastic member 1920 may comprise a third coupling portion being coupled with a third wire 1932. The coupling portion 1922 of the upper elastic member 1920 may comprise a fourth coupling portion being coupled with a fourth wire 1934.

The lens driving device 1010 may comprise a driving unit. The driving unit may move a moving unit against the fixed unit 1100. The driving unit may comprise an AF driving unit 1400. The driving unit may comprise an OIS driving unit 1500 and 1600. The driving unit may comprise a coil and a magnet.

The lens driving device 1010 may comprise an AF driving unit 1400. The AF driving unit 1400 may move the AF moving unit 1200 in an optical axis direction. The AF driving unit 1400 may move the AF holder 1210 in an optical axis direction. The AF driving unit 1400 may move the AF holder 1210 in an optical axis direction through electromagnetic force. The AF driving unit 1400 may comprise a coil and a magnet.

In a second embodiment of the present invention, the AF holder 1210 and the OIS holder 1310 can move in an optical axis direction by the interaction between the AF coil 1420 and the AF magnet 1410. The AF coil 1420, the AF holder 1210, and the OIS holder 1310 can move in an optical axis direction as one unit.

The lens driving device 1010 may comprise an AF magnet 1410. The AF driving unit 1400 may comprise an AF magnet 1410. The AF magnet 1410 may be disposed in the fixed unit 1100. The AF magnet 1410 may be disposed in the base 1110. The AF magnet 1410 may be disposed in the cover 1120. The AF magnet 1410 may be disposed in the side plate 1122 of the cover 1120. The AF magnet 1410 may be disposed on an outer surface of the base 1110. The AF magnet 1410 may be disposed on an inner side surface of the base 1110. The AF magnet 1410 may be fixed to the base 1110. The AF magnet 1410 may be coupled to the base 1110. The AF magnet 1410 may be attached to the base 1110 with an adhesive. The AF magnet 1410 may be disposed inside the cover 1120. The AF magnet 1410 may interact with the AF coil 1420. The AF magnet 1410 may electromagnetically interact with the AF coil 1420. The AF magnet 1410 may be disposed at a position corresponding to the AF coil 1420. The AF magnet 1410 may face the AF coil 1420. The AF magnet 1410 and the AF coil 1420 may face each other. The AF magnet 1410 may be overlapped with the AF coil 1420 in a direction perpendicular to the optical axis.

The AF magnet 1410 may be a four-pole magnet. The AF magnet 1410 may comprise a four-pole magnetizing magnet. The AF magnet 1410 may comprise a first magnet portion comprising an N pole and an S pole, and a second magnet portion comprising an N pole and an S pole. The first magnet portion and the second magnet portion may be disposed in a vertical direction. The first magnet portion and the second magnet portion may be spaced apart from each other in a vertical direction, and a neutral portion may be disposed between the first magnet portion and the second magnet portion.

The lens driving device 1010 may comprise an AF coil 1420. The AF driving unit 1400 may comprise an AF coil 1420. The AF coil 1420 may interact with an AF magnet 1410. The AF coil 1420 may move in an optical axis direction. The AF coil 1420 may move in an optical axis direction through interaction with the AF magnet 1410. The AF coil 1420 may face the AF magnet 1410. The AF coil 1420 may be disposed at a position corresponding to the AF magnet 1410. The AF coil 1420 may be overlapped with the AF magnet 1410 in a direction perpendicular to the optical axis. The AF coil 1420 may be disposed in the inner substrate 1710. The AF coil 1420 may be disposed in the first portion 1711 of the inner substrate 1710. The AF coil 1420 may be disposed in the AF holder 1210. The AF coil 1420 may be disposed in the AF moving unit 1200.

In a modified embodiment, the AF magnet 1410 may be disposed in the AF moving unit 1200 and the AF coil 1420 may be disposed in the fixed unit 1100. The AF magnet 1410 may be disposed in the AF holder 1210. The AF coil 1420 may be disposed in the base 1110 through the substrate.

The lens driving device 1010 may comprise an AF sensor 1430. The AF driving unit 1400 may comprise an AF sensor 1430. The AF sensor 1430 may be a Hall sensor. The AF sensor 1430 may be disposed in the substrate 1740. The AF sensor 1430 may be disposed in the first portion 1711 of the substrate 1740. The AF sensor 1430 may detect the AF magnet 1410. The AF sensor 1430 may detect movement of the AF magnet 1410. The movement amount or position of the AF magnet 1410 detected by the AF sensor 1430 may be used for feedback of auto focus driving.

The AF sensor 1430 may be a driver IC. The driver IC may comprise a sensing unit. The sensing unit may comprise a Hall element (Hall IC). The driver IC may be electrically connected to the AF coil 1420. The driver IC may supply current to the AF coil 1420.

The AF sensor 1430 may be disposed inside the AF coil 1420. The AF sensor 1430 may be overlapped with the neutral portion of the AF magnet 1410 in a direction perpendicular to the optical axis. In a modified embodiment, the AF sensor 1430 may be disposed in the outside of the AF coil 1420.

The lens driving device 1010 may comprise an OIS-x driving unit 1500. The OIS-x driving unit 1500 may move the OIS moving unit 1300 in an x-axis direction perpendicular to the optical axis direction. The OIS-x driving unit 1500 may move the OIS holder 1310 in an x-axis direction perpendicular to the optical axis. The OIS-x driving unit 1500 may move the OIS holder 1310 in an x-axis direction perpendicular to the optical axis using electromagnetic force. The OIS-x driving unit 1500 may comprise a coil and a magnet.

In a second embodiment of the present invention, the OIS holder 1310 can move in an x-axis direction perpendicular to the optical axis direction by the interaction between the OIS-x coil 1520 and the OIS-x magnet 1510. The OIS-x coil 1520 and the OIS holder 1310 can move in an x-axis direction as one unit.

The lens driving device 1010 may comprise an OIS-x magnet 1510. The OIS-x driving unit 1500 may comprise an OIS-x magnet 1510. The OIS-x magnet 1510 may be disposed in the fixed unit 1100. The OIS-x magnet 1510 may be disposed in the base 1110. The OIS-x magnet 1510 may be disposed on an outer surface of the base 1110. The OIS-x magnet 1510 may be disposed on an inner surface of the base 1110. The OIS-x magnet 1510 may be fixed to the base 1110. The OIS-x magnet 1510 may be coupled to the base 1110. The OIS-x magnet 1510 may be attached to the base 1110 with an adhesive. The OIS-x magnet 1510 can be disposed inside the cover 1120. The OIS-x magnet 1510 can interact with the OIS-x coil 1520. The OIS-x magnet 1510 can electromagnetically interact with the OIS-x coil 1520. The OIS-x magnet 1510 can be disposed at a position corresponding to the OIS-x coil 1520. The OIS-x magnet 1510 can face the OIS-x coil 1520. The OIS-x magnet 1510 and the OIS-x coil 1520 can face each other. The OIS-x magnet 1510 can be overlapped with the OIS-x coil 1520 in a direction perpendicular to the optical axis.

The second magnet 1610 may be a two-pole magnet. The OIS-x magnet 1510 may comprise a two-pole magnetizing magnet. The OIS-x magnet 1510 may comprise an N pole and an S pole. The inner surface of the OIS-x magnet 1510 is an N pole and the outer surface may be an S pole.

The lens driving device 1010 may comprise an OIS-x coil 1520. The OIS-x driving unit 1500 may comprise an OIS-x coil 1520. The OIS-x coil 1520 may interact with the OIS-x magnet 1510. The OIS-x coil 1520 may move in an x-axis direction perpendicular to the optical axis. The OIS-x coil 1520 may move in an x-axis direction through interaction with the OIS-x magnet 1510. The OIS-x coil 1520 may face the OIS-x magnet 1510. The OIS-x coil 1520 and the OIS-x magnet 1510 may face each other. The OIS-x coil 1520 may be disposed at a position corresponding to the OIS-x magnet 1510. The OIS-x coil 1520 may be overlapped with the OIS-x magnet 1510 in a direction perpendicular to the optical axis. The OIS-x coil 1520 may be disposed on the inner substrate 1710. The OIS-x coil 1520 may be disposed in the second portion 1713 of the inner substrate 1710. The OIS-x coil 1520 may be disposed in the OIS holder 1310. The OIS-x coil 1520 may be disposed in the OIS moving unit 1300.

The lens driving device 1010 may comprise an OIS-x sensor 1530. The OIS-x driving unit 1500 may comprise an OIS-x sensor 1530. The OIS-x sensor 1530 may be disposed in an inner substrate 1710. The OIS-x sensor 1530 may be disposed in a second portion 1713 of the inner substrate 1710. The OIS-x sensor 1530 may comprise a Hall sensor. The OIS-x sensor 1530 may detect an OIS-x magnet 1510. The OIS-x sensor 1530 may detect a magnetic force of the OIS-x magnet 1510. The OIS-x sensor 1530 may be disposed in an OIS-x coil 1520. The OIS-x sensor 1530 may be overlapped with the OIS-x coil 1520 in an optical axis direction. The OIS-x sensor 1530 may face the OIS-x magnet 1510. The OIS-x sensor 1530 may be disposed at a position corresponding to the OIS-x magnet 1510. The OIS-x sensor 1530 may detect the movement of the OIS-x magnet 1510. The amount of movement or position of the OIS-x magnet 1510 detected by the OIS-x sensor 1530 may be used for feedback of the shake correction driving in an x-axis direction.

The lens driving device 1010 may comprise an OIS-y driving unit 1600. The OIS-y driving unit 1600 may move the OIS moving unit 1300 in a y-axis direction perpendicular to the optical axis direction and the x-axis direction. The OIS-y driving unit 1600 may move the OIS holder 1310 in a y-axis direction perpendicular to both the optical axis and the x-axis direction. The OIS-y driving unit 1600 may move the OIS holder 1310 in a y-axis direction perpendicular to both the optical axis and the x-axis direction through electromagnetic force. The OIS-y driving unit 1600 may comprise a coil and a magnet.

In a second embodiment of the present invention, the OIS holder 1310 can move in a y-axis direction perpendicular to both the optical axis direction and the x-axis direction by the interaction between the OIS-y coil 1620 and the OIS-y magnet 1610. The OIS-y coil 1620 and the OIS holder 1310 can move in a y-axis direction as one unit.

The lens driving device 1010 may comprise an OIS-y magnet 1610. The OIS-y driving unit 1600 may comprise an OIS-y magnet 1610. The OIS-y magnet 1610 may be disposed in the fixed unit 1100. The OIS-y magnet 1610 may be disposed in the base 1110. The OIS-y magnet 1610 may be disposed on an outer surface of the base 1110. The OIS-y magnet 1610 may be disposed on an inner surface of the base 1110. The OIS-y magnet 1610 may be fixed to the base 1110. The OIS-y magnet 1610 may be coupled to the base 1110. The OIS-y magnet 1610 may be attached to the base 1110 with an adhesive. The OIS-y magnet 1610 may be disposed inside the cover 1120. The OIS-y magnet 1610 may interact with the OIS-y coil 1620. The OIS-y magnet 1610 may electromagnetically interact with the OIS-y coil 1620. The OIS-y magnet 1610 may be disposed at a position corresponding to the OIS-y coil 1620. The OIS-y magnet 1610 may face the OIS-y coil 1620. The OIS-y magnet 1610 and the OIS-y coil 1620 may face each other. The OIS-y magnet 1610 may be overlapped with the OIS-y coil 1620 in a direction perpendicular to the optical axis.

The OIS-y magnet 1610 may be a two-pole magnet. The OIS-y magnet 1610 may comprise a two-pole magnetizing magnet. The OIS-y magnet 1610 may comprise an N pole and an S pole. The inner surface of the OIS-y magnet 1610 may be an N pole and the outer surface may be an S pole.

The lens driving device 1010 may comprise an OIS-y coil 1620. The OIS-y driving unit 1600 may comprise an OIS-y coil 1620. The OIS-y coil 1620 may interact with an OIS-y magnet 1610. The OIS-y coil 1620 may be disposed on the opposite side of the AF coil 1420 with respect to the optical axis. The OIS-y coil 1620 may move in a y-axis direction perpendicular to both the optical axis and the x-axis. The OIS-y coil 1620 may move in a y-axis direction through interaction with the OIS-y magnet 1610. The OIS-y coil 1620 may face the OIS-y magnet 1610. The OIS-y coil 1620 and the OIS-y magnet 1610 may face each other. The OIS-y coil 1620 may be disposed at a position corresponding to the OIS-y magnet 1610. The OIS-y coil 1620 may be overlapped with the OIS-y magnet 1610 in a direction perpendicular to the optical axis. The OIS-y coil 1620 may be disposed in the inner substrate 1710. The OIS-y coil 1620 may be disposed in the third portion 1712 of the inner substrate 1710. The OIS-y coil 1620 may be disposed in the OIS holder 1310. The OIS-y coil 1620 may be disposed in the OIS moving unit 1300.

The lens driving device 1010 may comprise an OIS-y sensor 1630. The OIS-y driving unit 1600 may comprise an OIS-y sensor 1630. The OIS-y sensor 1630 may be disposed in the inner substrate 1710. The OIS-y sensor 1630 may be disposed in a third portion 1712 of the inner substrate 1710. The OIS-y sensor 1630 may comprise a Hall sensor. The OIS-y sensor 1630 may detect an OIS-y magnet 1610. The OIS-y sensor 1630 may detect a magnetic force of the OIS-y magnet 1610. The OIS-y sensor 1630 may be disposed in an OIS-y coil 1620. The OIS-y sensor 1630 may be overlapped with the OIS-y coil 1620 in an optical axis direction. The OIS-y sensor 1630 may face the OIS-y magnet 1610. The OIS-y sensor 1630 may be disposed at a position corresponding to the OIS-y magnet 1610. The OIS-y sensor 1630 may detect movement of the OIS-y magnet 1610. The amount of movement or position of the OIS-y magnet 1610 detected by the OIS-y sensor 1630 may be used for feedback of the shake correction driving in a y-axis direction.

The lens driving device 1010 may comprise a substrate. The substrate may comprise a flexible substrate. The substrate may be electrically connected to the coil. The substrate may be electrically connected to the sensor. The substrate may be formed to be flexible. The substrate may be a circuit board. The substrate may be a printed circuit board.

The lens driving device 1010 may comprise an inner substrate 1710. The inner substrate 1710 may be electrically connected to coils 1420, 1520, and 1620. The inner substrate 1710 may be electrically connected to sensors 1430, 1530, and 1630. The inner substrate 1710 may connect the AF holder 1210 and the OIS holder 1310. The inner substrate 1710 may elastically connect the AF holder 1210 and the OIS holder 1310. The inner substrate 1710 may movably support the OIS holder 1310 against the AF holder 1210. The inner substrate 1710 can guide the OIS holder 1310 to move in a direction perpendicular to the optical axis against the AF holder 1210. The inner substrate 1710 can comprise a flexible substrate. The inner substrate 1710 can comprise a flexible printed circuit board (FPCB). The inner substrate 1710 can comprise an elastic portion. The inner substrate 1710 can comprise an elastic member.

The inner substrate 1710 may comprise a first portion 1711. The first portion 1711 may be disposed in an AF moving unit 1200. The first portion 1711 may be disposed in an AF holder 1210. An AF coil 1420 may be disposed in the first portion 1711 of the inner substrate 1710. An AF sensor 1430 may be disposed in the first portion 1711 of the inner substrate 1710. A yoke 1830 may be disposed in the first portion 1711 of the inner substrate 1710.

The inner substrate 1710 may comprise a second portion 1713. The second portion 1713 may be disposed in the OIS holder 1310. The second portion 1713 may be disposed on a second side surface of the OIS holder 1310. The OIS-x coil 1520 may be disposed in the second portion 1713 of the inner substrate 1710. The OIS-x sensor 1530 may be disposed in the second portion 1713 of the inner substrate 1710.

The inner substrate 1710 may comprise a third portion 1712. The third portion 1712 may be disposed in the OIS holder 1310. The third portion 1712 may be disposed on a third side surface of the OIS holder 1310. The OIS-y coil 1620 may be disposed in the third portion 1712 of the inner substrate 1710. The OIS-y sensor 1630 may be disposed in the third portion 1712 of the inner substrate 1710.

The inner substrate 1710 may comprise a fourth portion 1714. The fourth portion 1714 may be disposed between the OIS holder 1310 and the AF holder 1210. The fourth portion 1714 may be disposed between the fourth side surface of the OIS holder 1310 and the AF holder 1210.

However, in the ‘first to fourth side surfaces’ of the OIS holder 1310 described in the present specification, ‘first to fourth’ are only for distinguishing the side surfaces from one another, and may be referred to differently as needed. For example, the ‘second side surface’ is referred to as a ‘first side surface’and the ‘third side surface’may be referred to as a ‘second side surface’.

The inner substrate 1710 may comprise a terminal 1714a. The fourth portion 1714 of the inner substrate 1710 may comprise a terminal 1714a. The terminal 1714a may be electrically connected to coils 1420, 1520, and 1620. The terminal 1714a may be electrically connected to sensors 1430, 1530, and 1630.

The inner substrate 1710 may comprise a hole 1714b. The fourth portion 1714 of the inner substrate 1710 may comprise a hole 1714b. The hole 1714b may be formed to penetrate the fourth portion 1714 of the inner substrate 1710. The hole 1714b may be disposed at a position corresponding to a lateral stopper of the OIS holder 1310. Due to the hole 1714b, the inner substrate 1710 may not interfere with the lateral stopper of the OIS holder 1310.

The lens driving device 1010 may comprise an outer substrate 1720. The outer substrate 1720 may be disposed in a base 1110. The outer substrate 1720 may be electrically connected to coils 1420, 1520, and 1620. The outer substrate 1720 may be electrically connected to sensors 1430, 1530, and 1630. The outer substrate 1720 may connect the AF holder 1210 and the base 1110. The outer substrate 1720 may elastically connect the AF holder 1210 and the base 1110. The outer substrate 1720 may movably support the AF holder 1210 against the base 1110. The outer substrate 1720 can guide the AF holder 1210 to move in an optical axis direction against the base 1110. The outer substrate 1720 can comprise a flexible substrate. The outer substrate 1720 can comprise a flexible printed circuit board (FPCB). The outer substrate 1720 can comprise an elastic portion. The outer substrate 1720 can comprise an elastic member.

The outer substrate 1720 may comprise a body portion 1721. The body portion 1721 may be disposed in the fixed unit 1100. The body portion 1721 may be disposed in the base 1110. The body portion 1721 may be formed to surround a side surface of the base 1110. The body portion 1721 may be disposed on three side surfaces of the base 1110. The body portion 1721 may comprise two terminal portions. The two terminal portions may be disposed on opposite sides with respect to an optical axis. The terminal portion may comprise a terminal 1721a.

The outer substrate 1720 may comprise a terminal 1721a. The body portion 1721 of the outer substrate 1720 may comprise a terminal 1721a. The terminal 1721a may be electrically connected to the terminal 1722a. The terminal 1721a may be disposed at a lower end of the base 1110. The terminal 1721a may be coupled to a printed circuit board 1050. The terminal 1721a may be coupled to a terminal of the printed circuit board 1050 with a solder. The terminal 1721a may be coupled to a terminal of the printed circuit board 1050 with a conductive member. The terminal 1721a may be connected to a terminal of the printed circuit board 1050. The terminal 1721a can be electrically connected to a terminal of the printed circuit board 1050.

The outer substrate 1720 may comprise an extended portion 1722. The extended portion 1722 may be a ‘leg portion’. The extended portion 1722 may be extended from the body portion 1721. At least a portion of the extended portion 1722 may move together with the AF moving unit 1200. At least a portion of the extended portion 1722 may move together with the AF holder 1210. The extended portion may be extended from the body portion 1721. The extended portion 1722 may comprise a plurality of leg portions. The extended portion 1722 may comprise a first leg portion and a second leg portion. The second leg portion may be disposed below the first leg portion.

The outer substrate 1720 may comprise a terminal 1722a. The extended portion 1722 of the outer substrate 1720 may comprise a terminal 1722a. The terminal 1722a may be coupled to a terminal 1714a of the inner substrate 1710. The terminal 1722a may be coupled to the terminal 1714a of the inner substrate 1710 with a solder. The terminal 1722a may be coupled to the terminal 1714a of the inner substrate 1710 with a conductive member. The terminal 1722a may be connected to the terminal 1714a of the inner substrate 1710. The terminal 1722a may be electrically connected to the terminal 1714a of the inner substrate 1710.

The lens driving device 1010 may comprise a guide member. The guide member may comprise a ball. The guide member may comprise a pin. The guide member may comprise a cylindrical member. The guide member may guide movement of the moving unit against the fixed unit 1100 in a specific direction.

The lens driving device 1010 may comprise an AF guide ball 1810. The AF guide ball 1810 may guide movement of the AF holder 1210 against the base 1110 in an optical axis direction. The AF guide ball 1810 may be disposed between the base 1110 and the AF holder 1210. The AF guide ball 1810 may be disposed between the base 1110 and the AF holder 1210 in an x-axis direction. The AF guide ball 1810 may be disposed in a groove 1111a of the base 1110. The AF guide ball 1810 may be disposed in the first groove 1214 of the AF holder 1210. The AF guide ball 1810 may comprise a first-first ball being in contacts with the base 1110 and the AF holder 1210 at four points, and a first-second ball being in contact with the base 1110 and the AF holder 1210 at three points. The AF guide ball 1810 may have a spherical shape. The AF guide ball 1810 may be formed of metal. Grease may be applied to the surface of the AF guide ball 1810.

The AF guide ball 1810 may comprise a plurality of balls. The AF guide ball 1810 may comprise eight balls. Four AF guide balls 1810 may be disposed on one side of the AF magnet 1410, and the remaining four AF guide balls 1810 may be disposed on the other side of the AF magnet 1410.

The lens driving device 1010 may comprise an OIS guide ball 1820. The OIS guide ball 1820 may guide movement of the OIS holder 1310 against the AF holder 1210 in a direction perpendicular to the optical axis. The OIS guide ball 1820 may be disposed between the AF holder 1210 and the OIS holder 1310. The OIS guide ball 1820 may be disposed between the AF holder 1210 and the OIS holder 1310 in an optical axis direction. The OIS guide ball 1820 may be overlapped with the AF moving unit 1200 and the OIS moving unit 1300 in an optical axis direction. The OIS guide ball 1820 may be disposed between the AF moving unit 1200 and the OIS moving unit 1300 in an optical axis direction.

The OIS guide ball 1820 can be disposed between the AF holder 1210 and the OIS holder 1310. The OIS guide ball 1820 can be pressed between the AF holder 1210 and the OIS holder 1310 by the pressing force of the elastic member.

The OIS guide ball 1820 can guide the OIS holder 1310 to move in an x-axis direction and a y-axis direction perpendicular to the optical axis direction with respect to the AF holder 1210. That is, the OIS guide ball 1820 can guide the OIS holder 1310 to move in an x-axis direction and a y-axis direction. In other words, the OIS guide ball 1820 can guide movement in both the x-axis direction and the y-axis direction. For reference, in a second embodiment of the present invention in which the ball guiding an x-axis direction and the ball guiding a y-axis direction are provided integrally, the size of the lens driving device 1010 can be minimized when compared to a comparative example in which a ball guiding an x-axis direction and a ball guiding a y-axis direction are provided separately. In particular, the height of the lens driving device 1010 in an optical axis direction can be reduced. Through this, the height being protruded from the smartphone, that is, the shoulder height can be minimized. The OIS guide ball 1820 may comprise multiple balls. The OIS guide ball 1820 may comprise four balls.

When viewed from above, the OIS guide ball 1820 can be disposed inside a space being formed by the inner portion 1921, the coupling portion 1922, and the connecting portion 1923 of the upper elastic member 1920. When viewed from above, the inner portion 1921, the coupling portion 1922, and the connecting portion 1923 of the upper elastic member 1920 can form a closed curve. At this time, the OIS guide ball 1820 can be disposed inside a space within the closed curve formed by the inner portion 1921, the coupling portion 1922, and the connecting portion 1923 of the upper elastic member 1920.

The lens driving device 1010 may comprise a yoke 1830. The yoke 1830 may be disposed in a first portion 1711 of the inner substrate 1710. An attractive force may be generated between the yoke 1830 and the AF magnet 1410. The yoke 1830 may be disposed at a position corresponding to the AF magnet 1410. The yoke 1830 may be formed of metal. The AF guide ball 1810 may be pressed between the base 1110 and the AF holder 1210 by the attractive force between the yoke 1830 and the AF magnet 1410. That is, the contact state of the AF guide ball 1810 with the base 1110 and the AF holder 1210 may be maintained by the attractive force between the yoke 1830 and the AF magnet 1410.

The lens driving device 1010 may comprise an elastic member. The elastic member may be formed to pressurize the OIS guide ball 1820. The elastic member may be formed to guide both the OIS-x-axis driving and the OIS-y-axis driving with only the OIS guide ball 1820. The elastic member may comprise a leaf spring. The elastic member may comprise a wire. The elastic member may have elasticity. The elastic member may be formed of metal.

The lens driving device 1010 may comprise a lower elastic member 1910. The lower elastic member 1910 may be a leaf spring. The lower elastic member 1910 may have elasticity. The lower elastic member 1910 may be disposed on a lower surface of the AF holder 1210. The lower elastic member 1910 may be disposed in the AF holder 1210. The lower elastic member 1910 may be disposed in a lower portion of the AF holder 1210. The lower elastic member 1910 may be disposed below the AF holder 1210. The lower elastic member 1910 may be disposed on a lower surface of the body portion 1721. The lower elastic member 1910 may be coupled to a lower surface of the body portion 1721. The lower elastic member 1910 may be disposed perpendicular to the optical axis.

The lower elastic member 1910 may comprise a plurality of elastic units spaced apart from one another. The lower elastic member 1910 may comprise first to fourth elastic units corresponding to the first to fourth wires 1931, 1932, 1933, and 1934. The first to fourth elastic units may be spaced apart from one another.

The lower elastic member 1910 may comprise an outer portion 1911. The outer portion 1911 may be coupled with the AF moving unit 1200. The lower elastic member 1910 may comprise a coupling portion 1912. The coupling portion 1912 may be coupled with the wire 1930. The lower elastic member 1910 may comprise a connecting portion 1913. The connecting portion 1913 may connect the outer portion 1911 and the coupling portion 1912. The coupling portion 1912 of the lower elastic member 1910 may be disposed lower than the outer portion 1911 of the lower elastic member 1910.

Hereinafter, one among the outer portion 1911, the coupling portion 1912, and the connecting portion 1913 of the lower elastic member 1910 may be referred to as a “first portion”, the other may be referred to as a “second portion”, and yet the other may be referred to as a “third portion”. Hereinafter, one among the outer portion 1911, the coupling portion 1912, and the connecting portion 1913 of the lower elastic member 1910 may be referred to as a “first region”, the other may be referred to as a “second region”, and yet the other may be referred to as a “third region”.

The lens driving device 1010 may comprise an upper elastic member 1920. The upper elastic member 1920 may be a leaf spring. The upper elastic member 1920 may have elasticity. The upper elastic member 1920 may be disposed on an upper surface of the OIS holder 1310. The upper elastic member 1920 may be disposed on the OIS holder 1310. The upper elastic member 1920 may be disposed on an upper portion of the OIS holder 1310. The upper elastic member 1920 may be disposed above the OIS holder 1310. The upper elastic member 1920 may be disposed perpendicular to the optical axis. The upper elastic member 1920 may be formed integrally.

The upper elastic member 1920 may comprise an inner portion 1921. The inner portion 1921 may be coupled with the OIS moving unit 1300. The upper elastic member 1920 may comprise a coupling portion 1922. The coupling portion 1922 may be coupled with a wire 1930. The upper elastic member 1920 may comprise a connecting portion 1923. The connecting portion 1923 may connect the inner portion 1921 and the coupling portion 1922. The coupling portion 1922 of the upper elastic member 1920 may be disposed higher than the inner portion 1921 of the upper elastic member 1920.

Hereinafter, one among the inner portion 1921, the coupling portion 1922, and the connecting portion 1923 of the upper elastic member 1920 may be referred to as a “first portion”, the other may be referred to as a “second portion”, and yet the other may be referred to as a “third portion”. Hereinafter, one among the inner portion 1921, the coupling portion 1922, and the connecting portion 1923 of the upper elastic member 1920 may be referred to as a “first region”, the other may be referred to as a “second region”, and yet the other may be referred to as a “third region”.

The lower elastic member 1910 can connect the first region of the wire 1930 and the AF moving unit 1200. The upper elastic member 1920 can connect the second region of the wire 1930 and the OIS moving unit 1300. The second region of the wire 1930 can be disposed higher than the first region. That is, the first region of the wire 1930 can be disposed lower than the second region.

As illustrated in FIGS. 58a and 58b, in an optical axis direction, the distance between the first region a and the second region d of the wire 1930 may be longer than the distance between the outer portion 1911, b, of the lower elastic member 1910 and the inner portion 1921, c, of the upper elastic member 1920. The first region a in the wire 1930 may be disposed lower than the outer portion 1911, b, of the lower elastic member 1910. A first gap ga may be formed in an optical axis direction between the first region a in the wire 1930 and the outer portion 1911, b, of the lower elastic member 1910. The second region d of the wire 1930 may be disposed higher than the inner portion 1921, c, of the upper elastic member 1920. A second gap gb can be formed in an optical axis direction between the second region d of the wire 1930 and the inner portion 1921, c, of the upper elastic member 1920.

Through this structure, the OIS guide ball 1820 can be pressed between the AF moving unit 1200 and the OIS moving unit 1300 by the lower elastic member 1910, the upper elastic member 1920, and the wire 1930. That is, through this structure, the OIS guide ball 1820 can be pressed between the AF holder 1210 and the OIS holder 1310 by the lower elastic member 1910, the upper elastic member 1920, and the wire 1930.

In a modified embodiment, in an optical axis direction, the distance between the first region a and the second region d in the wire 1930 may be equal to the distance between the outer portion 1911, b, of the lower elastic member 1910 and the inner portion 1921, c, of the upper elastic member 1920.

In a modified embodiment, the first region a in the wire 1930 may be disposed at the same height as the outer portion 1911, b, of the lower elastic member 1910. Or, the second region d in the wire 1930 may be disposed at the same height as the inner portion 1921, c, of the upper elastic member 1920.

The lens driving device 1010 may comprise a wire 1930. The wire 1930 may be a ‘side portion elastic member’. The wire 1930 may be a wire spring. The wire 1930 may be a suspension wire. The wire 1930 may have elasticity. The wire 1930 may connect the upper elastic member 1920 and the lower elastic member 1910. The wire 1930 may elastically connect the upper elastic member 1920 and the lower elastic member 1910. The wire 1930 may be disposed parallel to the optical axis. The wire 1930 may be disposed parallel to the optical axis direction.

The wire 1930 may comprise a plurality of wires. The wire 1930 may comprise four wires. The wire 1930 may comprise first to fourth wires 1931, 1932, 1933, and 1934. The wire 1930 may comprise first to fourth wires 1931, 1932, 1933, and 1934 respectively disposed in the first to fourth corner regions of the fixed unit 1100.

Hereinafter, the auto focus AF driving of the lens driving device according to a second embodiment of the present invention will be described with reference to the drawings.

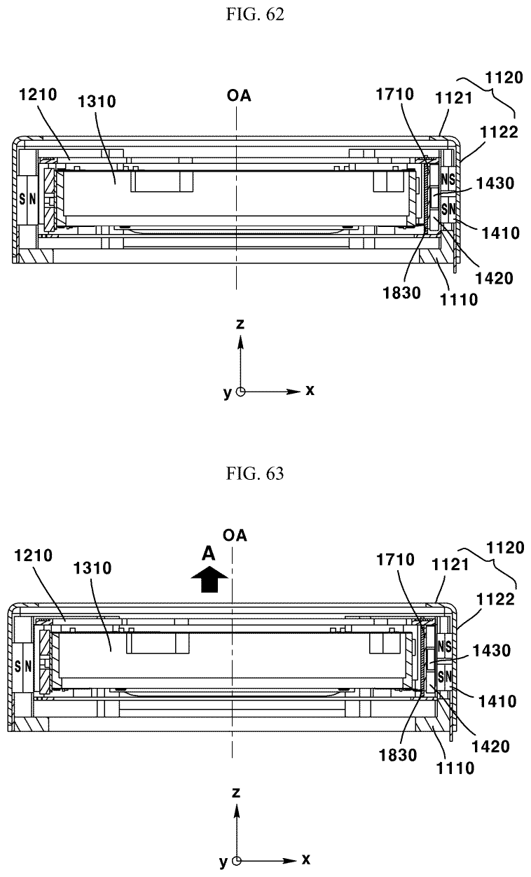

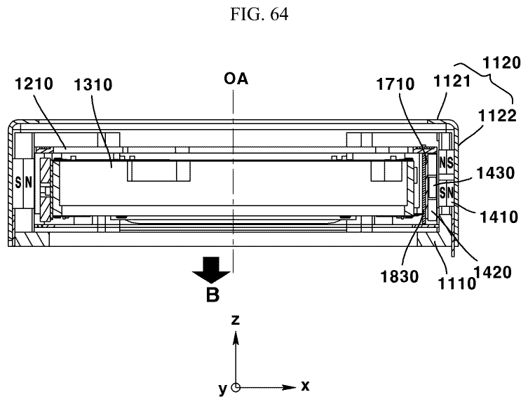

FIGS. 62 to 64 are diagrams for explaining an auto focus driving of a lens driving device according to a second embodiment of the present invention. FIG. 62 is a cross-sectional view illustrating an appearance of a moving unit in an initial state in which no current is applied to an AF coil. FIG. 63 is a cross-sectional view illustrating an appearance in which a moving unit moves upward in an optical axis direction when a forward current is applied to an AF coil. FIG. 64 is a cross-sectional view illustrating an appearance in which a moving unit moves downward in an optical axis direction when a reverse current is applied to an AF coil.

The moving unit may be disposed at a position spaced apart from both the upper plate 1121 of the cover 1120 and the base 1110 in an initial position where no current is applied to the AF coil 1420. At this time, the moving unit may be an AF moving unit 1200. In addition, the moving unit may comprise an AF moving unit 1200 and an OIS moving unit 1300.

When a forward current is applied to the AF coil 1420, the AF coil 1420 can move upward in an optical axis direction due to the electromagnetic interaction between the AF coil 1420 and the AF magnet 1410 (see A of FIG. 63). At this time, the AF holder 1210 can move upward in an optical axis direction together with the AF coil 1420. Furthermore, the OIS holder 1310 and the lens can move upward in an optical axis direction together with the AF holder 1210. Accordingly, the distance between the lens and the image sensor can be changed, and the focus of the image formed on the image sensor through the lens can be adjusted.

When a reverse current is applied to the AF coil 1420, the AF coil 1420 can move downward in an optical axis direction due to the electromagnetic interaction between the AF coil 1420 and the AF magnet 1410 (see B of FIG. 64). At this time, the AF holder 1210 can move downward in an optical axis direction together with the AF coil 1420. Furthermore, the OIS holder 1310 and the lens can move downward in an optical axis direction together with the AF holder 1210. Accordingly, the distance between the lens and the image sensor can be changed, and the focus of the image being formed on the image sensor through the lens can be adjusted.

Meanwhile, during the movement process of the AF coil 1420, the AF sensor 1430 moves together with the AF coil 1420 and detects the strength of the magnetic field of the AF magnet 1410 to detect the amount of movement or position of the lens in an optical axis direction. The amount of movement or position of the lens in an optical axis direction detected by the AF sensor 1430 can be used for auto focus feedback control.

Hereinafter, the optical image stabilization (OIS) operation of the lens driving device according to a second embodiment of the present invention will be described with reference to the drawings.

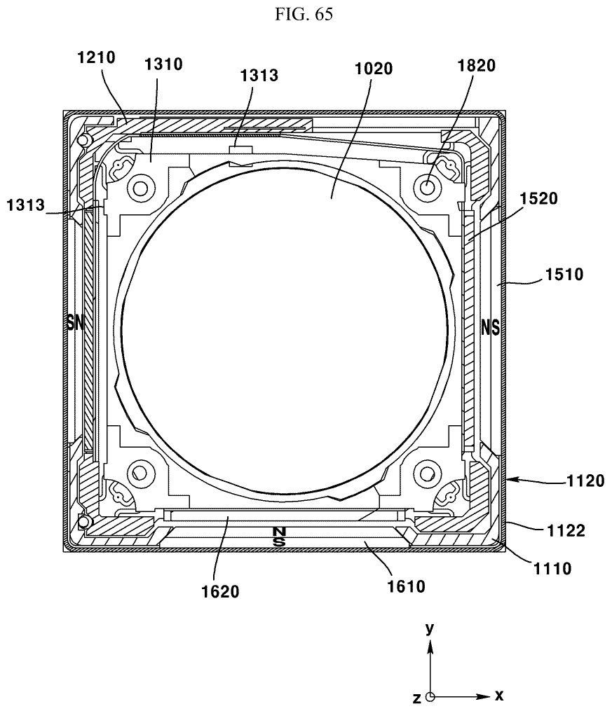

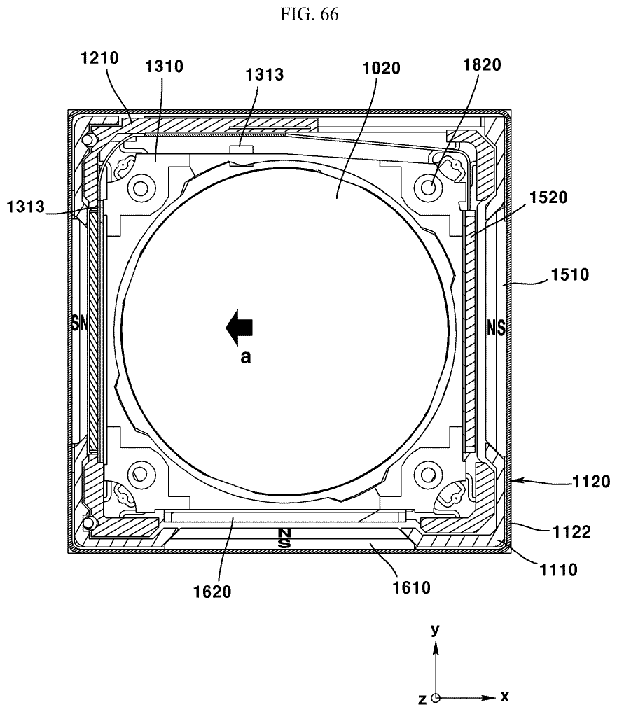

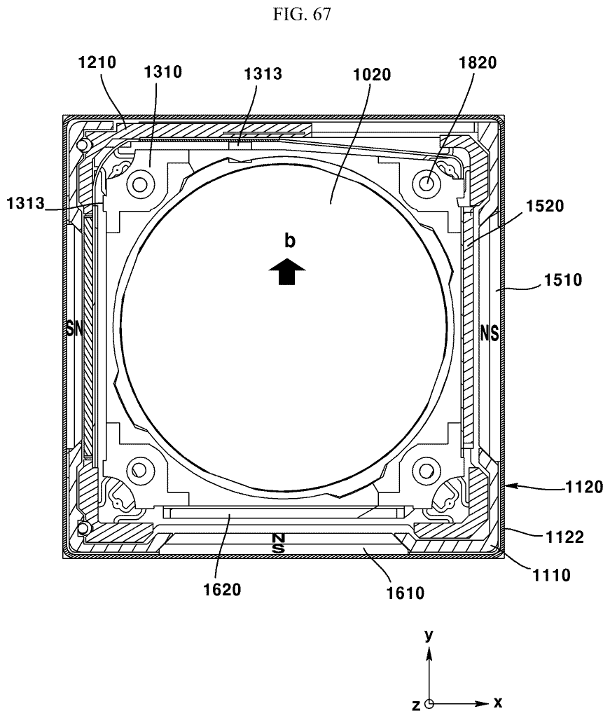

FIGS. 65 to 67 are drawings for explaining a hand shake correction driving of a lens driving device according to a second embodiment of the present invention. FIG. 65 is a cross-sectional view illustrating an appearance of a moving unit in an initial state in which no current is applied to an OIS-x coil and an OIS-y coil. FIG. 66 is a cross-sectional view illustrating an OIS moving unit moving in an x-axis direction perpendicular to an optical axis when a current is applied to an OIS-x coil. FIG. 67 is a cross-sectional view illustrating an OIS moving unit moving in a y-axis direction perpendicular to both an optical axis and an x-axis when a current is applied to an OIS-y coil.

As illustrated in FIG. 65, the moving unit may be disposed in an initial position where no current is applied to the OIS-x coil 1520 and the OIS-y coil 1620. At this time, the moving unit may be an OIS moving unit 1300.

When a current is applied to the OIS-x coil 1520, the OIS-x coil 1520 can move in an x-axis direction perpendicular to the optical axis due to the electromagnetic interaction between the OIS-x coil 1520 and the OIS-x magnet 1510 (see a of FIG. 66). At this time, the OIS holder 1310 can move in an x-axis direction together with the OIS-x coil 1520. Furthermore, the lens can move in an x-axis direction together with the OIS holder 1310. In more detail, when a forward current is applied to the OIS-x coil 1520, the OIS holder 1310, and the lens can move in one direction along an x-axis. In addition, when a reverse current is applied to the OIS-x coil 1520, the OIS-x coil 1520, the OIS holder 1310, and the lens can move in the other direction along an x-axis.

When a current is applied to the OIS-y coil 1620, the OIS-y coil 1620 can move in a y-axis direction perpendicular to the optical axis due to the electromagnetic interaction between the OIS-y coil 1620 and the OIS-y magnet 1610 (see b of FIG. 67). At this time, the OIS holder 1310 can move in a y-axis direction together with the OIS-y coil 1620. Furthermore, the lens can move in a y-axis direction together with the OIS holder 1310. In more detail, when a positive current is applied to the OIS-y coil 1620, the OIS holder 1310, and the lens can move in one direction along a y-axis. In addition, when a reverse current is applied to the OIS-y coil 1620, the OIS-y coil 1620, the OIS holder 1310, and the lens can move in the other direction along a y-axis.

Meanwhile, the OIS-x sensor 1530 can detect the amount of movement or position of the OIS-x coil 1520 by detecting the strength of the magnetic field of the OIS-x magnet 1510. The amount of movement or position detected by the OIS-x sensor 1530 can be used for x-axis direction shake correction feedback control. The OIS-y sensor 1630 can detect the amount of movement or position of the OIS-y coil 1620 by detecting the strength of the magnetic field of the OIS-y magnet 1610. The amount of movement or position detected by the OIS-y sensor 1630 can be used for y-axis direction shake correction feedback control.

Hereinafter, a camera device according to a second embodiment of the present invention will be described with reference to the drawings.

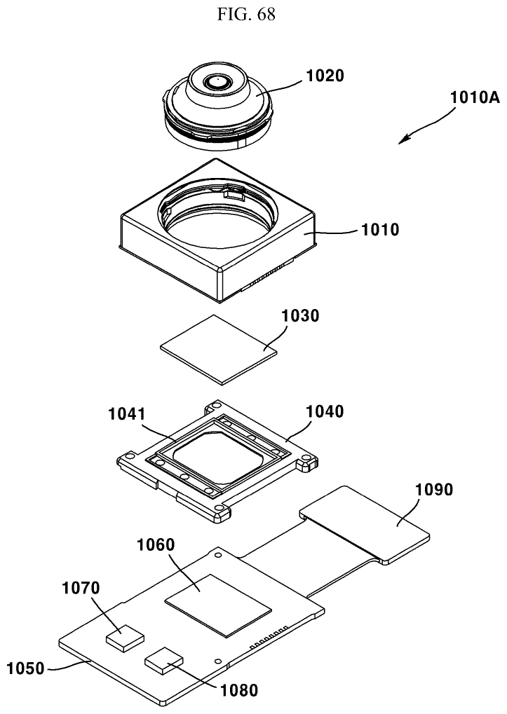

FIG. 68 is an exploded perspective view of a camera device according to a second embodiment of the present invention.

The camera device 1010A may comprise a camera module.

The camera device 1010A may comprise a lens module 1020. The lens module 1020 may comprise at least one lens. The lens may be disposed at a position corresponding to the image sensor 1060. The lens module 1020 may comprise a lens and a barrel. The lens module 1020 may be coupled to the OIS holder 1310 of a lens driving device 1010. The lens module 1020 may be coupled to the OIS holder 1310 by screw coupling and/or an adhesive. The lens module 1020 may be moved integrally with the OIS holder 1310.

The camera device 1010A may comprise a filter 1030. The filter 1030 may serve to block light of a specific frequency band passing through the lens module 1020 from being incident on the image sensor 1060. The filter 1030 may be disposed parallel to an x-y plane. The filter 1030 may be disposed between the lens module 1020 and the image sensor 1060. The filter 1030 may be disposed in the sensor base 1040. In a modified embodiment, the filter 1030 may be disposed in the base 1110. The filter 1030 may comprise an infrared filter. The infrared filter may block light of an infrared region from being incident on the image sensor 1060.

The camera device 1010A may comprise a sensor base 1040. The sensor base 1040 may be disposed between the lens driving device 1010 and the printed circuit board 1050. The sensor base 1040 may comprise a protruded portion 1041 in which a filter 1030 is disposed. An opening may be formed in a portion of the sensor base 1040 in which the filter 1030 is disposed so that light passing through the filter 1030 may be incident on the image sensor 1060. The adhesive member may couple or attach the base 1310 of the lens driving device 1010 to the sensor base 1040. The adhesive member may additionally serve to prevent foreign substances from entering inside the lens driving device 1010. The adhesive member may comprise at least one among an epoxy, a thermosetting adhesive, and an ultraviolet-curable adhesive.

The camera device 1010A may comprise a printed circuit board (PCB) 1050. The printed circuit board 1050 may be a substrate or a circuit board. A lens driving device 1010 may be disposed on the printed circuit board 1050. A sensor base 1040 may be disposed between the printed circuit board 1050 and the lens driving device 1010. The printed circuit board 1050 may be electrically connected to the lens driving device 1010. An image sensor 1060 may be disposed in the printed circuit board 1050. Various circuits, components, control units, and the like may be provided in the printed circuit board 1050 to convert an image being formed on the image sensor 1060 into an electrical signal and transmit it to an external device.

The camera device 1010A may comprise an image sensor 1060. The image sensor 1060 may be configured such that light passing through a lens and a filter 1030 is incident thereon to form an image. The image sensor 1060 may be mounted on a printed circuit board 1050. The image sensor 1060 may be electrically connected to the printed circuit board 1050. For example, the image sensor 1060 may be coupled to the printed circuit board 1050 by surface mounting technology (SMT). As another example, the image sensor 1060 may be coupled to the printed circuit board 1050 by flip chip technology. The image sensor 1060 may be disposed such that the optical axis is aligned with the lens. That is, the optical axis of the image sensor 1060 and the optical axis of the lens can be aligned. The image sensor 1060 can convert light irradiated to the effective image area of the image sensor 1060 into an electrical signal. The image sensor 1060 can be any one among a charge coupled device (CCD), a metal oxide semi-conductor (MOS), a CPD, and a CID.

The camera device 1010A may comprise a motion sensor 1070. The motion sensor 1070 may be mounted on a printed circuit board 1050. The motion sensor 1070 may be electrically connected to a control unit 1080 through a circuit pattern being provided in the printed circuit board 1050. The motion sensor 1070 may output rotational velocity information due to the movement of the camera device 1010A. The motion sensor 1070 may comprise a two-axis or three-axis gyro sensor or an angular velocity sensor.

The camera device 1010A may comprise a control unit 1080. The control unit 1080 may be disposed in a printed circuit board 1050. The control unit 1080 may be electrically connected to a coil 1330 of a lens driving device 1010. The control unit 1080 may individually control the direction, intensity, amplitude, and the like of current supplied to the coil 1330. The control unit 1080 may control the lens driving device 1010 to perform an auto focus function and/or an image stabilization function. Furthermore, the control unit 1080 may perform auto focus feedback control and/or image stabilization feedback control for the lens driving device 1010.

The camera device 1010A may comprise a connector 1090. The connector 1090 may be electrically connected to a printed circuit board 1050. The connector 1090 may comprise a port for electrically connecting to an external device.

Hereinafter, an optical device according to a second embodiment of the present invention will be described with reference to the drawings.

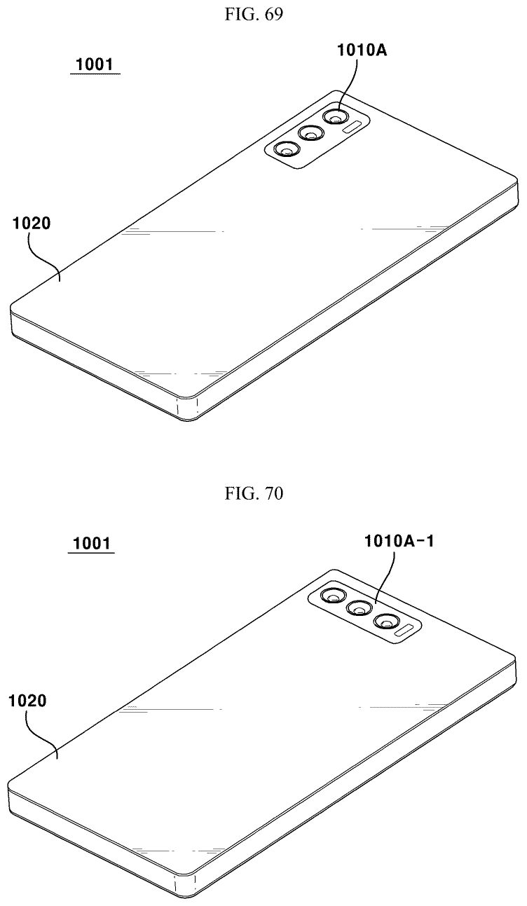

FIG. 69 is a perspective view of an optical device according to a second embodiment of the present invention.

The optical device 1001 may comprise at least one among a mobile phone, a cellular phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation device. The optical device 1001 may comprise any device for photographing videos or pictures.

The optical device 1001 may comprise a main body 1020. The optical device 1001 may comprise a camera device 1010A. The camera device 1010A may be disposed in the main body 1020. The camera device 1010A may capture a subject. The optical device 1001 may comprise a display. The display may be disposed in the main body 1020. The display may output one or more of an image and a video captured by the camera device 1010A. The display may be disposed on a first surface of the main body 1020. The camera device 1010A may be disposed on one or more of the first surface of the main body 1020 and the second surface opposite to the first surface. As illustrated in FIG. 69, in the camera device 1010A, a triple camera may be disposed in a vertical direction. As illustrated in FIG. 70, in the camera device 1010A-1, a triple camera may be disposed in a horizontal direction.

Hereinafter, the configuration of a lens driving device according to a third embodiment of the present invention is described with reference to the drawings.

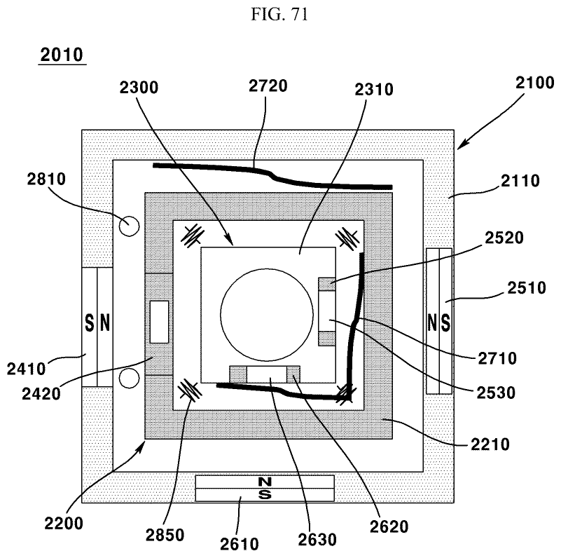

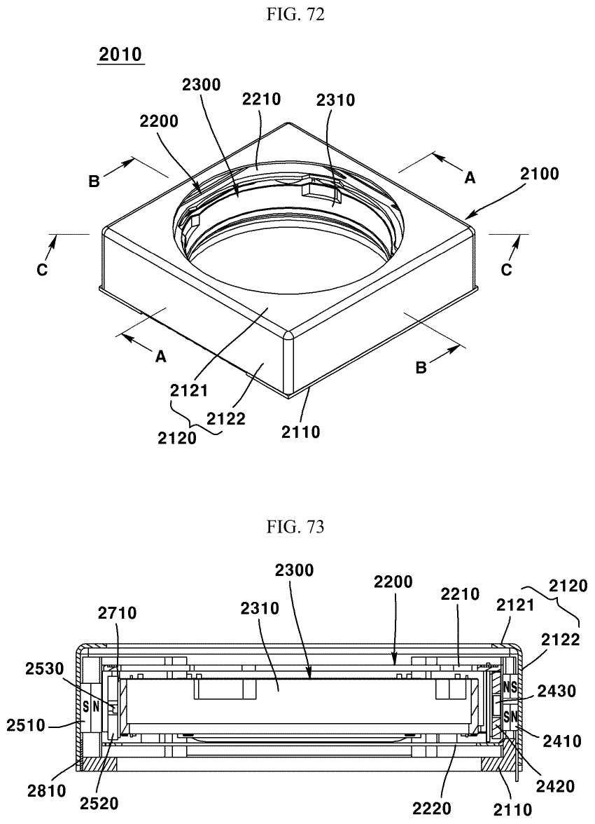

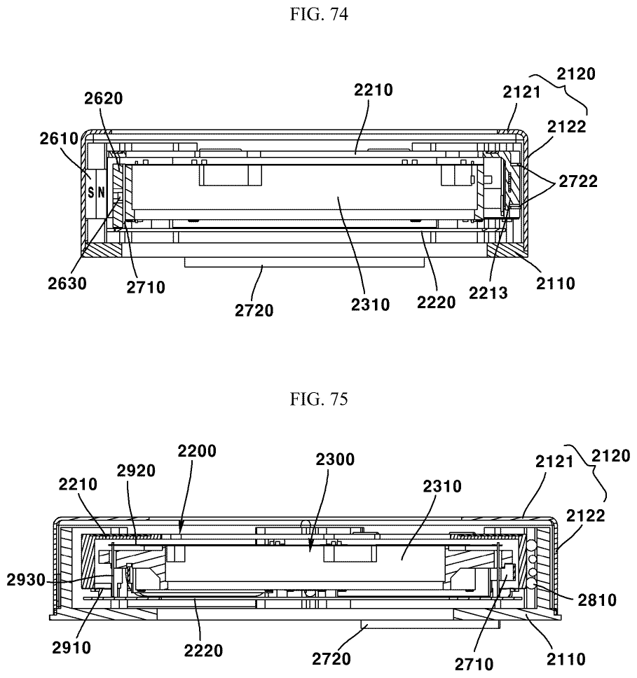

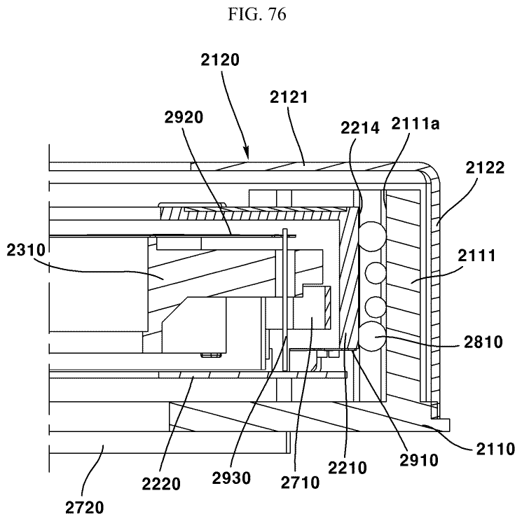

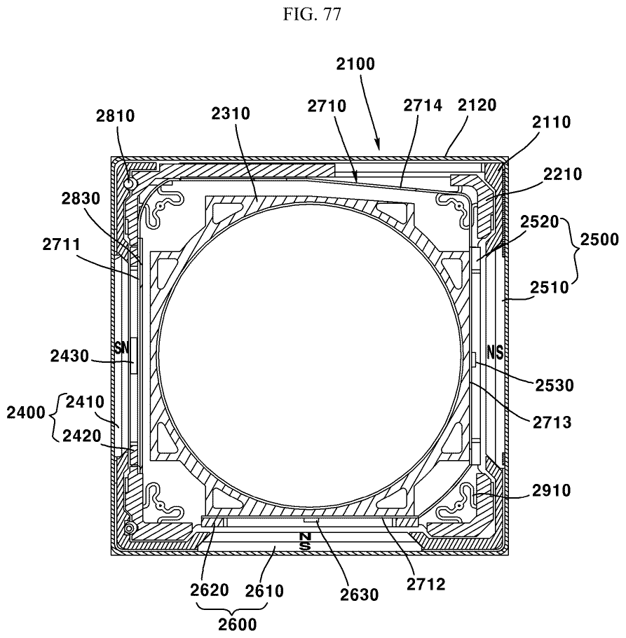

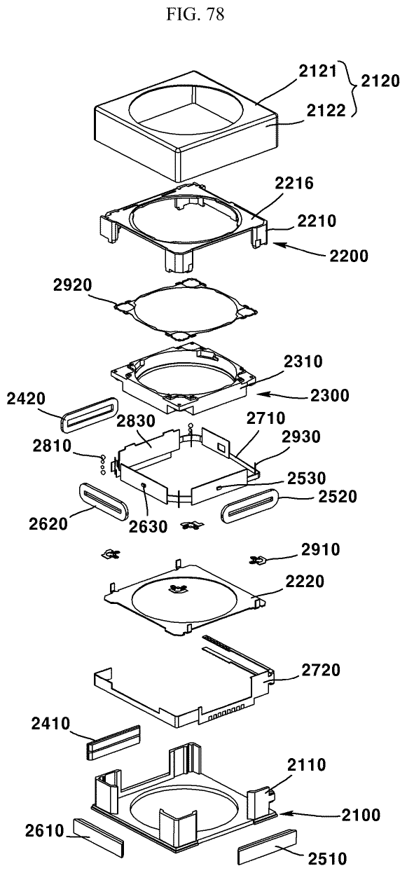

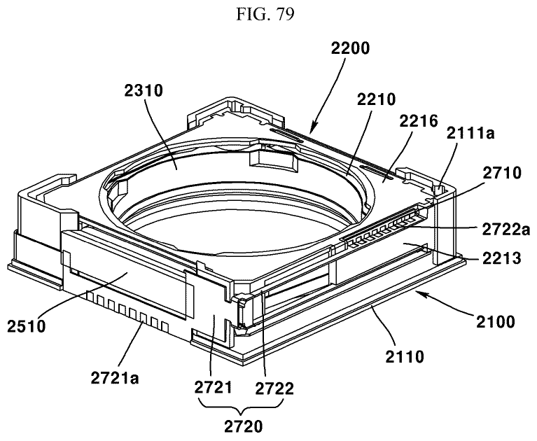

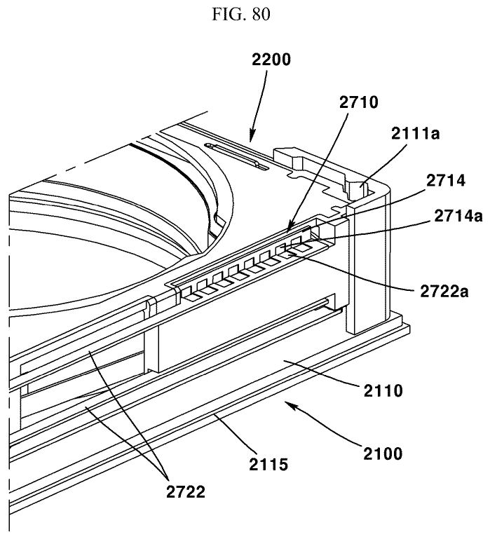

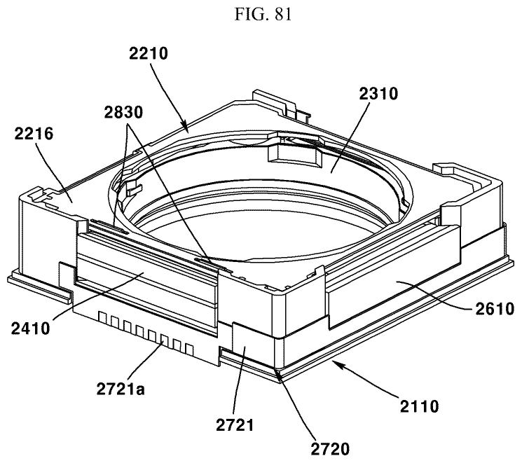

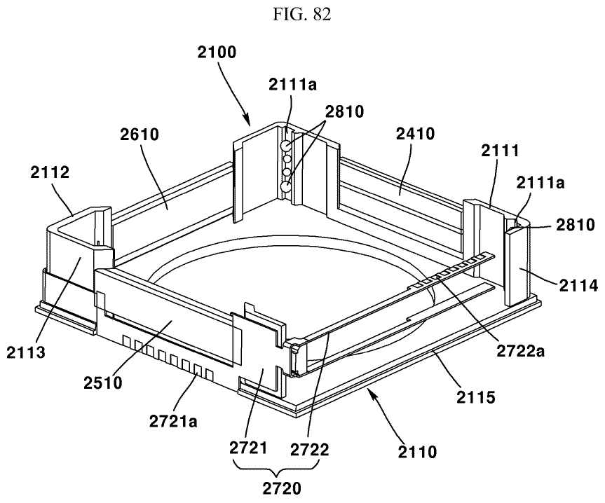

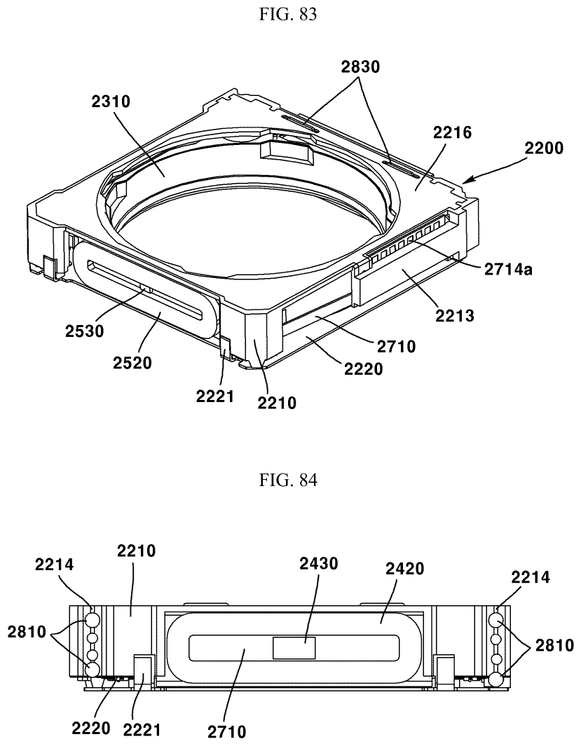

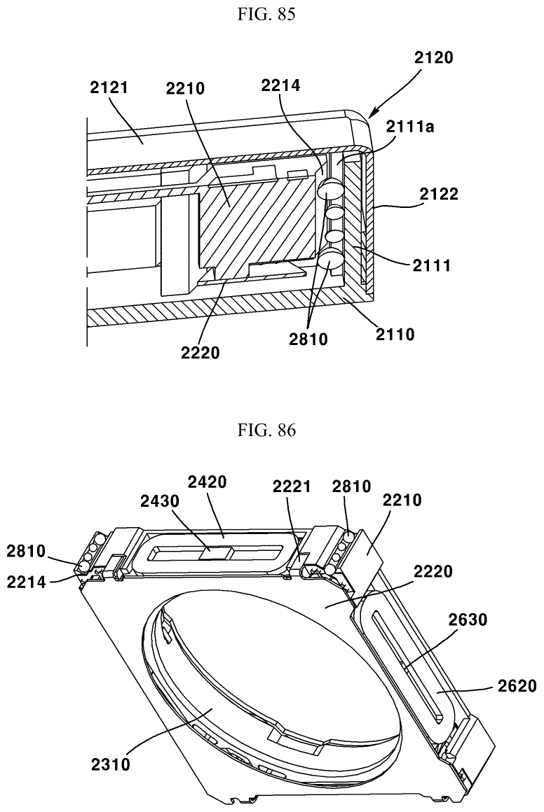

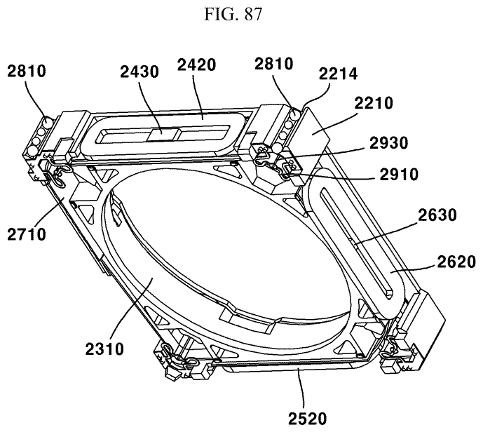

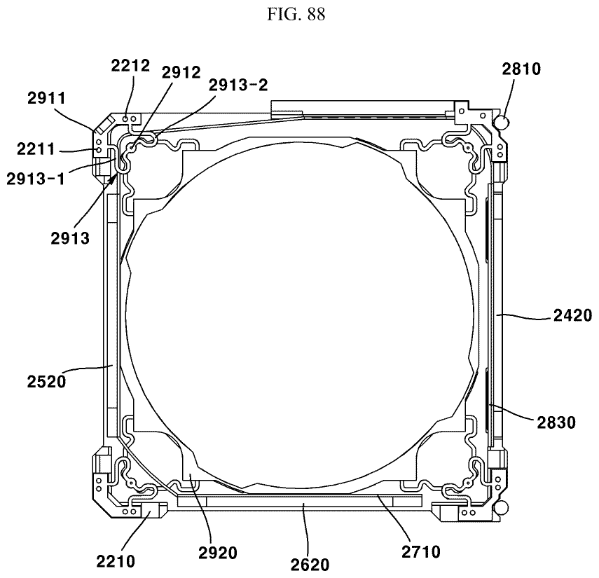

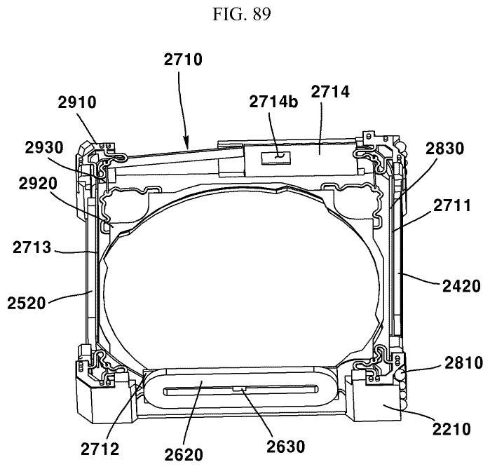

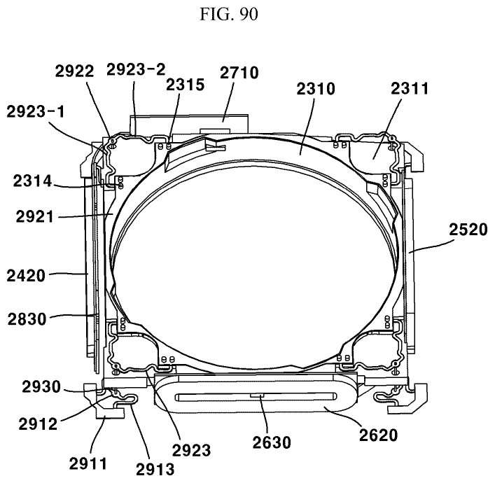

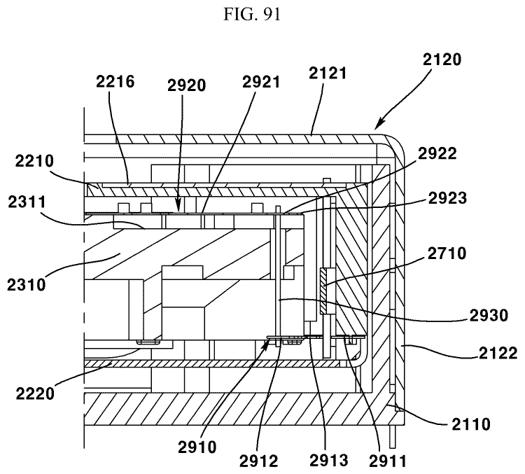

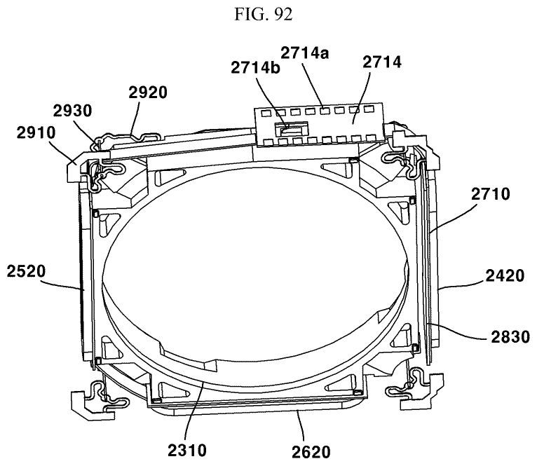

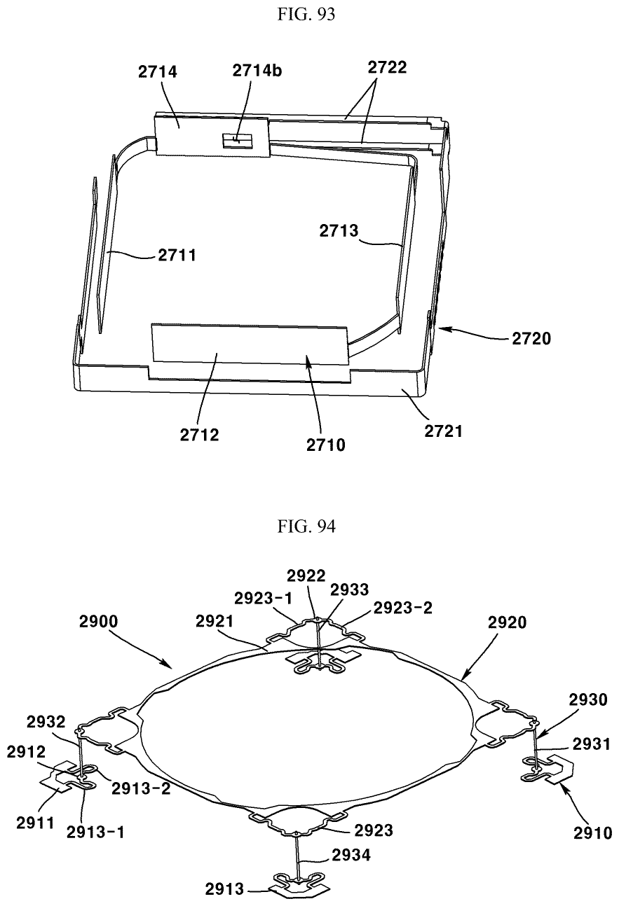

FIG. 71 is a conceptual diagram of a lens driving device according to a third embodiment of the present invention; FIG. 72 is a perspective view of a lens driving device according to a third embodiment of the present invention; FIG. 73 is a cross-sectional view taken along line A-A of FIG. 72; FIG. 74 is a cross-sectional view taken along line B-B of FIG. 72; FIG. 75 is a cross-sectional view taken along line C-C of FIG. 72; FIG. 76 is an enlarged view of a portion of FIG. 75; FIG. 77 is a cross-sectional view taken along line perpendicular to an optical axis of a lens driving device according to a third embodiment of the present invention as viewed from above; FIG. 78 is an exploded perspective view of a lens driving device according to a third embodiment of the present invention; FIG. 79 is a perspective view of a lens driving device according to a third embodiment of the present invention with a cover removed; FIG. 81 is a perspective view of FIG. 80 viewed from a different direction; FIG. 82 is a perspective view illustrating a fixed unit and related configuration of a lens driving device according to a third embodiment of the present invention; FIG. 83 is a perspective view illustrating a moving unit and related component of a lens driving device according to a third embodiment of the present invention; FIG. 84 is a front view of FIG. 83 viewed from front; FIG. 85 is a cross-sectional perspective view illustrating an AF guide ball and related component of a lens driving device according to a third embodiment of the present invention; FIG. 86 is a perspective view of FIG. 83 viewed from a different direction; FIG. 87 is a perspective view of FIG. 86 with the cover removed; FIG. 88 is a bottom view of an AF moving unit and related component of a lens driving device according to a third embodiment of the present invention viewed from below; FIG. 89 is a bottom perspective view of FIG. 88 viewed from a different direction; FIG. 90 is a perspective view illustrating an OIS moving unit and related component of a lens driving device according to a third embodiment of the present invention; FIG. 91 is a cross-sectional view illustrating an arrangement structure of an elastic member of a lens driving device according to a third embodiment of a present invention; FIG. 92 is a bottom perspective view of FIG. 90 seen from a different direction; FIG. 93 is a perspective view illustrating an inner substrate and an outer substrate of a lens driving device according to a third embodiment of the present invention; and FIG. 94 is a perspective view illustrating an elastic member and a wire of a lens driving device according to a third embodiment of the present invention.

The lens driving device 2010 may be a voice coil motor (VCM). The lens driving device 2010 may be a lens driving motor. The lens driving device 2010 may be a lens driving actuator. The lens driving device 2010 may comprise an AF module. The lens driving device 2010 may comprise an OIS module.

The lens driving device 2010 may comprise a fixed unit 2100. The fixed unit 2100 may be a portion that is relatively fixed portion when the moving unit moves. The moving unit may move with respect to the fixed unit 2100.

The lens driving device 2010 may comprise a base 2110. The fixed unit 2100 may comprise a base 2110. The base 2110 may be disposed below the AF holder 2210. The base 2110 may be disposed below the OIS holder 2310. The base 2110 may be coupled with the cover 2120. The AF holder 2210 and the OIS holder 2310 may be disposed on the base 2110. The AF holder 2210 and the OIS holder 2310 may be disposed on a lower plate of the base 2110. The AF holder 2210 and the OIS holder 2310 may be disposed inside the base 2110. The AF holder 2210 and the OIS holder 2310 can be disposed inside the side plate of the base 2110.

In a third embodiment of the present invention, all of the AF magnet 2410, the OIS-x magnet 2510, and the OIS-y magnet 2610 can be disposed in the base 2110. All of the AF magnet 2410, the OIS-x magnet 2510, and the OIS-y magnet 2610 can be disposed in the fixed unit 2100. That is, in the auto focus operation, all of the AF magnet 2410, the OIS-x magnet 2510, and the OIS-y magnet 2610 can be maintained in a fixed state. In addition, in the shake correction operation, all of the AF magnet 2410, the OIS-x magnet 2510, and the OIS-y magnet 2610 can be maintained in a fixed state. In the auto focus operation, the AF magnet 2410 is fixed and the AF coil 2420 can move. In the image stabilization operation, the OIS-x and OIS-y magnets 2510 and 2610 are fixed and the OIS-x and OIS-y coils 2520 and 2620 can move.

The base 2110 may comprise a lower plate. The base 2110 may comprise a side plate. The side plate may be a ‘side portion’. The side plate of the base 2110 may be extended from an upper surface of the lower plate.

The side plate of the base 2110 may comprise a plurality of side plates. The side plate of the base 2110 may comprise four side plates. However, one or more of the four side plates of the base 2110 may be omitted. The side plate of the base 2110 may comprise first to fourth side plates 2111, 2112, 2113, and 2114. The base 2110 may comprise a first side plate 2111 and a second side plate 2113 being disposed opposite to each other, and a third side plate 2112 and a fourth side plate 2114 being disposed opposite to each other.

The side portion of the base 2110 may comprise a plurality of side portions. The side portion of the base 2110 may comprise four side portions. However, one or more of the four side portions of the base 2110 may be omitted. The side portion of the base 2110 may comprise first to fourth side portions. The base 2110 may comprise a first side portion and a second side portion being disposed opposite to each other, and a third side portion and a fourth side portion being disposed opposite to each other.

The AF magnet 2410 may be disposed on the first side plate 2111 of the base 2110. The OIS-x magnet 2510 may be disposed in the second side plate 2113 of the base 2110. The OIS-y magnet 2610 may be disposed in the third side plate 2112 of the base 2110.

The first side plate 2111 of the base 2110 may comprise a groove 2111a. The groove 2111a may be an ‘AF guide ball accommodating groove’. An AF guide ball 2810 may be disposed in the groove 2111a. The groove 2111a may be in direct contact with the AF guide ball 2810. The groove 2111a may be disposed in an optical axis direction. The groove 2111a may comprise a plurality of grooves. The groove 2111a may comprise two grooves. The two grooves may be disposed parallel to each other. The groove 2111a may comprise a first groove that comes into contact with the AF guide ball 2810 at two points, and a second groove that comes into contact with the AF guide ball 2810 at one point. In a modified embodiment, both the first groove and the second groove can come into contact with the AF guide ball 2810 at two points.

The second side plate 2113 of the base 2110 may comprise a protruded portion. The protruded portion may be protruded outwardly. An extended portion 2722 of an outer substrate 2720 may be disposed above and below the protruded portion. A groove may be formed in the protruded portion so as not to interfere even when the extended portion 2722 of the outer substrate 2720 moves.

The base 2110 may comprise a step 2115. The step 2115 may be formed at a lower portion of the outer surface of the base 2110. The step 2115 may be protruded from an outer surface of the base 2110. A side plate 2122 of the cover 2120 may be disposed on the step 2115 of the base 2110.

The lens driving device 2010 may comprise a cover 2120. The fixed unit 2100 may comprise a cover 2120. The cover 2120 may be disposed in the base 2110. The cover 2120 may be coupled to the base 2110. The cover 2120 may be fixed to the base 2110. The cover 2120 may accommodate an AF holder 2210 therein. The cover 2120 may accommodate an OIS holder 2310 therein. The cover 2120 may be a shield member. The cover 2120 may be a shield can.

The cover 2120 may comprise an upper plate 2141. The upper plate 2141 may be disposed on a moving unit. The upward movement of the moving unit may be limited as the moving unit is in contact with the upper plate 2141. The upper plate 2141 may comprise a hole through which light passes.

The cover 2120 may comprise a side plate 2142. The side plate 2142 may be extended from the upper plate 2141. The side plate 2142 may be disposed in the base 2110. The side plate 2142 may be disposed in a step portion being protruded from a lower portion of the outer surface of the base 2110. The side plate 2142 may comprise a plurality of side plates. The side plate 2142 may comprise four side plates. The side plate 2142 may comprise a first side plate and a second side plate being disposed opposite to each other, and a third side plate and a fourth side plate disposed opposite to each other.

The lens driving device 2010 may comprise a moving unit. The moving unit may be disposed in the fixed unit 2100. The moving unit may be disposed inside the fixed unit 2100. The moving unit may be disposed on the fixed unit 2100. The moving unit may be movably disposed in the fixed unit 2100. The moving unit may be moved with respect to the fixed unit 2100 by the driving unit. The moving unit may be moved during AF driving. The moving unit may be moved during OIS driving. A lens may be coupled to the moving unit.

The lens driving device 2010 may comprise an AF moving unit 2200. The AF moving unit 2200 may be disposed in the fixed unit 2100. The AF moving unit 2200 may be disposed inside the fixed unit 2100. The AF moving unit 2200 may be disposed on the fixed unit 2100. The AF moving unit 2200 may be disposed between the fixed unit 2100 and the OIS moving unit 2300. The AF moving unit 2200 may be movably disposed in the fixed unit 2100. The AF moving unit 2200 may be moved in an optical axis direction against the fixed unit 2100 by the AF driving unit 2400. The AF moving unit 2200 may be moved during AF driving.

The lens driving device 2010 may comprise an AF holder 2210. The AF moving unit 2200 may comprise an AF holder 2210. The AF holder 2210 may be an ‘AF carrier’. The AF holder 2210 may be disposed in the base 2110. The AF holder 2210 may be disposed on the base 2110. The AF holder 2210 may be disposed inside the cover 2120. The AF holder 2210 may be disposed between the base 2110 and the OIS holder 2310. The AF holder 1210 may be movably disposed in an optical axis direction.

The AF holder 2210 may comprise a protrusion. The protrusion may be coupled with the lower elastic member 2910. The lower elastic member 2910 may comprise a hole being coupled with the protrusion of the AF holder 2210. In a modified embodiment, the AF holder 2210 may comprise a groove for accommodating an adhesive instead of the protrusion. In this case, the lower elastic member 2910 may comprise a hole disposed in the groove of the AF holder 2210. The protrusion of the AF holder 2210 may be formed on a lower surface of the AF holder 2210. The protrusion of the AF holder 2210 may be protruded from a lower surface of the AF holder 2210.

The protrusion of the AF holder 2210 may comprise a plurality of protrusions. The protrusion of the AF holder 2210 may comprise a first protrusion 2211 and a second protrusion 2212. The outer portion 2911 of the lower elastic member 2910 may comprise a first region being coupled with the first protrusion 2211 and a second region 2212 being coupled with the first protrusion 2212. The wire 2930 may comprise a first wire 2931 disposed at a first corner region of the fixed unit 2100. The coupling portion 2912 of the lower elastic member 2910 may comprise a first coupling portion being coupled with the first wire 2931. The connecting portion 2913 of the lower elastic member 2910 may comprise a first connecting portion 2913-1 and a second connecting portion 2913-2 connecting the outer portion 2911 of the lower elastic member 2910 and the first coupling portion of the lower elastic member 2910. The connecting portion 2913 of the lower elastic member 2910 may comprise a first connecting portion 2913-1 connecting the first region of the outer portion 2911 and the first coupling portion, and a second connecting portion 2913-2 connecting the second region of the outer portion 2911 and the first coupling portion. That is, the connecting portion 2913 of the lower elastic member 2910 may be provided with two strands of connecting portions to connect one outer portion 2911 and one coupling portion 2912.

When viewed from below, the first and second connecting portions 2913-1 and 2913-2 of the lower elastic member 2910 may be symmetrical with respect to an imaginary straight line connecting the optical axis and the first corner region of the fixed unit 2100.

The wire 2930 may comprise a second wire 2933 disposed in a second corner region of the fixed unit 2100. The coupling portion 2912 of the lower elastic member 2910 may comprise a second coupling portion being coupled with the second wire 2933. The wire 2930 may comprise a third wire 2932 being disposed in a third corner region of the fixed unit 2100. The coupling portion 2912 of the lower elastic member 2910 may comprise a third coupling portion being coupled with the third wire 2932. The wire 2930 may comprise a fourth wire 2934 being disposed in a fourth corner region of the fixed unit 2100. The coupling portion 2912 of the lower elastic member 2910 may comprise a fourth coupling portion being coupled to the fourth wire 2934. The first corner region of the fixed unit 2100 may be disposed to be diagonally opposite to the second corner region, and the third corner region may be disposed to be diagonally opposite to the fourth corner region.

The AF holder 2210 may comprise a protruded portion 2213. The protruded portion 2213 may be formed on an outer surface of the AF holder 2210. The protruded portion 2213 may be protruded outwardly from the AF holder 2210. An extended portion 2722 of an outer substrate 2720 may be disposed on an upper surface and a lower surface of the protruded portion 2213.

The AF holder 2210 may comprise a groove 2214. The groove 2214 may be an ‘AF guide ball accommodating groove’. An AF guide ball 2810 may be disposed in the groove 2214. The groove 2214 may be in direct contact with the AF guide ball 2810. The groove 2214 may be disposed in an optical axis direction. The groove 2214 may comprise a plurality of grooves. The groove 2214 may comprise two grooves. The two grooves may be disposed parallel to each other. The groove 2214 may comprise a first groove that comes into contact with the AF guide ball 2810 at two points, and a second groove that comes into contact with the AF guide ball 2810 at one point. In a modified embodiment, both the first groove and the second groove may come into contact with the AF guide ball 2810 at two points.

The AF holder 2210 may comprise a metal member 2216. The metal member 2216 may be insert-molded into the AF holder 2210. At least a portion of the metal member 2216 may be disposed on an upper surface of the AF holder 2210. The metal member 2216 may be disposed to reinforce the strength of the AF holder 2210.

The lens driving device 2010 may comprise a cover 2220. The AF moving unit 2200 may comprise a cover 2220. The cover 2220 may be coupled with the AF holder 2210. The cover 2220 may be coupled to a lower surface of the AF holder 2210. The cover 2220 may be coupled to the AF holder 2210 from the lower side. The cover 2220 may comprise a hook 2221. The hook 2221 of the cover 2220 may be coupled to the AF holder 2210. The hook 2221 of the cover 2220 may be protruded upward and coupled to a side surface of the AF holder 2210.

The lens driving device 2010 may comprise an OIS moving unit 2300. The OIS moving unit 2300 may be disposed in the fixed unit 2100. The OIS moving unit 2300 may be disposed inside the fixed unit 2100. The OIS moving unit 2300 may be disposed in the fixed unit 2100. The OIS moving unit 2300 may be disposed inside the AF moving unit 2200. The OIS moving unit 2300 may be movably disposed. The OIS moving unit 2300 may move in an x-axis direction perpendicular to the optical axis against the fixed unit 2100 and the AF moving unit 2200 by the OIS-x driving unit 2500. The OIS moving unit 2300 can move in a y-axis direction perpendicular to the optical axis against the fixed unit 2100 and the AF moving unit 2200 by the OIS-y driving unit 2600. The OIS moving unit 2300 can move during OIS driving.

The OIS moving unit 2300 can be spaced apart from the fixed unit 2100 and the AF moving unit 2200. The OIS moving unit 2300 can be spaced apart from the fixed unit 2100 and the AF moving unit 2200 in an optical axis direction. The OIS moving unit 2300 can form a first gap with the fixed unit 2100 downward in an optical axis direction. In addition, the OIS moving unit 2300 can form a second gap with the AF moving unit 2200 upward in an optical axis direction. Through this, even when the OIS moving unit 2300 is tilted due to the influence of gravity due to the posture of the optical device, interference with the fixed unit 2100 and the AF moving unit 2200 can be prevented.

The lens driving device 2010 may comprise an OIS holder 2310. The OIS moving unit 2300 may comprise an OIS holder 2310. The OIS holder 2310 may be an ‘OIS carrier’. The OIS holder 2310 may be disposed inside the AF holder 2210. The OIS holder 2310 may be disposed inside the base 2110. The OIS holder 2310 may be disposed on the base 2110. The OIS holder 2310 may be disposed inside the cover 2120. The OIS holder 2310 may be movably disposed in a direction perpendicular to the optical axis.

The OIS holder 2310 may comprise an outer surface. The OIS holder 2310 may comprise a plurality of side surfaces. The OIS holder 2310 may comprise a first side surface and a second side surface being disposed opposite to each other, and a third side surface and a fourth side surface being disposed opposite to each other. The AF coil 2420 may be disposed between the first side surface of the OIS holder 2310 and the AF magnet 2410. The OIS-x coil 2520 may be disposed between the second side surface of the OIS holder 2310 and the OIS-x magnet 2510. The OIS-y coil 2620 may be disposed between the third side surface of the OIS holder 2310 and the OIS-y magnet 2610. The AF coil 2420 may be disposed on a first side surface of the OIS holder 2310. The OIS-x coil 2520 can be disposed on a second side surface of the OIS holder 2310. The OIS-y coil 2620 can be disposed on a third side surface of the OIS holder 2310.

The OIS holder 2310 may comprise a groove 2311. The groove 2311 may be an ‘upper elastic member interference prevention groove’. The groove 2311 may be formed on an upper surface of the OIS holder 2310. The groove 2311 may be formed concavely on an upper surface of the OIS holder 2310. The groove 2311 may be disposed at a position corresponding to the upper elastic member 2920 to prevent interference between the OIS holder 2310 and the upper elastic member 2920.

The OIS holder 2310 may comprise a lateral stopper. The lateral stopper may limit a lateral stroke of the OIS holder 2310. That is, when the OIS holder 2310 moves to the maximum, the lateral stopper of the lower surface OIS holder 2310 may be in contact with at least one of the AF holder 2210 and the base 2110. The lateral stopper may be formed on an outer surface of the OIS holder 2310. The lateral stopper may be protruded outwardly from a side surface of the OIS holder 2310.

The OIS holder 2310 may comprise a protrusion. The protrusion may be coupled with the upper elastic member 2920. The upper elastic member 2920 may comprise a hole being coupled with the protrusion of the OIS holder 2310. In a modified embodiment, the OIS holder 2310 may comprise a groove for accommodating an adhesive instead of the protrusion. In this case, the upper elastic member 2920 may comprise a hole being disposed in the groove of the OIS holder 2310. The protrusion of the OIS holder 2310 may be formed on an upper surface of the OIS holder 2310. The protrusion of the OIS holder 2310 may be protruded from an upper surface of the OIS holder 2310.

The protrusion of the OIS holder 2310 may comprise a plurality of protrusions. The protrusion of the OIS holder 2310 may comprise a first protrusion 2314 and a second protrusion 2315. The inner portion 2921 of the upper elastic member 2920 may comprise a first region being coupled with the first protrusion 2314 and a second region 2212 being coupled with the second protrusion 2315. The wire 2930 may comprise a first wire 2931 being disposed at a first corner region of the fixed unit 2100. The coupling portion 2922 of the upper elastic member 2920 may comprise a first coupling portion being coupled with the first wire 2931. The connecting portion 2923 of the upper elastic member 2920 may comprise a first connecting portion 2923-1 and a second connecting portion 2923-2 connecting the inner portion 2921 of the upper elastic member 2920 and the first coupling portion of the upper elastic member 2920. The connecting portion 2923 of the upper elastic member 2920 may comprise a first connecting portion 2923-1 connecting the first region of the inner portion 2921 and the first coupling portion, and a second connecting portion 2923-2 connecting the second region of the inner portion 2921 and the first coupling portion. That is, the connecting portion 2923 of the upper elastic member 2920 may be provided with two strands of connecting portions to connect one inner portion 2921 and one coupling portion 2922.

When viewed from below, the first and second connecting portions 2923-1 and 2923-2 of the upper elastic member 2920 may be symmetrical with respect to an imaginary straight line connecting the optical axis and the first corner region of the fixed unit 2100.

The coupling portion 2922 of the upper elastic member 2920 may comprise a second coupling portion being coupled with a second wire 2933. The coupling portion 2922 of the upper elastic member 2920 may comprise a third coupling portion being coupled with a third wire 2932. The coupling portion 2922 of the upper elastic member 2920 may comprise a fourth coupling portion being coupled with a fourth wire 2934.

The lens driving device 2010 may comprise a driving unit. The driving unit may move a moving unit against the fixed unit 2100. The driving unit may comprise an AF driving unit 2400. The driving unit may comprise an OIS driving unit 2500 and 2600. The driving unit may comprise a coil and a magnet.

The lens driving device 2010 may comprise an AF driving unit 2400. The AF driving unit 2400 may move the AF moving unit 2200 in an optical axis direction. The AF driving unit 2400 may move the AF holder 2210 in an optical axis direction. The AF driving unit 2400 may move the AF holder 2210 in an optical axis direction through electromagnetic force. The AF driving unit 2400 may comprise a coil and a magnet.

In a third embodiment of the present invention, the AF holder 2210 and the OIS holder 2310 can move in an optical axis direction by the interaction between the AF coil 2420 and the AF magnet 2410. The AF coil 2420, the AF holder 2210, and the OIS holder 2310 can move in an optical axis direction as one unit.

The lens driving device 2010 may comprise an AF magnet 2410. The AF driving unit 2400 may comprise an AF magnet 2410. The AF magnet 2410 may be disposed in the fixed unit 2100. The AF magnet 2410 may be disposed in the base 2110. The AF magnet 2410 may be disposed in the cover 2120. The AF magnet 2410 may be disposed in the side plate 2122 of the cover 2120. The AF magnet 2410 may be disposed on an outer surface of the base 2110. The AF magnet 2410 may be disposed on an inner side surface of the base 2110. The AF magnet 2410 may be fixed to the base 2110. The AF magnet 2410 may be coupled to the base 2110. The AF magnet 2410 may be attached to the base 2110 with an adhesive. The AF magnet 2410 may be disposed inside the cover 2120. The AF magnet 2410 may interact with the AF coil 2420. The AF magnet 2410 may electromagnetically interact with the AF coil 2420. The AF magnet 2410 may be disposed at a position corresponding to the AF coil 2420. The AF magnet 2410 may face the AF coil 2420. The AF magnet 2410 and the AF coil 2420 may face each other. The AF magnet 2410 may be overlapped with the AF coil 2420 in a direction perpendicular to the optical axis.

The AF magnet 2410 may be a four-pole magnet. The AF magnet 2410 may comprise a four-pole magnetizing magnet. The AF magnet 2410 may comprise a first magnet portion comprising an N pole and an S pole, and a second magnet portion comprising an N pole and an S pole. The first magnet portion and the second magnet portion may be disposed in a vertical direction. The first magnet portion and the second magnet portion may be spaced apart from each other in a vertical direction, and a neutral portion may be disposed between the first magnet portion and the second magnet portion.

The lens driving device 2010 may comprise an AF coil 2420. The AF driving unit 2400 may comprise an AF coil 2420. The AF coil 2420 may interact with an AF magnet 2410. The AF coil 2420 may move in an optical axis direction. The AF coil 2420 may move in an optical axis direction through interaction with the AF magnet 2410. The AF coil 2420 may face the AF magnet 2410. The AF coil 2420 may be disposed at a position corresponding to the AF magnet 2410. The AF coil 2420 may be overlapped with the AF magnet 2410 in a direction perpendicular to the optical axis. The AF coil 2420 may be disposed in the inner substrate 2710. The AF coil 2420 may be disposed in the first portion 2711 of the inner substrate 2710. The AF coil 2420 may be disposed in the AF holder 2210. The AF coil 2420 may be disposed in the AF moving unit 2200.

In the above, the AF magnet 2410 is described as being disposed in the fixed unit 2100 and the AF coil 2420 is described as being disposed in the AF moving unit 2200, but in a modified embodiment, they may be disposed in the opposite way. That is, in a modified embodiment, the AF magnet 2410 may be disposed in the AF moving unit 2200. The AF coil 2420 may be disposed in the fixed unit 2100.

The lens driving device 2010 may comprise an AF sensor 2430. The AF driving unit 2400 may comprise an AF sensor 2430. The AF sensor 2430 may be a Hall sensor. The AF sensor 2430 may be disposed in the substrate 2740. The AF sensor 2430 may be disposed in the first portion 2711 of the substrate 2740. The AF sensor 2430 may detect the AF magnet 2410. The AF sensor 2430 may detect movement of the AF magnet 2410. The movement amount or position of the AF magnet 2410 detected by the AF sensor 2430 may be used for feedback of auto focus driving.

The AF sensor 2430 may be a driver IC. The driver IC may comprise a sensing unit. The sensing unit may comprise a Hall element (Hall IC). The driver IC may be electrically connected to the AF coil 2420. The driver IC may supply current to the AF coil 2420.

The AF sensor 2430 may be disposed inside the AF coil 2420. The AF sensor 2430 may be overlapped with the neutral portion of the AF magnet 2410 in a direction perpendicular to the optical axis. In a modified embodiment, the AF sensor 2430 may be disposed in the outside of the AF coil 2420.

The lens driving device 2010 may comprise an OIS-x driving unit 2500. The OIS-x driving unit 2500 may move the OIS moving unit 2300 in an x-axis direction perpendicular to the optical axis direction. The OIS-x driving unit 2500 may move the OIS holder 2310 in an x-axis direction perpendicular to the optical axis. The OIS-x driving unit 2500 may move the OIS holder 2310 in an x-axis direction perpendicular to the optical axis using electromagnetic force. The OIS-x driving unit 2500 may comprise a coil and a magnet.

In a third embodiment of the present invention, the OIS holder 1310 can move in an x-axis direction perpendicular to the optical axis direction by the interaction between the OIS-x coil 2520 and the OIS-x magnet 2510. The OIS-x coil 2520 and the OIS holder 2310 can move in an x-axis direction as one unit.

The lens driving device 2010 may comprise an OIS-x magnet 2510. The OIS-x driving unit 2500 may comprise an OIS-x magnet 2510. The OIS-x magnet 2510 may be disposed in the fixed unit 2100. The OIS-x magnet 2510 may be disposed in the base 2110. The OIS-x magnet 2510 may be disposed on an outer surface of the base 2110. The OIS-x magnet 2510 may be disposed on an inner surface of the base 2110. The OIS-x magnet 2510 may be fixed to the base 2110. The OIS-x magnet 2510 may be coupled to the base 2110. The OIS-x magnet 2510 may be attached to the base 2110 with an adhesive. The OIS-x magnet 2510 can be disposed inside the cover 2120. The OIS-x magnet 2510 can interact with the OIS-x coil 2520. The OIS-x magnet 2510 can electromagnetically interact with the OIS-x coil 2520. The OIS-x magnet 2510 can be disposed at a position corresponding to the OIS-x coil 2520. The OIS-x magnet 2510 can face the OIS-x coil 2520. The OIS-x magnet 2510 and the OIS-x coil 2520 can face each other. The OIS-x magnet 2510 can be overlapped with the OIS-x coil 2520 in a direction perpendicular to the optical axis.

The second magnet 2610 may be a two-pole magnet. The OIS-x magnet 2510 may comprise a two-pole magnetizing magnet. The OIS-x magnet 2510 may comprise an N pole and an S pole. The inner surface of the OIS-x magnet 2510 is an N pole and the outer surface may be an S pole.

The lens driving device 2010 may comprise an OIS-x coil 2520. The OIS-x driving unit 2500 may comprise an OIS-x coil 2520. The OIS-x coil 2520 may interact with the OIS-x magnet 2510. The OIS-x coil 2520 may move in an x-axis direction perpendicular to the optical axis. The OIS-x coil 2520 may move in an x-axis direction through interaction with the OIS-x magnet 2510. The OIS-x coil 2520 may face the OIS-x magnet 2510. The OIS-x coil 2520 and the OIS-x magnet 2510 may face each other. The OIS-x coil 2520 may be disposed at a position corresponding to the OIS-x magnet 2510. The OIS-x coil 2520 may be overlapped with the OIS-x magnet 2510 in a direction perpendicular to the optical axis. The OIS-x coil 2520 may be disposed on the inner substrate 2710. The OIS-x coil 2520 may be disposed in the second portion 2713 of the inner substrate 2710. The OIS-x coil 2520 may be disposed in the OIS holder 2310. The OIS-x coil 2520 may be disposed in the OIS moving unit 2300.

The lens driving device 2010 may comprise an OIS-x sensor 2530. The OIS-x driving unit 2500 may comprise an OIS-x sensor 2530. The OIS-x sensor 2530 may be disposed in an inner substrate 2710. The OIS-x sensor 2530 may be disposed in a second portion 2713 of the inner substrate 2710. The OIS-x sensor 2530 may comprise a Hall sensor. The OIS-x sensor 2530 may detect an OIS-x magnet 2510. The OIS-x sensor 2530 may detect a magnetic force of the OIS-x magnet 2510. The OIS-x sensor 2530 may be disposed in an OIS-x coil 2520. The OIS-x sensor 2530 may be overlapped with the OIS-x coil 2520 in an optical axis direction. The OIS-x sensor 2530 may face the OIS-x magnet 2510. The OIS-x sensor 2530 may be disposed at a position corresponding to the OIS-x magnet 2510. The OIS-x sensor 2530 may detect the movement of the OIS-x magnet 2510. The amount of movement or position of the OIS-x magnet 2510 detected by the OIS-x sensor 2530 may be used for feedback of the shake correction driving in an x-axis direction.

The lens driving device 2010 may comprise an OIS-y driving unit 2600. The OIS-y driving unit 2600 may move the OIS moving unit 2300 in a y-axis direction perpendicular to the optical axis direction and the x-axis direction. The OIS-y driving unit 2600 may move the OIS holder 2310 in a y-axis direction perpendicular to both the optical axis and the x-axis direction. The OIS-y driving unit 2600 may move the OIS holder 2310 in a y-axis direction perpendicular to both the optical axis and the x-axis direction through electromagnetic force. The OIS-y driving unit 2600 may comprise a coil and a magnet.

In a third embodiment of the present invention, the OIS holder 2310 can move in a y-axis direction perpendicular to both the optical axis direction and the x-axis direction by the interaction between the OIS-y coil 2620 and the OIS-y magnet 2610. The OIS-y coil 2620 and the OIS holder 2310 can move in a y-axis direction as one unit.

The lens driving device 2010 may comprise an OIS-y magnet 2610. The OIS-y driving unit 2600 may comprise an OIS-y magnet 2610. The OIS-y magnet 2610 may be disposed in the fixed unit 2100. The OIS-y magnet 2610 may be disposed in the base 2110. The OIS-y magnet 2610 may be disposed on an outer surface of the base 2110. The OIS-y magnet 2610 may be disposed on an inner surface of the base 2110. The OIS-y magnet 2610 may be fixed to the base 2110. The OIS-y magnet 2610 may be coupled to the base 2110. The OIS-y magnet 2610 may be attached to the base 2110 with an adhesive. The OIS-y magnet 2610 may be disposed inside the cover 2120. The OIS-y magnet 2610 may interact with the OIS-y coil 2620. The OIS-y magnet 2610 may electromagnetically interact with the OIS-y coil 2620. The OIS-y magnet 2610 may be disposed at a position corresponding to the OIS-y coil 2620. The OIS-y magnet 2610 may face the OIS-y coil 2620. The OIS-y magnet 2610 and the OIS-y coil 2620 may face each other. The OIS-y magnet 2610 may be overlapped with the OIS-y coil 2620 in a direction perpendicular to the optical axis.

The OIS-y magnet 2610 may be a two-pole magnet. The OIS-y magnet 2610 may comprise a two-pole magnetizing magnet. The OIS-y magnet 2610 may comprise an N pole and an S pole. The inner surface of the OIS-y magnet 2610 may be an N pole and the outer surface may be an S pole.

The lens driving device 2010 may comprise an OIS-y coil 2620. The OIS-y driving unit 2600 may comprise an OIS-y coil 2620. The OIS-y coil 2620 may interact with an OIS-y magnet 2610. The OIS-y coil 2620 may be disposed on the opposite side of the AF coil 2420 with respect to the optical axis. The OIS-y coil 2620 may move in a y-axis direction perpendicular to both the optical axis and the x-axis. The OIS-y coil 2620 may move in a y-axis direction through interaction with the OIS-y magnet 2610. The OIS-y coil 2620 may face the OIS-y magnet 2610. The OIS-y coil 2620 and the OIS-y magnet 2610 may face each other. The OIS-y coil 2620 may be disposed at a position corresponding to the OIS-y magnet 2610. The OIS-y coil 2620 may be overlapped with the OIS-y magnet 2610 in a direction perpendicular to the optical axis. The OIS-y coil 2620 may be disposed in the inner substrate 2710. The OIS-y coil 2620 may be disposed in the third portion 2712 of the inner substrate 2710. The OIS-y coil 2620 may be disposed in the OIS holder 2310. The OIS-y coil 2620 may be disposed in the OIS moving unit 2300.

The lens driving device 2010 may comprise an OIS-y sensor 2630. The OIS-y driving unit 2600 may comprise an OIS-y sensor 2630. The OIS-y sensor 2630 may be disposed in the inner substrate 2710. The OIS-y sensor 2630 may be disposed in a third portion 2712 of the inner substrate 2710. The OIS-y sensor 2630 may comprise a Hall sensor. The OIS-y sensor 2630 may detect an OIS-y magnet 2610. The OIS-y sensor 2630 may detect a magnetic force of the OIS-y magnet 2610. The OIS-y sensor 2630 may be disposed in an OIS-y coil 2620. The OIS-y sensor 2630 may be overlapped with the OIS-y coil 2620 in an optical axis direction. The OIS-y sensor 2630 may face the OIS-y magnet 2610. The OIS-y sensor 2630 may be disposed at a position corresponding to the OIS-y magnet 2610. The OIS-y sensor 2630 may detect movement of the OIS-y magnet 2610. The amount of movement or position of the OIS-y magnet 2610 detected by the OIS-y sensor 2630 may be used for feedback of the shake correction driving in a y-axis direction.

The lens driving device 2010 may comprise a substrate. The substrate may comprise a flexible substrate. The substrate may be electrically connected to the coil. The substrate may be electrically connected to the sensor. The substrate may be formed to be flexible. The substrate may be a circuit board. The substrate may be a printed circuit board.

The lens driving device 2010 may comprise an inner substrate 2710. The inner substrate 2710 may be electrically connected to coils 2420, 2520, and 2620. The inner substrate 2710 may be electrically connected to sensors 2430, 2530, and 2630. The inner substrate 2710 may connect the AF holder 2210 and the OIS holder 2310. The inner substrate 2710 may elastically connect the AF holder 2210 and the OIS holder 2310. The inner substrate 2710 may movably support the OIS holder 2310 against the AF holder 2210. The inner substrate 2710 can guide the OIS holder 2310 to move in a direction perpendicular to the optical axis against the AF holder 2210. The inner substrate 2710 can comprise a flexible substrate. The inner substrate 2710 can comprise a flexible printed circuit board (FPCB). The inner substrate 2710 can comprise an elastic portion. The inner substrate 2710 can comprise an elastic member.

The inner substrate 2710 may comprise a first portion 2711. The first portion 2711 may be disposed in an AF moving unit 2200. The first portion 2711 may be disposed in an AF holder 2210. An AF coil 2420 may be disposed in the first portion 2711 of the inner substrate 1710. An AF sensor 2430 may be disposed in the first portion 2711 of the inner substrate 2710. A yoke 2830 may be disposed in the first portion 2711 of the inner substrate 2710.

The inner substrate 2710 may comprise a second portion 2713. The second portion 2713 may be disposed in the OIS holder 2310. The second portion 2713 may be disposed on a second side surface of the OIS holder 2310. The OIS-x coil 2520 may be disposed in the second portion 2713 of the inner substrate 2710. The OIS-x sensor 2530 may be disposed in the second portion 2713 of the inner substrate 2710.

The inner substrate 2710 may comprise a third portion 2712. The third portion 2712 may be disposed in the OIS holder 2310. The third portion 2712 may be disposed on a third side surface of the OIS holder 2310. The OIS-y coil 2620 may be disposed in the third portion 2712 of the inner substrate 2710. The OIS-y sensor 2630 may be disposed in the third portion 2712 of the inner substrate 2710.

The inner substrate 2710 may comprise a fourth portion 2714. The fourth portion 2714 may be disposed between the OIS holder 2310 and the AF holder 2210. The fourth portion 2714 may be disposed between the fourth side surface of the OIS holder 2310 and the AF holder 2210.

However, in the ‘first to fourth side surfaces’ of the OIS holder 2310 described in the present specification, ‘first to fourth’ are only for distinguishing the side surfaces from one another, and may be referred to differently as needed. For example, the ‘second side surface’ is referred to as a ‘first side surface’and the ‘third side surface’may be referred to as a ‘second side surface’.

The inner substrate 2710 may comprise a terminal 2714a. The fourth portion 2714 of the inner substrate 2710 may comprise a terminal 2714a. The terminal 2714a may be electrically connected to coils 2420, 2520, and 2620. The terminal 2714a may be electrically connected to sensors 2430, 2530, and 2630.

The inner substrate 2710 may comprise a hole 2714b. The fourth portion 2714 of the inner substrate 2710 may comprise a hole 2714b. The hole 2714b may be formed to penetrate the fourth portion 2714 of the inner substrate 2710. The hole 2714b may be disposed at a position corresponding to a lateral stopper of the OIS holder 2310. Due to the hole 2714b, the inner substrate 2710 may not interfere with the lateral stopper of the OIS holder 2310.

The lens driving device 2010 may comprise an outer substrate 2720. The outer substrate 2720 may be disposed in a base 2110. The outer substrate 2720 may be electrically connected to coils 2420, 2520, and 2620. The outer substrate 2720 may be electrically connected to sensors 2430, 2530, and 2630. The outer substrate 2720 may connect the AF holder 2210 and the base 2110. The outer substrate 2720 may elastically connect the AF holder 2210 and the base 2110. The outer substrate 2720 may movably support the AF holder 2210 against the base 2110. The outer substrate 2720 can guide the AF holder 2210 to move in an optical axis direction against the base 2110. The outer substrate 2720 can comprise a flexible substrate. The outer substrate 2720 can comprise a flexible printed circuit board (FPCB). The outer substrate 2720 can comprise an elastic portion. The outer substrate 2720 can comprise an elastic member.

The outer substrate 2720 may comprise a body portion 2721. The body portion 2721 may be disposed in the fixed unit 2100. The body portion 2721 may be disposed in the base 2110. The body portion 2721 may be formed to surround a side surface of the base 2110. The body portion 2721 may be disposed on three side surfaces of the base 2110. The body portion 2721 may comprise two terminal portions. The two terminal portions may be disposed on opposite sides with respect to an optical axis. The terminal portion may comprise a terminal 2721a.

The outer substrate 2720 may comprise a terminal 2721a. The body portion 2721 of the outer substrate 2720 may comprise a terminal 2721a. The terminal 2721a may be electrically connected to the terminal 2722a. The terminal 2721a may be disposed at a lower end of the base 2110. The terminal 2721a may be coupled to a printed circuit board 2050. The terminal 2721a may be coupled to a terminal of the printed circuit board 2050 with a solder. The terminal 2721a may be coupled to a terminal of the printed circuit board 2050 with a conductive member. The terminal 2721a may be connected to a terminal of the printed circuit board 2050. The terminal 2721a can be electrically connected to a terminal of the printed circuit board 2050.

The outer substrate 2720 may comprise an extended portion 2722. The extended portion 2722 may be a ‘leg portion’. The extended portion 2722 may be extended from the body portion 2721. At least a portion of the extended portion 2722 may move together with the AF moving unit 2200. At least a portion of the extended portion 2722 may move together with the AF holder 2210. The extended portion may be extended from the body portion 2721. The extended portion 2722 may comprise a plurality of leg portions. The extended portion 2722 may comprise a first leg portion and a second leg portion. The second leg portion may be disposed below the first leg portion.

The outer substrate 2720 may comprise a terminal 2722a. The extended portion 2722 of the outer substrate 2720 may comprise a terminal 2722a. The terminal 2722a may be coupled to a terminal 2714a of the inner substrate 2710. The terminal 2722a may be coupled to the terminal 2714a of the inner substrate 2710 with a solder. The terminal 2722a may be coupled to the terminal 2714a of the inner substrate 2710 with a conductive member. The terminal 2722a may be connected to the terminal 2714a of the inner substrate 2710. The terminal 2722a may be electrically connected to the terminal 2714a of the inner substrate 2710.

The lens driving device 2010 may comprise a guide member. The guide member may comprise a ball. The guide member may comprise a pin. The guide member may comprise a cylindrical member. The guide member may guide movement of the moving unit against the fixed unit 2100 in a specific direction.

The lens driving device 2010 may comprise a ball 2810. The ball 2810 may be an ‘AF guide ball’. The ball 2810 may be disposed between the fixed unit 2100 and the AF moving unit 2200. The ball 2810 may guide movement of the AF moving unit 2200 in an optical axis direction. The ball 2810 may guide movement of the AF moving unit 2200 in an optical axis direction against the fixed unit 2100. The ball 2810 may guide movement of the AF holder 2210 against the base 2110 in an optical axis direction. The ball 2810 may be disposed between the base 2110 and the AF holder 2210. The ball 2810 may be disposed between the base 2110 and the AF holder 2210 in an x-axis direction. The ball 2810 may be disposed in the groove 2111a of the base 2110. The ball 2810 may not be overlapped with the OIS moving unit 2300 in an optical axis direction. The ball 2810 may be disposed in the first groove 2214 of the AF holder 2210. The ball 2810 may comprise a first-first ball being in contact with the base 2110 and the AF holder 2210 at four points, and a first-second ball being in contact with the base 2110 and the AF holder 2210 at three points. The ball 2810 may have a spherical shape. The ball 2810 may be formed of metal. Grease may be applied to the surface of the ball 2810.

The ball 2810 may comprise a plurality of balls. The ball 2810 may comprise eight balls. Four balls 2810 may be disposed on one side of the AF magnet 2410 and the remaining four balls 2810 may be disposed on the other side of the AF magnet 2410.

The lens driving device 2010 may comprise a yoke 2830. The yoke 2830 may be disposed in a first portion 2711 of the inner substrate 2710. An attractive force may be generated between the yoke 2830 and the AF magnet 2410. The yoke 2830 may be disposed at a position corresponding to the AF magnet 2410. The yoke 2830 may be formed of metal. The AF guide ball 2810 may be pressed between the base 2110 and the AF holder 2210 by the attractive force between the yoke 2830 and the AF magnet 2410. That is, the contact state of the AF guide ball 1810 with the base 2110 and the AF holder 2210 may be maintained by the attractive force between the yoke 2830 and the AF magnet 2410.

The lens driving device 2010 may comprise an elastic member 2900. The elastic member 2900 may connect with the AF moving unit 2200 and the OIS moving unit 2300. The elastic member 2900 may elastically connect the AF moving unit 2200 and the OIS moving unit 2300. The elastic member 2900 may movably support the OIS moving unit 2300 against the AF moving unit 2200. The elastic member 2900 may guide the OIS driving. The elastic member 2900 may guide the OIS moving unit 2300 to move in a direction perpendicular to the optical axis. The elastic member 2900 may guide the OIS moving unit 2300 to move in an x-axis direction and a y-axis direction against AF moving unit 2200. The elastic member 2900 may be formed to guide both the OIS-x-axis actuation and the OIS-y-axis actuation. The elastic member 2900 may comprise a leaf spring. The elastic member 2900 may comprise a wire. The elastic member 2900 may have elasticity. The elastic member 2900 may be formed of a metal. The first resonant frequency of the elastic member 2900 may be 40 to 60 Hz. The first resonant frequency of the elastic member 2900 may be 30 to 70 Hz.

The spring stiffness of the elastic member 2900 can be determined by the weight of the moving body. The spring stiffness of the elastic member 2900 can be determined by the target natural frequency [Hz] of the moving body. The spring stiffness of the elastic member 2900 can be determined by the electromagnetic force level. In summary, since the weight of the moving body and the electromagnetic force level vary greatly depending on the size of the lens, the spring stiffness can also vary greatly. However, in the case of the target natural frequency, considering the control characteristics, in the case of the spring type such as the third embodiment of the present invention, it can be set to a value of at least 40 Hz or more.

For the image sensor 1/I“ OIS actuator, the x-axis spring constant Kx can be 104 N/m (240 Hz) to 228 N/m (260 Hz). In addition, the y-axis spring constant Ky can be 104 N/m (240 Hz) to 228 N/m (260 Hz). The x-axis spring constant and the y-axis spring constant can be the same. The z-axis spring constant Kz can be set to the maximum value that satisfies the Kx and Ky conditions.

The lens driving device 2010 may comprise a lower elastic member 2910. The lower elastic member 2910 may be a leaf spring. The lower elastic member 2910 may have elasticity. The lower elastic member 2910 may be coupled to the AF moving unit 2200. The lower elastic member 2910 may be coupled to the AF holder 2210. The lower elastic member 2910 may be disposed on a lower surface of the AF holder 2210. The lower elastic member 2910 may be disposed in the AF holder 2210. The lower elastic member 2910 may be disposed on a lower portion of the AF holder 2210. The lower elastic member 2910 may be disposed below the AF holder 2210. The lower elastic member 2910 may be disposed on a lower surface of the body portion 2721. The lower elastic member 2910 can be coupled to a lower surface of the body portion 2721. The lower elastic member 2910 can be disposed perpendicular to the optical axis.

The lower elastic member 2910 may comprise a plurality of elastic units being spaced apart from one another. The lower elastic member 2910 may comprise first to fourth elastic units corresponding to the first to fourth wires 2931, 2932, 2933, and 2934. The first to fourth elastic units may be spaced apart from each other.

The lower elastic member 2910 may comprise an outer portion 2911. The outer portion 2911 may be coupled with the AF moving unit 2200. The lower elastic member 2910 may comprise a coupling portion 2912. The coupling portion 2912 may be coupled with a wire 2930. The lower elastic member 2910 may comprise a connecting portion 2913. The connecting portion 2913 may connect the outer portion 2911 and the coupling portion 2912. The outer portion 2911 of the lower elastic member 2910 and the coupling portion 2912 of the lower elastic member 2910 may be disposed at the same height. However, the OIS moving unit 2300 may be disposed in a state where it is tilted downward due to the weight of the lens in an UP posture where the lens is disposed above the image sensor. At this time, the coupling portion 2912 can be disposed at a lower position than the outer portion 2911.

The lens driving device 2010 may comprise an upper elastic member 2920. The upper elastic member 2920 may be a leaf spring. The upper elastic member 2920 may have elasticity. The upper elastic member 2920 may be coupled to the OIS moving unit 2300. The upper elastic member 2920 may be coupled to the OIS holder 2310. The upper elastic member 2920 may be disposed on an upper surface of the OIS holder 2310. The upper elastic member 2920 may be disposed in the OIS holder 2310. The upper elastic member 2920 may be disposed on an upper portion of the OIS holder 2310. The upper elastic member 2920 may be disposed in the OIS holder 2310. The upper elastic member 2920 may be disposed perpendicular to the optical axis. The upper elastic member 2920 can be formed integrally.

The upper elastic member 2920 may comprise an inner portion 2921. The inner portion 2921 may be coupled with the OIS moving unit 2300. The upper elastic member 2920 may comprise a coupling portion 2922. The coupling portion 2922 may be coupled with a wire 2930. The upper elastic member 2920 may comprise a connecting portion 2923. The connecting portion 2923 may connect the inner portion 2921 and the coupling portion 2922. The inner portion 2921 of the upper elastic member 2920 and the coupling portion 2922 of the lower elastic member 2910 may be disposed at the same height. However, the OIS moving unit 2300 may be disposed in a state where it is tilted downward due to the weight of the lens in an UP posture where the lens is disposed on an image sensor. At this time, the inner portion 2921 can be disposed at a lower position than the coupling portion 2922.

The lens driving device 2010 may comprise a wire 2930. The wire 2930 may be a ‘side portion elastic member’. The wire 2930 may be a wire spring. The wire 2930 may be a suspension wire. The wire 2930 may have elasticity. The wire 2930 may connect the upper elastic member 2920 and the lower elastic member 2910. The wire 2930 may elastically connect the upper elastic member 2920 and the lower elastic member 2910. The wire 2930 may be disposed parallel to the optical axis. The wire 2930 may be disposed parallel to the optical axis direction.

The wire 2930 may comprise a plurality of wires. The wire 2930 may comprise four wires. The wire 2930 may comprise first to fourth wires 2931, 2932, 2933, and 2934. The wire 2930 may comprise first to fourth wires 2931, 2932, 2933, and 2934 respectively being disposed in the first to fourth corner regions of the fixed unit 2100.

Hereinafter, the auto focus (AF) driving of the lens driving device according to a third embodiment of the present invention will be described with reference to the drawings.

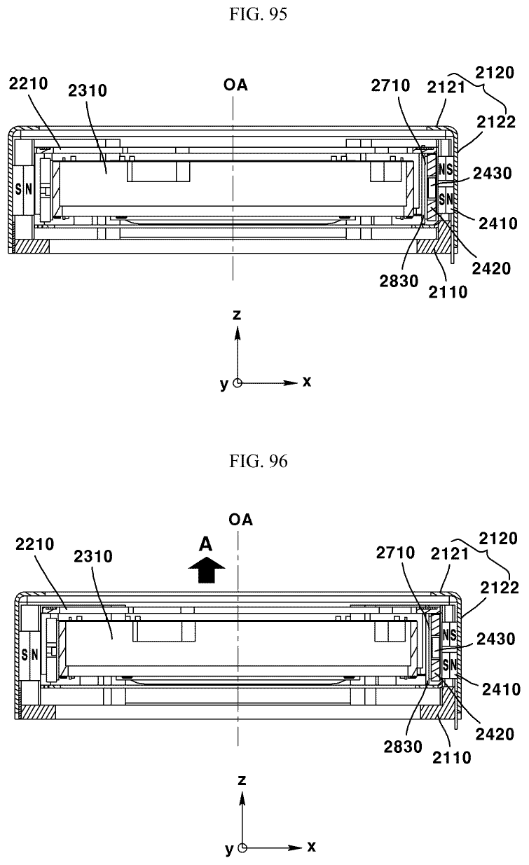

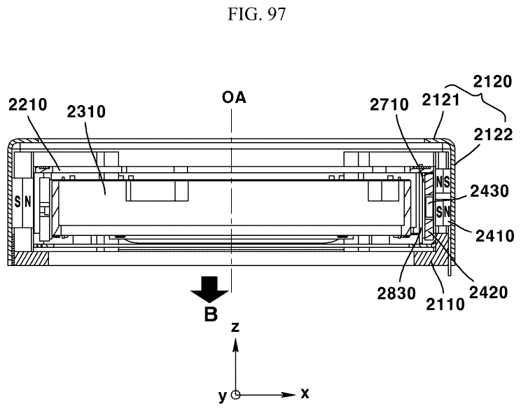

FIGS. 95 to 97 are drawings for explaining an auto focus driving of a lens driving device according to a third embodiment of the present invention. FIG. 95 is a cross-sectional view illustrating an appearance of a moving unit in an initial state where no current is applied to an AF coil. FIG. 96 is a cross-sectional view illustrating an appearance where a moving unit moves upward in an optical axis direction when a positive current is applied to an AF coil. FIG. 97 is a cross-sectional view illustrating a moving unit moving downward in an optical axis direction when reverse current is applied to an AF coil.

The moving unit may be disposed at a position spaced apart from both the upper plate 2121 of the cover 2120 and the base 2110 in an initial position where no current is applied to the AF coil 2420. At this time, the moving unit may be an AF moving unit 2200. In addition, the moving unit may comprise an AF moving unit 2200 and an OIS moving unit 2300.

When a forward current is applied to the AF coil 2420, the AF coil 2420 can move upward in an optical axis direction due to the electromagnetic interaction between the AF coil 2420 and the AF magnet 2410 (see A of FIG. 96). At this time, the AF holder 2210 can move upward in an optical axis direction together with the AF coil 2420. Furthermore, the OIS holder 2310 and the lens can move upward in an optical axis direction together with the AF holder 2210. Accordingly, the distance between the lens and the image sensor can be changed, and the focus of the image formed on the image sensor through the lens can be adjusted.

When a reverse current is applied to the AF coil 2420, the AF coil 2420 can move downward in an optical axis direction due to the electromagnetic interaction between the AF coil 2420 and the AF magnet 2410 (see B of FIG. 97). At this time, the AF holder 2210 can move downward in an optical axis direction together with the AF coil 2420. Furthermore, the OIS holder 2310 and the lens can move downward in an optical axis direction together with the AF holder 2210. Accordingly, the distance between the lens and the image sensor can be changed, and the focus of the image being formed on the image sensor through the lens can be adjusted.

Meanwhile, during the movement process of the AF coil 2420, the AF sensor 2430 moves together with the AF coil 2420 and detects the strength of the magnetic field of the AF magnet 2410 to detect the amount of movement or position of the lens in an optical axis direction. The amount of movement or position of the lens in an optical axis direction detected by the AF sensor 2430 can be used for auto focus feedback control.

Hereinafter, the optical image stabilization OIS operation of the lens driving device according to a third embodiment of the present invention will be described with reference to the drawings.

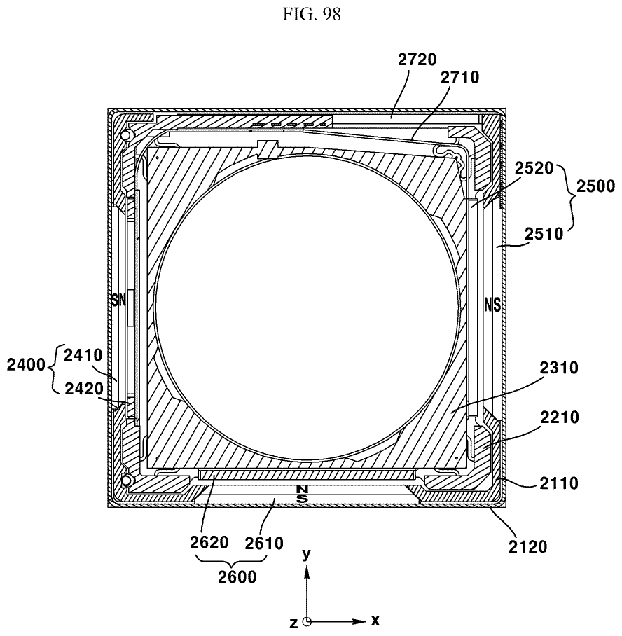

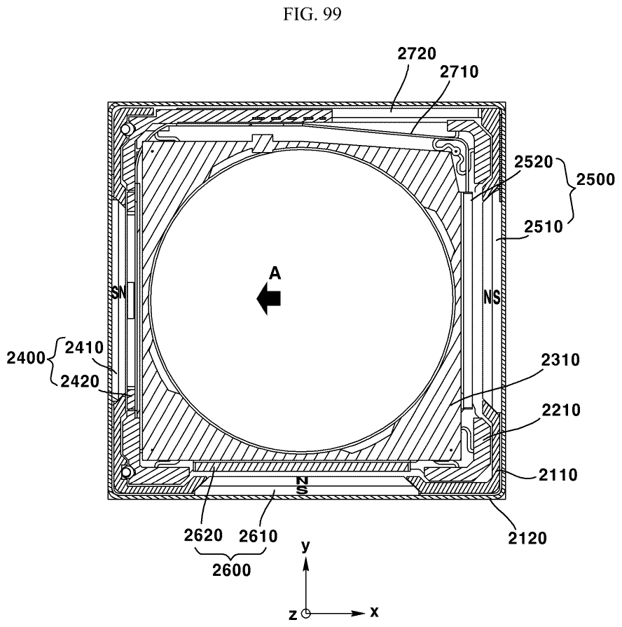

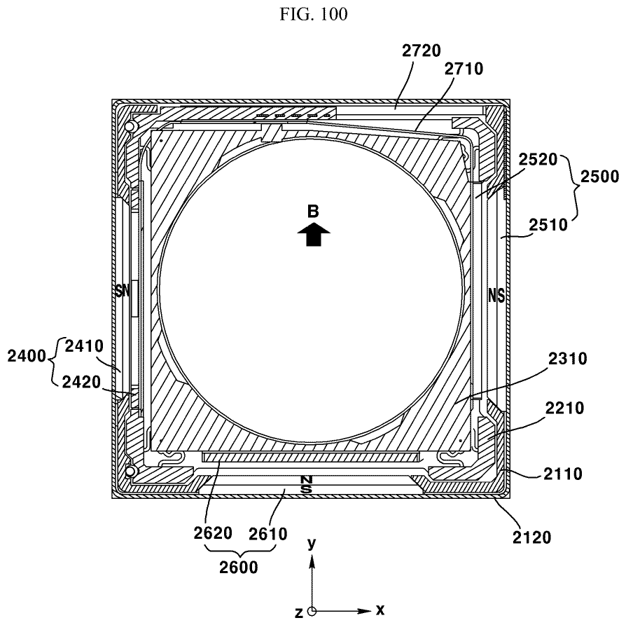

FIGS. 98 to 100 are drawings for explaining a shake correction drive of a lens driving device according to a third embodiment of the present invention. FIG. 98 is a cross-sectional view illustrating a moving unit in an initial state when no current is applied to an OIS-x coil and an OIS-y coil. FIG. 99 is a cross-sectional view illustrating an OIS moving unit moving in an x-axis direction perpendicular to an optical axis when current is applied to an OIS-x coil. FIG. 100 is a cross-sectional view illustrating an OIS moving unit moving in a y-axis direction perpendicular to both an optical axis and an x-axis when current is applied to an OIS-y coil.

As illustrated in FIG. 98, the moving unit may be disposed in an initial position where no current is applied to the OIS-x coil 2520 and the OIS-y coil 2620. At this time, the moving unit may be an OIS moving unit 2300.

When a current is applied to the OIS-x coil 2520, the OIS-x coil 2520 can move in an x-axis direction perpendicular to the optical axis due to the electromagnetic interaction between the OIS-x coil 2520 and the OIS-x magnet 2510 (see A of FIG. 99). At this time, the OIS holder 2310 can move in an x-axis direction together with the OIS-x coil 2520. Furthermore, the lens can move in an x-axis direction together with the OIS holder 2310. In more detail, when a forward current is applied to the OIS-x coil 2520, the OIS holder 2310, and the lens can move in one direction along an x-axis. In addition, when a reverse current is applied to the OIS-x coil 2520, the OIS-x coil 2520, the OIS holder 2310, and the lens can move in the other direction along an x-axis.

When a current is applied to the OIS-y coil 2620, the OIS-y coil 2620 can move in a y-axis direction perpendicular to the optical axis due to the electromagnetic interaction between the OIS-y coil 2620 and the OIS-y magnet 2610 (see B of FIG. 100). At this time, the OIS holder 2310 can move in a y-axis direction together with the OIS-y coil 2620. Furthermore, the lens can move in a y-axis direction together with the OIS holder 2310. In more detail, when a positive current is applied to the OIS-y coil 2620, the OIS holder 2310, and the lens can move in one direction along a y-axis. In addition, when a reverse current is applied to the OIS-y coil 2620, the OIS-y coil 2620, the OIS holder 2310, and the lens can move in the other direction along a y-axis.

Meanwhile, the OIS-x sensor 2530 can detect the amount of movement or position of the OIS-x coil 2520 by detecting the strength of the magnetic field of the OIS-x magnet 2510. The amount of movement or position detected by the OIS-x sensor 2530 can be used for x-axis direction shake correction feedback control. The OIS-y sensor 2630 can detect the amount of movement or position of the OIS-y coil 2620 by detecting the strength of the magnetic field of the OIS-y magnet 2610. The amount of movement or position detected by the OIS-y sensor 2630 can be used for y-axis direction shake correction feedback control.

Hereinafter, a camera device according to a third embodiment of the present invention will be described with reference to the drawings.

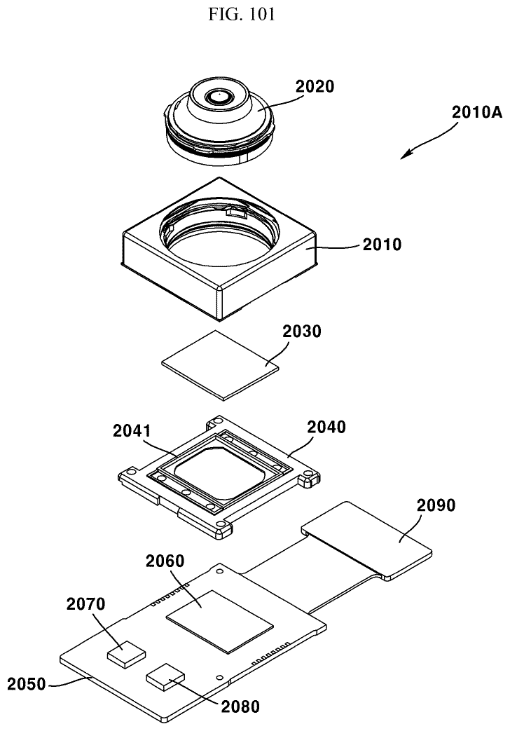

FIG. 101 is an exploded perspective view of a camera device according to a third embodiment of the present invention.

The camera device 2010A may comprise a camera module.

The camera device 2010A may comprise a lens module 2020. The lens module 2020 may comprise at least one lens. The lens may be disposed at a position corresponding to the image sensor 2060. The lens module 2020 may comprise a lens and a barrel. The lens module 2020 may be coupled to an OIS holder 2310 of the lens driving device 2010. The lens module 2020 may be coupled to the OIS holder 2310 by screw coupling and/or an adhesive. The lens module 2020 may be moved integrally with the OIS holder 2310.

The camera device 2010A may comprise a filter 2030. The filter 2030 may serve to block the light of a specific frequency band passing through the lens module 2020 from being incident on the image sensor 2060. The filter 2030 may be disposed parallel to an x-y plane. The filter 2030 may be disposed between the lens module 2020 and the image sensor 2060. The filter 2030 may be disposed in the sensor base 2040. In a modified embodiment, the filter 2030 may be disposed in the base 2110. The filter 2030 may comprise an infrared filter. The infrared filter may block light of an infrared region from being incident on the image sensor 2060.

The camera device 2010A may comprise a sensor base 2040. The sensor base 2040 may be disposed between the lens driving device 2010 and the printed circuit board 2050. The sensor base 2040 may comprise a protruded portion 2041 in which a filter 2030 is disposed. An opening may be formed in a portion of the sensor base 2040 in which the filter 2030 is disposed so that light passing through the filter 2030 may be incident on the image sensor 2060. The adhesive member may couple or attach the base 2310 of the lens driving device 2010 to the sensor base 2040. The adhesive member may additionally serve to prevent foreign substances from entering the interior of the lens driving device 2010. The adhesive member may comprise at least one or more among an epoxy, a thermosetting adhesive, and an ultraviolet-curable adhesive.

The camera device 2010A may comprise a printed circuit board (PCB) 2050. The printed circuit board 2050 may be a substrate or a circuit board. A lens driving device 2010 may be disposed on the printed circuit board 2050. A sensor base 2040 may be disposed between the printed circuit board 2050 and the lens driving device 2010. The printed circuit board 2050 may be electrically connected to the lens driving device 2010. An image sensor 2060 may be disposed on the printed circuit board 2050. Various circuits, elements, control units, and the like may be provided on the printed circuit board 2050 to convert an image being formed on the image sensor 2060 into an electrical signal and transmit it to an external device.

The camera device 2010A may comprise an image sensor 2060. The image sensor 2060 may be a configuration in which a light passing through a lens and a filter 2030 is incident thereon to form an image. The image sensor 2060 may be mounted on a printed circuit board 2050. The image sensor 2060 may be electrically connected to the printed circuit board 2050. For example, the image sensor 2060 may be coupled to the printed circuit board 2050 by surface mounting technology (SMT). As another example, the image sensor 2060 may be coupled to the printed circuit board 2050 by flip chip technology. The image sensor 2060 may be disposed such that its optical axis is aligned with that of the lens. That is, the optical axis of the image sensor 2060 and the optical axis of the lens may be aligned. The image sensor 2060 can convert light irradiated to the effective image area of the image sensor 2060 into an electrical signal. The image sensor 2060 can be any one among a charge coupled device (CCD), a metal oxide semi-conductor (MOS), a CPD, and a CID.

The camera device 2010A may comprise a motion sensor 2070. The motion sensor 2070 may be mounted on a printed circuit board 2050. The motion sensor 2070 may be electrically connected to the control unit 2080 through a circuit pattern being provided on the printed circuit board 2050. The motion sensor 2070 may output rotational velocity information due to the movement of the camera device 2010A. The motion sensor 2070 may comprise a two-axis or three-axis gyro sensor or an angular velocity sensor.

The camera device 2010A may comprise a control unit 2080. The control unit 2080 may be disposed on a printed circuit board 2050. The control unit 2080 may be electrically connected to a coil 2330 of a lens driving device 2010. The control unit 2080 may individually control the direction, intensity, amplitude, and the like of the current supplied to the coil 2330. The control unit 2080 may control the lens driving device 2010 to perform an auto focus function and/or a shake correction function. Furthermore, the control unit 2080 may perform auto focus feedback control and/or shake correction feedback control for the lens driving device 2010.

The camera device 2010A may comprise a connector 2090. The connector 2090 may be electrically connected to the printed circuit board 2050. The connector 2090 may comprise a port for electrically connecting to an external device.

Hereinafter, an optical device according to a third embodiment of the present invention will be described with reference to the drawings.

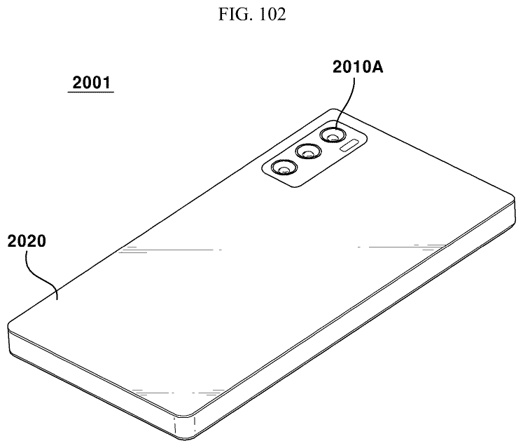

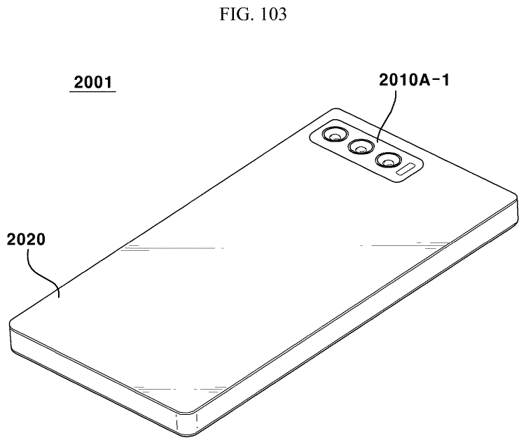

FIG. 102 is a perspective view of an optical device according to a third embodiment of the present invention; and FIG. 103 is a perspective view of an optical device according to a modified embodiment.

The optical device 1001 may comprise at least one among a mobile phone, a cellular phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation device. The optical device 1001 may comprise any device for photographing videos or pictures.

The optical device 2001 may comprise a main body 2020. The optical device 2001 may comprise a camera device 2010A. The camera device 2010A may be disposed in the main body 2020. The camera device 2010A may capture a subject. The optical device 2001 may comprise a display. The display may be disposed in the main body 2020. The display may output one or more of an image and a video captured by the camera device 2010A. The display may be disposed on a first surface of the main body 2020. The camera device 2010A may be disposed on one or more of the first surface of the main body 2020 and the second surface opposite to the first surface. As illustrated in FIG. 102, in the camera device 2010A, a triple camera may be disposed in a vertical direction. As illustrated in FIG. 103, in the camera device 2010A-1, a triple camera may be disposed in a horizontal direction.

Although the first to third embodiments of the present invention have been described above separately, some of the components of the first to third embodiments may be replaced with each other. That is, some of the components of the first embodiment may be replaced with corresponding components of one or more of the second embodiment and third embodiment. Some of the components of the second embodiment may be replaced with corresponding components of one or more of the first embodiment and third embodiment. Some of the components of the third embodiment may be replaced with corresponding components of one or more of the first embodiment and second embodiment.

Although the embodiment of the present invention has been described above with reference to the accompanying drawings, those of ordinary skill in the art to which the present invention belongs will understand that the present invention may be embodied in other specific forms without changing the technical spirit or essential features thereof. Therefore, it should be understood that the embodiments described above are illustrative in all respects and not restrictive.

1. A lens driving device comprising:
a base;
a first holder disposed in the base;
a second holder disposed in the first holder;
first to third magnets disposed on the base;
a first coil disposed on the first holder and configured to interact with the first magnet;
a second coil disposed on the second holder and configured to interact with the second magnet; and
a third coil disposed on the second holder and configured to interact with the third magnet.

2. The lens driving device of claim 1, wherein, by the interaction between the first coil and the first magnet, the first holder is configured to move in an optical axis direction,
wherein, by the interaction between the second coil and the second magnet, the second holder is configured to move in a first direction perpendicular to the optical axis direction, and
wherein, by the interaction between the third coil and the third magnet, the second holder is configured to move in a second direction perpendicular to both the optical axis direction and the first direction.

3. The lens driving device of claim 2, wherein the second holder is configured to move in the optical axis direction together with the first holder by the interaction between the first coil and the first magnet.

4. The lens driving device of claim 1, wherein the base comprises a first side portion and a second side portion disposed opposite to each other, and a third side portion and a fourth side portion disposed opposite to each other,
wherein the first magnet is disposed on the first side portion of the base,
wherein the second magnet is disposed on the second side portion of the base, and
wherein the third magnet is disposed on the third side portion of the base.

5. The lens driving device of claim 1, wherein the second holder comprises a first side surface and a second side surface disposed opposite to each other, and a third side surface and a fourth side surface disposed opposite to each other,
wherein the first coil is disposed between the first side surface of the second holder and the first magnet,
wherein the second coil is disposed between the second side surface of the second holder and the second magnet, and
wherein the third coil is disposed between the third side surface of the second holder and the third magnet.

6. The lens driving device of claim 5, comprising a first substrate comprising a first portion disposed on the first holder, a second portion disposed on the second side surface of the second holder, and a third portion disposed on the third side surface of the second holder,
wherein the first coil is disposed on the first portion of the first substrate,
wherein the second coil is disposed on the second portion of the first substrate, and
wherein the third coil is disposed on the third portion of the first substrate.

7. The lens driving device of claim 6, wherein the first substrate comprises a fourth portion disposed between the fourth side surface of the second holder and the first holder, and
wherein the fourth portion of the first substrate comprises a terminal.

8. The lens driving device of claim 7, comprising a second substrate disposed on the base,
wherein the second substrate comprises a body portion disposed on the base and an extended portion extending from the body portion,
wherein the extended portion comprises a first terminal coupled with the terminal of the first substrate,
wherein the body portion comprises a second terminal electrically connected with the first terminal, and
wherein at least a portion of the extended portion is configured to move together with the first holder.

9. The lens driving device of claim 1, comprising a first ball disposed between the base and the first holder.

10. The lens driving device of claim 6, comprising a yoke disposed on the first portion of the first substrate and configured to generate an attractive force with the first magnet.

11. The lens driving device of claim 1, comprising a second ball disposed between the first holder and the second holder.

12. The lens driving device of claim 11, comprising:
a first elastic member disposed on an upper surface of the second holder;
a second elastic member disposed on a lower surface of the first holder; and
a third elastic member connecting the first elastic member and the second elastic member,
wherein the first holder comprises a body portion and a pressing portion coupled with an upper surface of the body portion,
wherein the second elastic member is disposed on a lower surface of the body portion, and
wherein the second ball is disposed between the pressing portion of the first holder and the second holder.

13. The lens driving device of claim 11, wherein the second ball is configured to guide the second holder to move in a first direction and a second direction perpendicular to an optical axis direction with respect to the first holder.

14. The lens driving device of claim 6, comprising:
a first sensor disposed on the first portion of the first substrate and configured to detect the first magnet;
a second sensor disposed on the second portion of the first substrate and configured to detect the second magnet; and
a third sensor disposed on the third portion of the first substrate and configured to detect the third magnet.

15. A camera device comprising:
a printed circuit board;
an image sensor disposed on the printed circuit board;
the lens driving device of claim 1 disposed on the printed circuit board; and
a lens coupled with the lens driving device.

16. An optical device comprising:
a main body;
the camera device of claim 15 disposed on the main body; and
a display disposed on the main body and configured to output at least one of an image and a video photographed by the camera device.

17. A lens driving device comprising:
a base;
a first holder disposed in the base;
a second holder disposed in the first holder;
a first coil and a first magnet configured to move the first holder in an optical axis direction;
a second coil and a second magnet configured to move the second holder in a first direction perpendicular to the optical axis direction; and
a third coil and a third magnet configured to move the second holder in a second direction perpendicular to the optical axis direction,
wherein the first coil is disposed on the first holder, and
wherein the second coil and the third coil are disposed on the second holder.

18. The lens driving device of claim 17, wherein the first magnet, the second magnet, and the third magnet are disposed on the base.

19. The lens driving device of claim 17, wherein the second direction is perpendicular to the first direction.

20. A lens driving device comprising:
a base;
a first holder disposed in the base;
a second holder disposed in the first holder;
a first coil and a first magnet configured to move the first holder in an optical axis direction;
a second coil and a second magnet configured to move the second holder in a first direction perpendicular to the optical axis direction; and
a third coil and a third magnet configured to move the second holder in a second direction perpendicular to the optical axis direction,
wherein the second magnet is overlapped with the first magnet in the first direction, and
wherein, in the first direction, the first coil and the second coil are disposed between the first magnet and the second magnet.
